(19) United States
(12) Patent Application Publication
(10) Pub. No.: US 2003/0219467 A1
(43) Pub. Date: Nov. 27, 2003

(54) Method for the inhibition of methanogensis

(75) Inventors: Jess L. Miner, Lincoln, NE (US); Stephen W. Ragsdale, Lincoln, NE (US); James M. Takacs, Hickman, NE (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Board of Regents of the University of Nebraska

(21) Appl. No.: 10/245,965

(22) Filed: Sep. 18, 2002

Related U.S. Application Data
(60) Provisional application No. 60/322,928, filed on Sep. 18, 2001.

(51) Int. Cl. A23K 1/165

(52) U.S. Cl. 424/442

(57) ABSTRACT

The current invention is directed toward a method for inhibiting methanogenesis and/or the growth of methanogens. The method comprises contacting a methanogenic archaea medium with a methane inhibiting amount and/or a growth inhibiting amount of a compound that specifically inhibits methane formation and inhibits the growth of methanogens. A method to increase feed efficiency in a ruminant is also provided via administering to the animal an effective rumen modifying amount of a compound that specifically inhibits methanogenesis.

### CROSS REFERENCE TO RELATED APPLICATION

This application claims priority from Provisional Application Serial No. 60/322,928 filed on Sep. 18, 2001, which is hereby incorporated by reference in its entirety.

### STATEMENT REGARDING FEDERALLY SPONSORED RESEARCH

This invention was made with Government support under Contract No. STTR R41-GM6497 awarded by the National Institutes of Health. The Government has certain rights in this invention.

### FIELD OF THE INVENTION

The present invention relates to a method for the inhibition of methanogenesis. The invention also relates to a method for inhibiting the growth of methanogenic archaea as well as a method for increasing the feed efficiency in a ruminant animal.

### BACKGROUND OF THE INVENTION

Microbial methane formation, or methanogenesis, is a strictly anaerobic process carried out by a metabolically unique group of organisms in the kingdom of Archaea, known as methanogens. The methanogens comprise the genera Methanococcus, Methanobacterium, Methanosarcina, Methanobrevibacter, Methanotherrus, Methanothrix, Methanospirillum, Methanomicrobium, Methanococcoides, Methanogenium, Methanobacter and Methanoplanus. Because methanogens are able to survive a variety of temperature ranges, these archaea are widely distributed in strictly anaerobic environments including the digestive tract of many animals (e.g., humans, termites, and the rumen compartment of ruminant animals), landfills, stagnant ponds, anaerobic digesters and rice paddies.

The methanogens are also highly interactive ecologically, and depend heavily on the metabolism of other microbes to produce the substrates needed for their survival. Fermentative bacteria provide these substrates by conversion of complex macromolecules such as cellulose or protein into the four principal methanogenic substrates: hydrogen, carbon dioxide, acetic acid, and formic acid. The methanogens then remove these fermentative end-products and convert them into methane. A classic example of this type of association is termed “interspecies hydrogen transfer” wherein a hydrogen-producing organism generates hydrogen for the methanogen, and the methanogen then removes hydrogen which is actually inhibitory for the hydrogen producer. This association is seen in the natural food chain where primary bacteria convert cellulose to various products including lactate, acetate, fatty acids, carbon dioxide and hydrogen, and the methanogens then utilize the hydrogen and carbon dioxide to produce methane and water.

Regulation of methane production by methanogenic archaea has several important agronomic and environmental utilities. One application with agronomic importance is the regulation of methane production in ruminant animals. It has long been recognized that methane production in ruminants dramatically impacts the efficiency with which these animals convert feed into metabolic energy. This decrease in efficiency results because methane represents a caloric loss to the ruminant of approximately 5-10% of its total caloric intake. It is therefore highly advantageous to divert microbial rumen metabolism away from methane formation and toward substrates that can be utilized by the ruminant with marginal caloric loss, such as volatile fatty acids (“VFA”).

Equally, regulation of methane production has environmental significance because methane is a major greenhouse gas and atmospheric pollutant. Although methane constitutes only 0.4% of all greenhouse pollutants, it is said to be responsible for approximately 18% of the total greenhouse warming of the earth's atmosphere, and its annual rate of increase is on the order of 1%. Some of the primary sources of environmental methane come from domestic animals, landfills, and rice cultivation, which together contribute over 40% of the total methane emissions and over 60% of the anthropogenic methane emissions. Methane emissions from rice cultivation are estimated to contribute about 20% of the total methane produced in the atmosphere, and emissions from landfills constitute about 7% of the total emissions. And it is estimated that ruminants contribute approximately 18-20% of the global methane produced annually. The United States ruminant population alone produces over 5 million metric tons of methane per year.

Methanogen inhibitors have been developed previously, primarily for use as feedstock additives to increase ruminant feed efficiency. These additives fall primarily into two classes. The first group indirectly affect methane formation by interfering with carbon or electron flow at a point upstream of the methanogen in the microbial food chain. The second group affect methanogens directly. Examples of compounds known to inhibit methanogenesis directly or indirectly are diverse, and range from common anions such as nitrate, to ionopore antibiotics. Specific examples include monesin, lasalocid, salinomycin, avoparcin, aridcin, actaplanin, penicillin, chlorine and bromine methane analogs, long chain fatty acids, sulfate and nitrate. A complete list is cited in C. J. Van Nevel, D. I. Demeyer, “Manipulation of Rumen Fermentation,” in The Rumen Microbial Ecosystem, P. N. Hobson (ed) Elsevier Publishing Co. (1988), hereby incorporated by reference. However most, if not all, of these compounds, lack specificity for methane formation, and some exhibit a multitude of negative side effects in the rumen of animals such as toxicity.

Accordingly, in view of the foregoing, a need continues to exist for a method employing compounds that specifically inhibit methane production by methanogens that is cost effective and may be safely administered to animals.

### SUMMARY OF THE INVENTION

Among the several aspects of the invention, therefore, is provided a method for inhibiting methane production by methanogenic archaea, the method comprising contacting a methanogenic archaea medium with an effective methane inhibiting amount of at least one compound of Formula XXXA:

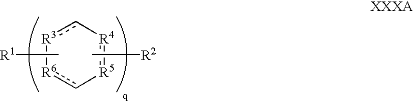

wherein the dashed lines independently indicate an optional double bond;

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

wherein q is 0 or 1;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

Another aspect provides a method for inhibiting the growth of methanogenic archaea, the method comprising contacting a methanogenic archaea medium with an effective growth inhibiting amount of at least one compound of Formula XXXA:

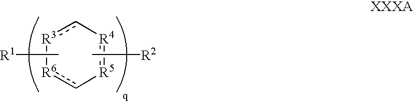

wherein the dashed lines independently indicate an optional double bond;

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷) and —NR²⁹(NR²⁶R³⁷);

wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

wherein q is 0 or 1;

and wherein either R¹ or R² and either R³ or R⁴ or R⁵ or R^{6,} or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In still a further aspect of the invention is provided a method for increasing feed efficiency in a ruminant animal, the method comprising administering to the animal an effective rumen modifying amount of at least one compound of Formula XXXA:

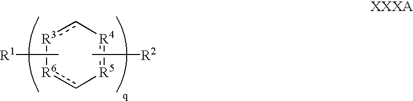

wherein the dashed lines independently indicate an optional double bond;

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙOR¹¹R¹², —SPOₙR¹¹R¹², —CR⁹R¹⁰(POₙNR¹¹R¹²), and —NR¹³(POₙR¹¹R¹²);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

wherein q is 0 or 1;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R² or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

Another aspect of the invention provides a method for inhibiting methane production by methanogenic archaea, the method comprising contacting a methanogenic archaea medium with an effective methane inhibiting amount of at least one compound of Formula I:

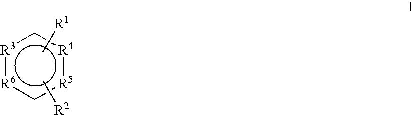

wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocycloxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is from 0 to 2;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

Another aspect provides a method for inhibiting the growth of methanogenic archaea, the method comprising contacting a methanogenic archaea medium with an effective growth inhibiting amount of at least one compound of Formula I:

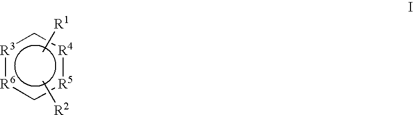

wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocycloxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is from 0 to 2;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In still a further aspect of the invention is provided a method for increasing feed efficiency in a ruminant animal, the method comprising administering to the animal an effective rumen modifying amount of at least one compound of Formula I:

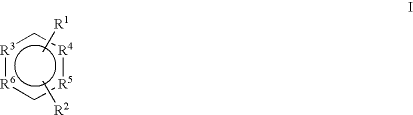

wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of —OR³⁶, —CR²⁷R²⁸⁽OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocycloxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocycloxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is from 0 to 2;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

Other features of the present invention will be in part apparent to those skilled in the art and in part pointed out in the detailed description provided below.

### BRIEF DESCRIPTION OF THE DRAWINGS

These and other features, aspects, and advantages of the present invention will become better understood with regard to the following description, appended claims and accompanying figures where:

FIG. 1 depicts the series of reactions employed by methanogenic archaea to convert hydrogen and carbon dioxide to methane.

FIG. 2 depicts the enzyme mechanism for the formation of RFA-P from the reactants p-aminobenzoate and phosphoribosylpyrophosphate catalyzed by RFA-P synthase.

FIG. 3 depicts the ability of the indicated compound (A4 (●), A7 (Δ) and A20(∘)) to inhibit RFA-P synthase.

FIG. 4 depicts the ability of the indicated compound (1000 μM A2 (▴), 300 μM A4 (∘), and 500 μM A4 (□)) to inhibit growth of Methanothermobacter marburgensis.

FIG. 5 depicts the inability of the indicated compound (A2 (∘) and A4 (▴)) to inhibit growth of the acetogenic bacterium, Moorella thermoacetica.

FIG. 6 depicts inhibition of RFA-P synthase by 4-(isopropylamino)benzoic acid.

FIG. 7A depicts inhibition of methanogen growth by 4-(isopropylamino)benzoic acid. Methanothermobacter marburgensis was cultured in the presence of 0 (●), 15 (□), 25 (♦), 75 (▪), and 90 (⋄) micromoles of 4-(isopropylamino)benzoic acid. Growth was followed by measuring optical density at 580 nm. FIG. 7B depicts the growth of acetogen in the presence (□) or absence (●) of 1 mM of 4-(isopropylamino)benzoic acid. Growth was followed by measuring the optical density at 600 nm.

FIG. 8 depicts the effect of 4-ethylamino-benzoate on volatile fatty acid production in mixed cultures of ruminal organisms.

### DESCRIPTION OF THE PREFERRED EMBODIMENT

Biological methane formation, as detailed above, is a process unique to methanogenic archaea. Although this process is beneficial to methanogens, it is often highly detrimental to ruminant animals and to the environment. It has been discovered that certain compounds both inhibit methane production by methanogens and also inhibit their growth. The method of the invention comprises contacting a methanogenic archaea medium with a compound of Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX. This method, unlike previous approaches, is highly beneficial because it provides compounds that specifically inhibit methane production by methanogens and yet is safe when administered to an animal, such as a ruminant.

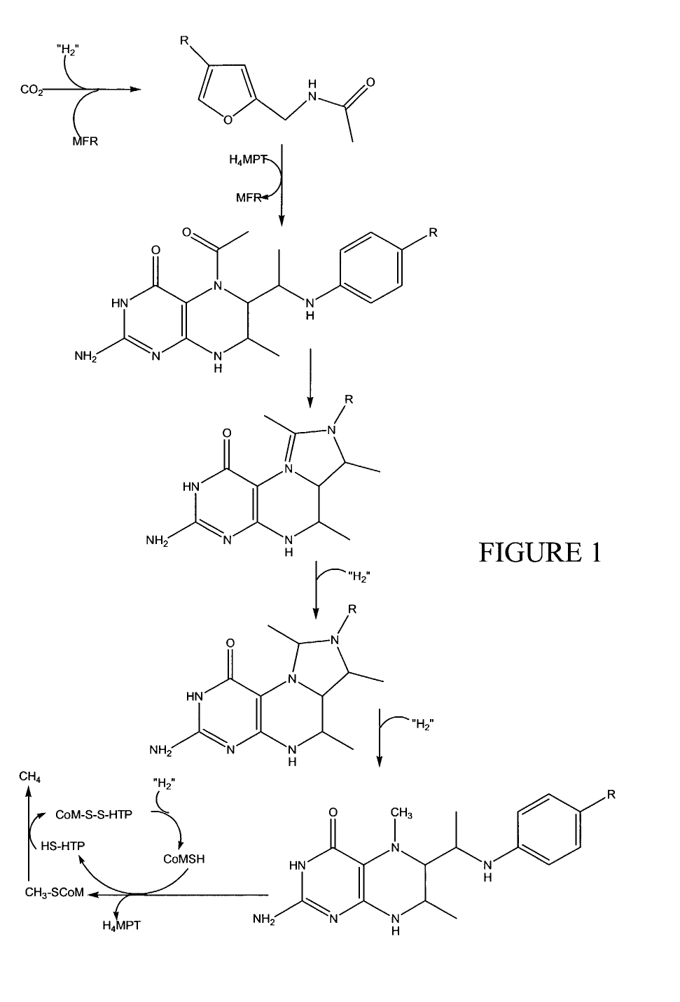

Referring now to FIG. 1, via a series of reactions, methanogenic archaea convert hydrogen and carbon dioxide to methane. This process involves a number of unusual cofactors only present in methanogens, such as methanopterin. Methanopterin functions as a one-carbon carrier coenzyme, which replaces the function of tetrahydrofolic acid in eukaryotes as a one-carbon carrier. Because of its role as a coenzyme, methanopterin is involved in a number of key reactions in methanogenesis. Accordingly, any interruption of methanopterin biosynthesis specifically and dramatically impacts methane production by methanogens and also impacts their growth.

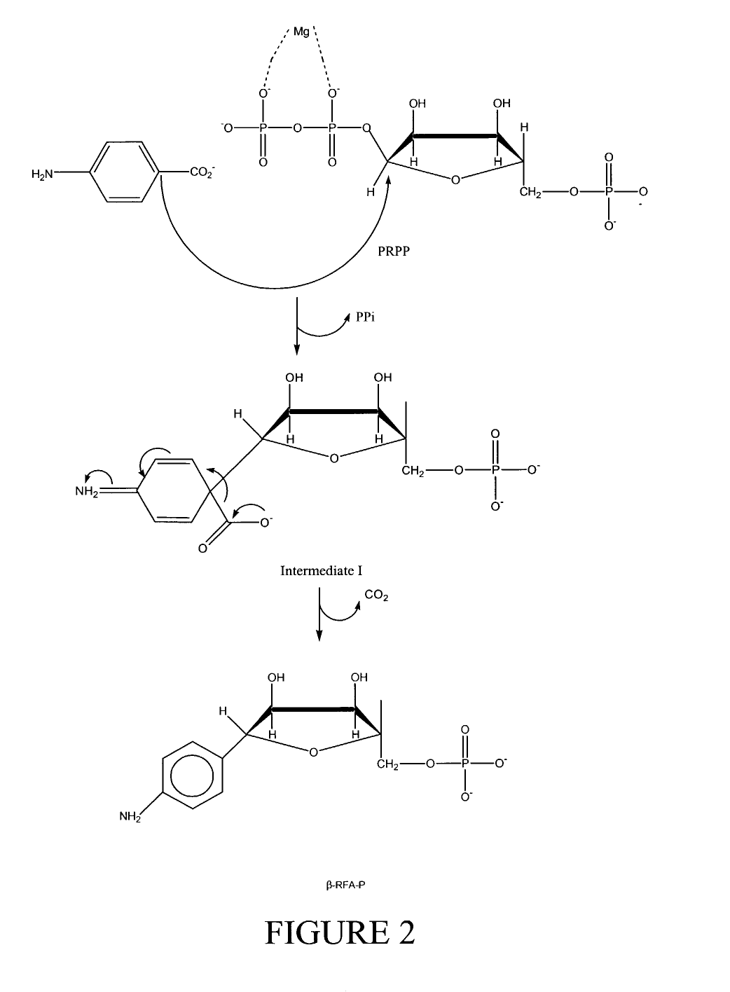

Taking advantage of methanopterin's pivotal role in methanogenesis, and without being bound to any particular theory, it is believed that the compounds represented by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX, as set forth below, inhibit methane production and growth of methanogens by disrupting the biosynthesis of methanopterin. In one embodiment, the compounds represented by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX specifically inhibit the enzyme RFA-P synthase, which catalyzes the first step in methanopterin biosynthesis. This enzyme, as detailed in FIG. 2, catalyzes the formation of RFA-P from the substrates p-amino-benzoic acid and phosphoribosylpyrophosphate (PRPP). It has been found, advantageously, and in contrast to previous approaches, that because methanopterin is only present in methanogens, inhibition of its biosynthesis not only specifically inhibits methane production by methanogens, but also does not impair animal health or fermentation processes catalyzed by non-methanogenic microbes.

Generally speaking, the compounds used in the methods described herein have any of the general Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX shown below, and include the diastereomers, enantiomers, racemates, tautomers, salts, esters, amides and proforms thereof.

One aspect of the invention, accordingly, provides a method to inhibit methane production by methanogens and also a method to inhibit their growth. The method comprises contacting a methanogenic archaea medium with a methane inhibiting amount and/or a growth inhibiting amount of at least one compound of Formula XXXA:

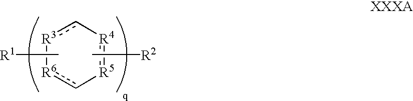

wherein the dashed lines independently indicate an optional double bond;

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³ (SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

wherein q is 0 or 1;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R^{37,} or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula XXX:

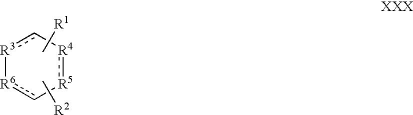

wherein the dashed lines independently indicate an optional double bond;

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula IA:

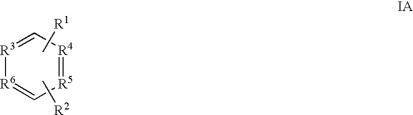

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —OₙC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷₁ R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula IIA:

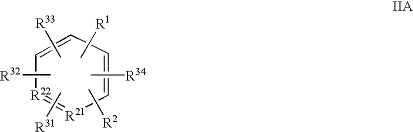

wherein R¹ is selected from the group consisting of —C≡N, —OₘBR³R⁴, —C(H)R⁵(BR³R⁴), —OₘC(O)R⁶, —(C(H)R⁵)ₚ(C(O)R⁶), —CHR⁵(NR⁸R¹²), —CR⁵═CR¹¹(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);

wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);

wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;

wherein R⁵ and R¹¹ are independently selected from the group consisting of hydrogen, hydrocarbyl, substituted hydrocarbyl, heterocyclo, hydroxy, hydrocarbyloxy, substituted hydrocarbyloxy, and heterocyclooxy;

wherein R⁶, R⁷, R⁹, R¹⁰ and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁸, R¹² and R¹⁷ are independently selected from the group consisting of hydrogen, hydroxy, hydrocarbyl, substituted hydrocarbyl, and heterocyclo;

wherein R¹⁶ and R¹⁸ are independently selected from the group consisting of hydrogen, hydrocarbyl, substituted hydrocarbyl, and heterocyclo;

wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²¹ and R²² are independently carbon or nitrogen;

wherein R³¹, R³², R³³ and R³⁴ are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;

wherein m is 0 or 1;

wherein n is an integer from 0 to 2;

wherein p is an integer from 0 to 3;

and wherein R³ and R⁴, or R⁵ and either R³ or R⁴ or R⁶ or R⁷ or R⁸ or R⁹ or R¹⁰ or R¹², or R⁸ and either R⁷ or R⁹ or R¹⁰ or R¹², or R⁹ and R¹⁰, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷or R⁸ or R⁹ or R¹⁰ or R¹⁶ or R¹⁷ or R¹⁸ or R¹⁹ or R²⁰ or R³² or R³³ or R³⁴, or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³³ or R³⁴, or R³³ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³⁴, or R³⁴ and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula IIIA:

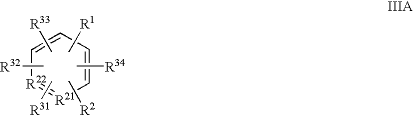

wherein R¹ is selected from the group consisting of —C≡N, —BR³R⁴, —C(H)R⁵(BR³R⁴), —CR⁵═CR¹¹(C(O)R⁶), —C(O)R⁶, —CHR⁵(NR⁸R¹²), —(C(H)R⁵)ₚ(C(O)R⁶), —SOₙR⁷, —C(H)R⁵(SOₙR⁷), —POₙR⁹R¹⁰, and —C(H)R⁵(POₙR⁹R¹⁰);

wherein R² is selected from the group consisting of hydrogen, hydroxy, —C(O)R²⁵, —C(H)R¹⁶(OH), —OₘNR¹⁹R²⁰, and —C(H)R¹⁶(N(H)R¹⁹);

wherein R³, R⁴, R⁶, R⁷ and R⁹ are independently selected from the group consisting of hydroxy and alkoxy;

wherein R⁵, R⁸, R¹¹, R¹², R¹⁶, R²⁵, R³¹, R³², R³³ and R³⁴ are independently selected from the group consisting of hydrogen, hydroxy, amino, halogen, hydrocarbyl, and substituted hydrocarbyl;

wherein R¹⁰ is selected from the group consisting of hydrocarbyl, substituted hydrocarbyl, heterocyclo, and alkoxy;

wherein R¹⁹ and R²⁰ are independently selected from the group consisting of hydrogen, hydrocarbyl, substituted hydrocarbyl, and heterocyclo;

wherein R²¹ and R²² are independently carbon or nitrogen;

wherein m is 0 or 1;

wherein n is an integer from 0 to 2;

wherein p is an integer from 0 to 3;

and wherein R³ and R⁴, or R⁵ and either R⁶ or R⁸ or R¹², or R⁸ and R¹², or R⁹ and R¹⁰, or R¹⁶ and either R¹⁹ or R³¹ or R³² or R³³ or R³⁴, or R¹⁹ and either R²⁰ or R³¹ or R³² or R³³ or R³⁴, or R²⁰ and either R³¹ or R³² or R³³ or R³⁴, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula IVA:

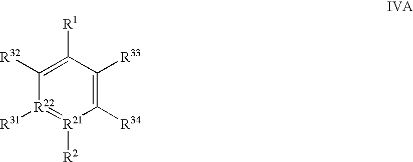

wherein R¹ is selected from the group consisting of —C≡N, —BR³R⁴, —C(O)R⁶, —CHR⁵(NR⁸R¹²), —(C(H)R⁵)ₚ(C(O)R⁶), —CR⁵═CR¹¹(C(O)R⁶), —SOₙ(OH), —POₙR⁹R¹⁰ and —C(H)R⁵(POₙR⁹R¹⁰);

wherein R² is selected from the group consisting of hydrogen, hydroxy, —C(O)R²⁵, —C(H)R¹⁶(OH), —NR¹⁹R²⁰, and —CH₂(N(H)R¹⁹);

wherein R³, R⁴, R⁶, R⁹ and R¹⁰ are independently selected from the group consisting of hydroxy and alkoxy;

wherein R⁵, R⁶, R¹¹ and R¹² are independently selected from the group consisting of hydrogen, hydrocarbyl and substituted hydrocarbyl;

wherein R¹⁶, R¹⁹, R²⁰, R²⁵, R³¹, R³², R³³ and R³⁴ are independently selected from the group consisting of hydrogen, hydroxy, amino, halogen, hydrocarbyl, and substituted hydrocarbyl;

wherein R²¹ and R²² are independently carbon or nitrogen;

wherein n is an integer from 0 to 2;

wherein p is an integer from 0 to 3;

and wherein R³ and R⁴, or R⁵ and either R⁶ or R⁸ or R¹², or R⁸ and R¹², or R⁹ and R¹⁰, or R¹⁹ and either R²⁰ or R³¹, or R²⁰ and R³¹, together with the atoms to which they are independently attached, can form a substituted or unsubstituted, saturated, partially saturated or unsaturated heterocyclic ring containing from 3 to 5 carbon atoms.

In another embodiment, the method comprises contacting a methanogenic archaea medium with a methane inhibiting amount and/or a growth inhibiting amount of a compound of Formula I:

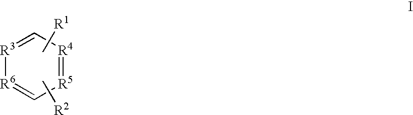

wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(pOₙR¹¹R¹²);

wherein R² is selected from the group consisting of —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is from 0 to 2;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula II:

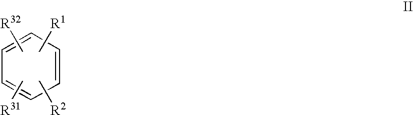

wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);

wherein R² is selected from the group consisting of —OR¹⁸, —C(H)R¹⁶(OR¹⁸), —OₘN(H)R¹⁹, —C(H)R¹⁶(N(H)R¹⁹), and —NR¹⁷(N(H)R¹⁹);

wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;

wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;

wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁸ and R¹⁷ are independently selected from the group consisting of hydrogen, hydroxy, hydrocarbyl, substituted hydrocarbyl, and heterocyclo;

wherein R¹⁶ and R¹⁸ are independently selected from the group consisting of hydrogen, hydrocarbyl, substituted hydrocarbyl, and heterocyclo;

wherein R¹⁹ is selected from the group consisting of hydrogen, hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R³¹ and R³² are independently selected from the group consisting of hydrogen, halogen, hydrocarbyl, substituted hydrocarbyl, heterocyclo, hydroxy, hydrocarbyloxy, substituted hydrocarbyloxy, and heterocyclooxy;

wherein m is 0 or 1;

wherein n is from 0 to 2;

and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R³², or R³² and either R³ or R⁴ or R⁵ or R⁶ or R⁷ or R⁸ or R⁹ or R¹⁰ or R¹⁶ or R¹⁷ or R¹⁸ or R¹⁹, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula III:

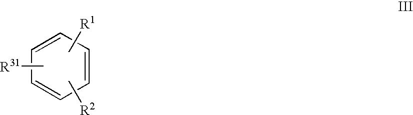

wherein R¹ is selected from the group consisting of —BR³R⁴, —C(H)R⁵(BR³R⁴), —C(O)R⁶, —C(H)R⁵(C(O)R⁶), —SₙOR⁷, —C(H)R⁵(SOₙR⁷), —POₙR⁹R¹⁰, and —C(H)R⁵(POₙR⁹R¹⁰);

wherein R² is selected from the group consisting of hydroxy, —C(H)R¹⁶(OH), —OₘN(H) R¹⁹, and —C(H)R¹⁶(N(H)R¹⁹);

wherein R³, R⁴, R⁶, R⁷ and R⁹ are independently selected from the group consisting of hydroxy and alkoxy;

wherein R⁵, R¹⁶ and R³¹ are independently selected from the group consisting of hydrogen, hydrocarbyl, and substituted hydrocarbyl;

wherein R¹⁰ is selected from the group consisting of hydrocarbyl, substituted hydrocarbyl, heterocyclo, and alkoxy;

wherein R¹⁹ is selected from the group consisting of hydrogen, hydrocarbyl, substituted hydrocarbyl, and heterocyclo;

wherein m is 0 or 1;

wherein n is from 0 to 2;

and wherein R³ and R⁴, or R⁵ and R⁶, or R⁹ and R¹⁰, or R¹⁶ and R¹⁹, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula IV:

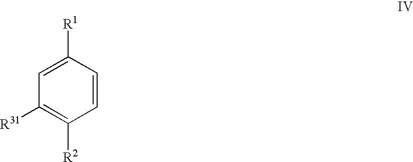

wherein R¹ is selected from the group consisting of —BR³R⁴, —C(O)R⁶, —CH₂(C(O)R⁶), —SOₙ(OH), and —POₙR⁹(OH);

wherein R² is selected from the group consisting of —CH₂OH, —N(H)R¹⁹, and —CH₂(N(H)R¹⁹);

wherein R³, R⁴, and R⁶ are independently selected from the group consisting of hydroxy and alkoxy;

wherein R⁹ is alkoxy;

wherein R¹⁹ and R³¹ are independently selected from the group consisting of hydrogen, hydrocarbyl, and substituted hydrocarbyl;

wherein n is from 0 to 2;

and wherein R³ and R⁴, or R¹⁹ and R³¹, together with the atoms to which they are independently attached, can form a substituted or unsubstituted, saturated, partially saturated or unsaturated heterocyclic ring containing from 3 to 5 carbon atoms.

In another embodiment, the method comprises contacting a methanogenic archaea medium with a methane inhibiting amount and/or a growth inhibiting amount of a compound of Formula V:

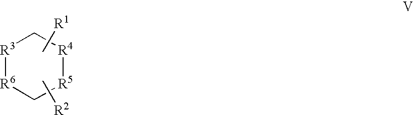

wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula VI:

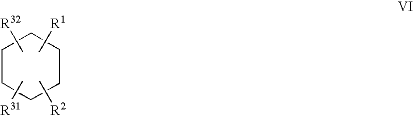

wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);

wherein R² is selected from the group consisting of hydrogen, —OR¹⁸, —C(H)R¹⁶(OR¹⁸), —OₘNR¹⁹R²⁰, —C(H)R¹⁶(N(H)R¹⁹), and —NR¹⁷(N(H)R¹⁹);

wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;

wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;

wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁸ and R¹⁷ are independently selected from the group consisting of hydrogen, hydroxy, hydrocarbyl, substituted hydrocarbyl, and heterocyclo;

wherein R¹⁶ and R¹⁸ are independently selected from the group consisting of hydrogen, hydrocarbyl, substituted hydrocarbyl, and heterocyclo;

wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;

wherein m is 0 or 1;

wherein n is an integer from 0 to 2

and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³², or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula VII:

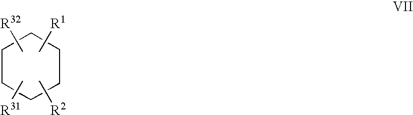

wherein R¹ is selected from the group consisting of —BR³R⁴, —C(O)R⁶, —SOₙR⁷, and —POₙR⁹R¹⁰;

wherein R² is selected from the group consisting of hydrogen, hydroxy, —C(H)R⁶(OH), —OₘNR¹⁹R²⁰, and —C(H)R¹⁶(N(H)R¹⁹);

wherein R³, R⁴, R⁶, R⁷ and R⁹ are independently selected from the group consisting of hydroxy, hydrocarbyl, and alkoxy;

wherein R⁵, R¹⁶, R³¹ and R³² are independently selected from the group consisting of hydrogen, hydroxy, amino, hydrocarbyl, and substituted hydrocarbyl;

wherein R¹⁰ is selected from the group consisting of hydrocarbyl, substituted hydrocarbyl, heterocyclo, and alkoxy;

wherein R¹⁹ and R²⁰ are independently selected from the group consisting of hydrogen, hydrocarbyl, substituted hydrocarbyl, and heterocyclo;

wherein m is 0 or 1;

wherein n is an integer from 0 to 2;

and wherein R³ and R⁴, or R⁵ and R⁶, or R⁹ and R¹⁰, or R¹⁶ and either R¹⁹ or R³¹ or R³², or R¹⁹ and either R²⁰ or R³¹ or R³², or R²⁰ and either R³¹ or R³², together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula VIII:

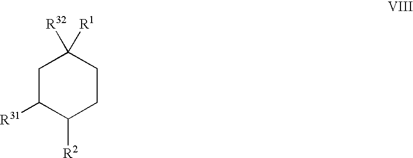

wherein R¹ is selected from the group consisting of —BR³R⁴, —C(O)R⁶, —C(H)R⁵(C(O)R⁶), —SOₙ(OH), and —POₙR⁹R¹⁰;

wherein R² is selected from the group consisting of hydrogen, hydroxy, —C(H)R¹⁶(OH), —NR¹⁹R²⁰, and —CH₂ (N(H)R¹⁹);

wherein R³, R⁴, R⁶, R⁹ and R¹⁰ are independently selected from the group consisting of hydroxy and alkoxy;

wherein R⁵ is alkyl;

wherein R¹⁶, R¹⁹, R²⁰, R³¹, and R³² are independently selected from the group consisting of hydrogen, hydroxy, amino, hydrocarbyl, and substituted hydrocarbyl;

wherein n is an integer from 0 to 2;

and wherein R³ and R⁴, or R⁵ and R⁶, or R⁹ and R¹⁰, or R¹⁹ and either R²⁰ or R³¹ or R³², or R²⁰ and either R³¹or R³², together with the atoms to which they are independently attached, can form a substituted or unsubstituted, saturated, partially saturated or unsaturated heterocyclic ring containing from 3 to 5 carbon atoms.

In another embodiment, the method comprises contacting a methanogenic archaea medium with a methane inhibiting amount and/or a growth inhibiting amount of a compound of Formula IX:

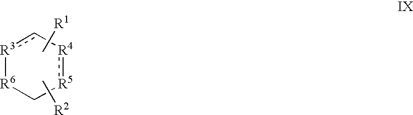

wherein the dashed lines independently indicate an optional double bond;

wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷₁, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷, and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula X:

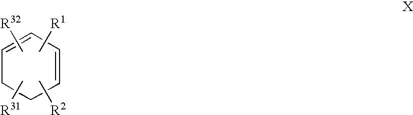

wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);

wherein R² is selected from the group consisting of hydrogen, —OR¹⁸, —C(H)R¹⁶(OR¹⁸), —OₘNR¹⁹R²⁰, —C(H)R¹⁶(N(H)R¹⁹), and —NR¹⁷(N(H)R¹⁹);

wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;

wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;

wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R¹⁶ and R¹⁷ are independently selected from the group consisting of hydrogen, hydroxy, hydrocarbyl, substituted hydrocarbyl, and heterocyclo;

wherein R¹⁶ and R¹⁸ are independently selected from the group consisting of hydrogen, hydrocarbyl, substituted hydrocarbyl, and heterocyclo;

wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;

wherein m is 0 or 1;

wherein n is an integer from 0 to 2;

and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R¹⁹ and R²⁰, or R³¹ and either R³ or R⁴ or R¹ or R⁶ or R⁷ or R⁸ or R⁹ or R¹⁰ or R¹⁶ or R¹⁷ or R¹⁸ or R¹⁹ or R²⁰ or R³², or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula XI:

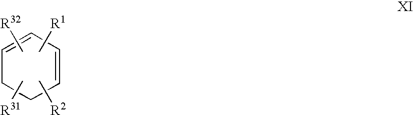

wherein R¹ is selected from the group consisting of —BR³R⁴, —C(O)R⁶, —SOₙR⁷, and —POₙR⁹R¹⁰;

wherein R² is selected from the group consisting of hydrogen, hydroxy, —C(H)R¹⁶(OH), —OₘNR¹⁹R²⁰, and —C(H)R¹⁶(N(H)R¹⁹);

wherein R³, R⁴, R⁶, R⁷ and R⁹ are independently selected from the group consisting of hydroxy, hydrocarbyl, and alkoxy;

wherein R⁵, R¹⁶, R³¹ and R³² are independently selected from the group consisting of hydrogen, hydroxy, amino, hydrocarbyl, and substituted hydrocarbyl;

wherein R¹⁰ is selected from the group consisting of hydrocarbyl, substituted hydrocarbyl, heterocyclo, and alkoxy;

wherein R¹⁹ and R²⁰ are independently selected from the group consisting of hydrogen, hydrocarbyl, substituted hydrocarbyl, and heterocyclo;

wherein m is 0 or 1;

wherein n is an integer from 0 to 2;

and wherein R³ and R⁴, or R⁵ and R⁶, or R⁹ and R¹⁰, or R¹⁶ and either R¹⁹ or R³¹ or R³², or R¹⁹ and either R²⁰ or R³¹ or R³², or R²⁰ and either R³¹ or R³², together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula XII:

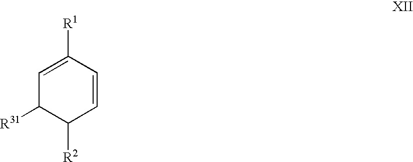

wherein R¹ is selected from the group consisting of —BR³R⁴, —C(O)R⁶, —C(H)R⁵(C(O)R⁶), —SOₙ(OH), and

wherein R² is selected from the group consisting of hydrogen, hydroxy, —C(H)R¹⁶(OH), —NR¹⁹R²⁰, and —CH₂(N(H)R¹⁹);

wherein R³, R⁴, R⁶, R⁹ and R¹⁰ are independently selected from the group consisting of hydroxy and alkoxy;

wherein R⁵ is alkyl;

wherein R¹⁶, R¹⁹, R²⁰, R³¹, and R³² are independently selected from the group consisting of hydrogen, hydroxy, amino, hydrocarbyl, and substituted hydrocarbyl;

wherein n is an integer from 0 to 2;

and wherein R³ and R⁴, or R⁵ and R⁶, or R⁹ and R¹⁰, or R¹⁹ and either R²⁰ or R³¹ or R³², or R²⁰ and either R³¹ or R³², together with the atoms to which they are independently attached, can form a substituted or unsubstituted, saturated, partially saturated or unsaturated heterocyclic ring containing from 3 to 5 carbon atoms.

In another embodiment, the method comprises contacting a methanogenic archaea medium with a methane inhibiting amount and/or a growth inhibiting amount of a compound of Formula XIII:

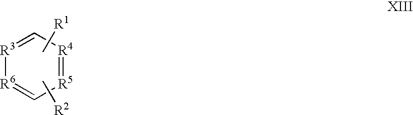

wherein R¹ is —CR⁹R¹⁰(NR¹³R¹⁴);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R²⁵ is selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

and wherein R⁹ and either R¹⁰ or R¹³ or R¹⁴, together with the atoms to which they are independently attached, form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula XIV:

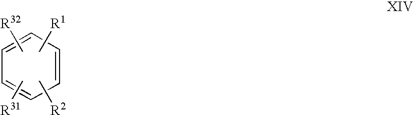

wherein R¹ is —CHR⁵(NR⁸R¹²);

wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);

wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;

wherein R²⁵ is selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁸ and R¹² are independently selected from the group consisting of hydrogen, hydroxy, hydrocarbyl, substituted hydrocarbyl, and heterocyclo;

wherein R¹⁶ and R¹⁸ are independently selected from the group consisting of hydrogen, hydrocarbyl, substituted hydrocarbyl, and heterocyclo;

wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;

wherein m is 0 or 1;

wherein n is an integer from 0 to 2;

and wherein R⁵ and either R⁸ or R¹², together with the atoms to which they are independently attached, form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula XV:

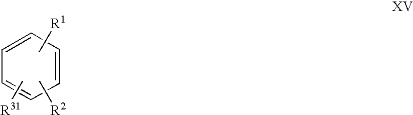

wherein R¹ is —CHR⁵(NR⁸R¹²);

wherein R² is selected from the group consisting of hydrogen, hydroxy, —C(O)R²⁵, —C(H)R¹⁶(OH), —OₘNR¹⁹R²⁰, and —C(H)R¹⁶(N(H)R¹⁹);

wherein R⁵, R⁸, R¹², R¹⁶, R²⁵ and R³¹ are independently selected from the group consisting of hydrogen, hydroxy, amino, halogen, hydrocarbyl, and substituted hydrocarbyl;

wherein R¹⁹ and R²⁰ are independently selected from the group consisting of hydrogen, hydrocarbyl, substituted hydrocarbyl, and heterocyclo;

wherein m is 0 or 1;

and wherein R⁵ and either R⁸ or R¹², together with the atoms to which they are independently attached, form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula XVI:

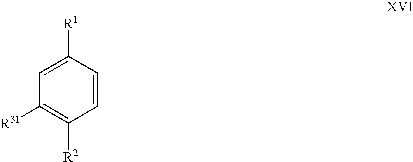

wherein R¹ is —CHR⁵(NR⁸R¹²);

wherein R² is selected from the group consisting of hydrogen, hydroxy, —C(O)R²⁵, —C(H)R¹⁶(OH), —NR¹⁹R²⁰, and —CH₂(N(H)R¹⁹);

wherein R⁵, R⁸, and R¹² are independently selected from the group consisting of hydrogen, hydrocarbyl and substituted hydrocarbyl;

wherein R¹⁶, R¹⁹, R²⁰, R²⁵ and R³¹ are independently selected from the group consisting of hydrogen, hydroxy, amino, halogen, hydrocarbyl, and substituted hydrocarbyl;

and wherein R⁵ and either R⁸ or R¹², together with the atoms to which they are independently attached, form a substituted or unsubstituted, saturated, partially saturated or unsaturated heterocyclic ring containing from 3 to 5 carbon atoms.

In another embodiment, the method comprises contacting a methanogenic archaea medium with a methane inhibiting amount and/or a growth inhibiting amount of a compound of Formula XVII:

R¹—R² XVII

wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);

wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);

wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;

wherein R¹³, R¹⁴ and R²⁹ are independently selected from the group consisting of hydrogen, hydroxy, hydrocarbyl, substituted hydrocarbyl, and heterocyclo;

wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein R²⁷, R²⁸ and R³⁶ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

and wherein R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

In another embodiment, the method comprises contacting a methanogenic archaea medium with a methane inhibiting amount and/or a growth inhibiting amount of a compound of Formula XVIII:

R¹—R² XVIII

wherein R¹ is selected from the group consisting of —C≡N, —OₘBR³R⁴, —C(H)R⁵(BR³R⁴), —OₘC(O)R⁶, —(C(H)R⁵)ₚ(C(O)R⁶), —CHR⁵(NR⁸R¹²), —CR⁵═CR¹¹(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);

wherein R² is selected from the group consisting of hydrogen, —OR¹⁸, —OₘC(O)R²⁵, —C(H)R¹⁶((OR¹⁸), —OₘNR¹⁹R²⁰, —C(H)R¹⁶(N(H)R¹⁹), and —NR¹⁷(N(H)R¹⁹);

wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;

wherein R⁵ and R¹¹ are independently selected from the group consisting of hydrogen, hydrocarbyl, substituted hydrocarbyl, heterocyclo, hydroxy, hydrocarbyloxy, substituted hydrocarbyloxy, and heterocyclooxy;

wherein R⁶, R⁷, R⁹, R¹⁰ and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;

wherein R⁸, R¹² and R¹⁷ are independently selected from the group consisting of hydrogen, hydroxy, hydrocarbyl, substituted hydrocarbyl, and heterocyclo;

wherein R¹⁶ and R¹⁸ are independently selected from the group consisting of hydrogen, hydrocarbyl, substituted hydrocarbyl, and heterocyclo;

wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;

wherein m is 0 or 1;

wherein n is an integer from 0 to 2;

wherein p is an integer from 0 to 3;

and wherein R³ and R⁴, or R⁵ and either R³ or R⁴ or R⁶ or R⁷ or R⁸ or R⁹ or R¹⁰ or R¹², or R⁸ and either R⁷ or R⁹ or R¹⁰ or R¹², or R⁹ and R¹⁰, or R¹⁶ and either R¹⁸ or R¹⁹, or R¹⁷ and R¹⁹, or R¹⁹ and R²⁰, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula XIX:

R¹—R² XIX

wherein R¹ is selected from the group consisting of —C≡N, —BR³R⁴, —C(H)R⁵(BR³R⁴), —CR⁵═CR¹¹(C(O)R⁶), —C(O)R⁶, —CHR⁵(NR⁸R¹²), —(C(H)R⁵)ₚ(C(O)R⁶), —SOₙR⁷, —C(H)R⁵(SOₙR⁷), —POₙR⁹R¹⁰, and —C(H)R⁵(POₙR⁹R¹⁰);

wherein R² is selected from the group consisting of hydrogen, hydroxy, —C(O)R²⁵, —C(H)R¹⁶(OH), —OₘNR¹⁹R²⁰, and —C(H)R¹⁶(N(H)R¹⁹);

wherein R³, R⁴, R⁶, R⁷ and R⁹ are independently selected from the group consisting of hydroxy and alkoxy;

wherein R⁵, R⁸, R¹¹, R¹², R¹⁶ and R²⁵ are independently selected from the group consisting of hydrogen, hydroxy, amino, halogen, hydrocarbyl, and substituted hydrocarbyl;

wherein R¹⁰ is selected from the group consisting of hydrocarbyl, substituted hydrocarbyl, heterocyclo, and alkoxy;

wherein R¹⁹ and R²⁰ are independently selected from the group consisting of hydrogen, hydrocarbyl, substituted hydrocarbyl, and heterocyclo;

wherein m is 0 or 1;

wherein n is an integer from 0 to 2;

wherein p is an integer from 0 to 3;

and wherein R³ and R⁴, or R⁵ and either R⁶ or R⁸ or R¹², or R⁸ and R¹², or R⁹ and R¹⁰, or R¹⁶ and R¹⁹, or R¹⁹ and R²⁰, together with the atoms to which they are independently attached, can form a substituted or unsubstituted, saturated, partially saturated or unsaturated carbocyclic or heterocyclic ring containing from 3 to 6 carbon atoms.

In another embodiment, the method comprises contacting a methanogenic archaea medium with a methane inhibiting amount and/or a growth inhibiting amount of a compound of Formula XX:

R¹—R² XX

wherein R¹ is selected from the group consisting of —C≡N, —BR³R⁴, —C(O)R⁶, —CHR⁵(NR⁸R¹²), —(C(H)R⁵)ₚ(C(O)R⁶), —CR⁵═CR¹¹(C(O)R⁶), —SOₙ(OH), —POₙR⁹R¹⁰ and —C(H)R⁵(POₙR⁹R¹⁰);

wherein R² is selected from the group consisting of hydrogen, hydroxy, —C(O)R²⁵, —C(H)R¹⁶(OH), —NR¹⁹R²⁰, and —CH₂(N(H)R¹⁹);

wherein R³, R⁴, R⁶, R⁹ and R¹⁰ are independently selected from the group consisting of hydroxy and alkoxy;

wherein R⁵, R⁸, R¹¹ and R¹² are independently selected from the group consisting of hydrogen, hydrocarbyl and substituted hydrocarbyl;

wherein R¹⁶, R¹⁹, R²⁰ and R²⁵ are independently selected from the group consisting of hydrogen, hydroxy, amino, halogen, hydrocarbyl, and substituted hydrocarbyl;

wherein n is an integer from 0 to 2;

wherein p is an integer from 0 to 3;

and wherein R³ and R⁴, or R⁵ and either R⁶ or R⁸ or R¹², or R⁸ and R¹², or R⁹ and R¹⁰, or R¹⁹ and R²⁰, together with the atoms to which they are independently attached, can form a substituted or unsubstituted, saturated, partially saturated or unsaturated heterocyclic ring containing from 3 to 5 carbon atoms.

In another embodiment, the compound represented above by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX is selected from the group of compounds illustrated in Table 1 below.

TABLE 1
Examples of Methane Inhibiting and/or Growth Inhibiting
Compounds as Embodiments

| Compound | |
|---|---|
| Number | Structural Formula |
| A1 | 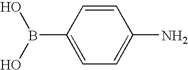 |
| A2 | 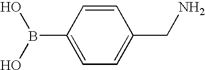 |
| A3 | 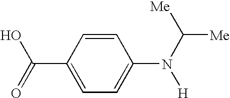 |
| A4 | 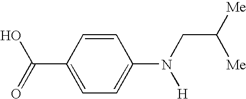 |
| A5 | 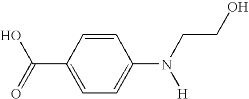 |
| A6 | 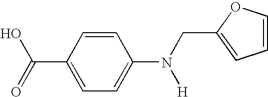 |
| A7 | 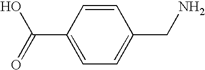 |
| A8 | 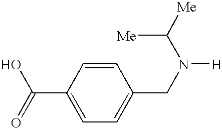 |
| A9 | 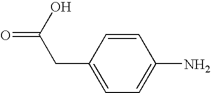 |
| A10 | 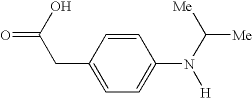 |
| A11 | 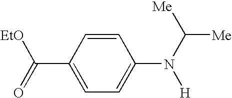 |
| A12 | 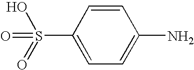 |
| A13 | 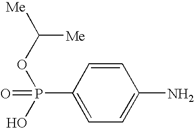 |
| A14 | 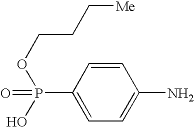 |
| A15 | 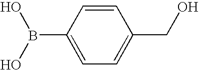 |
| A16 | 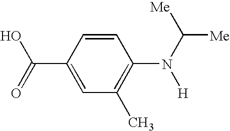 |
| A17 | 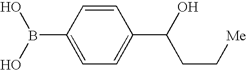 |
| A18 | 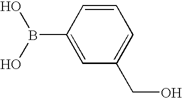 |
| A19 | 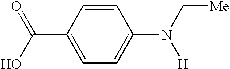 |
| A20 | 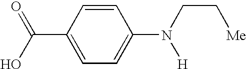 |
| A21 | 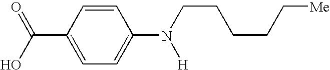 |
| A22 | 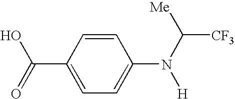 |
| A23 | 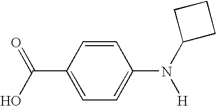 |
| A24 | 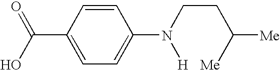 |
| A25 | 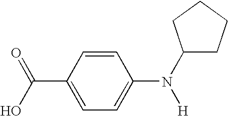 |
| A26 | 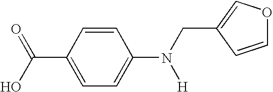 |
| A27 | 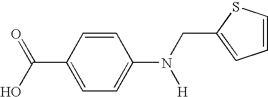 |
| A28 | 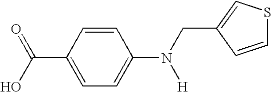 |
| A29 | 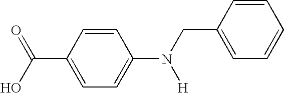 |
| A30 | 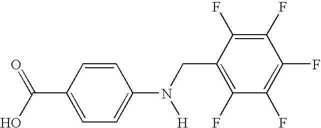 |
| A31 | 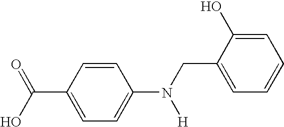 |
| A32 | 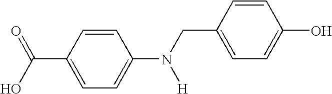 |
| A33 | 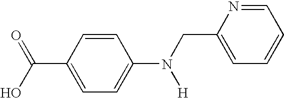 |
| A34 | 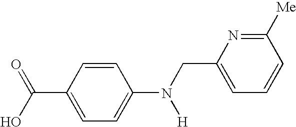 |
| A35 | 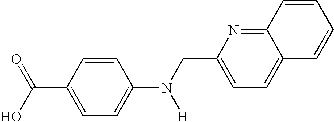 |
| A36 | 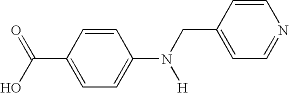 |
| A37 | 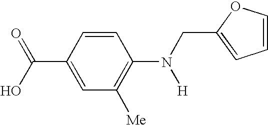 |
| A38 | 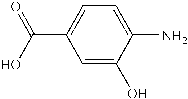 |
| A39 | 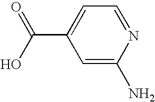 |
| A40 | 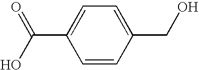 |
| A41 | 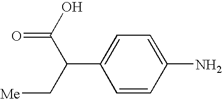 |
| A42 | 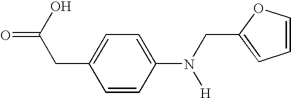 |
| A43 | 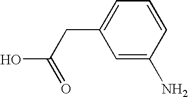 |
| A44 | 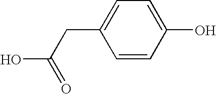 |
| A45 | 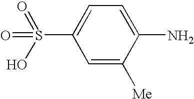 |
| A46 | 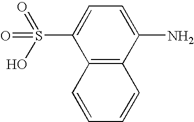 |
| A47 | 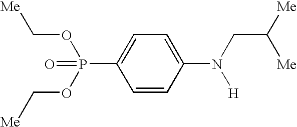 |
| A48 | 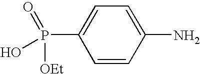 |
| A49 | 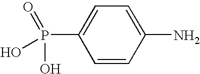 |
| A50 | 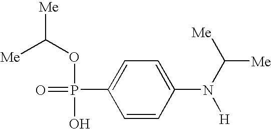 |
| A51 | 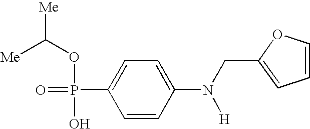 |
| A52 | 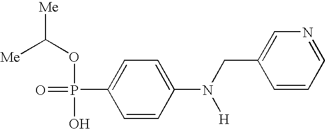 |
| A53 | 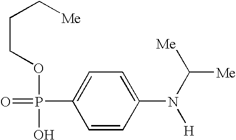 |
| A54 | 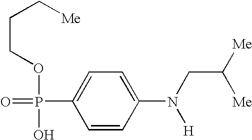 |
| A55 | 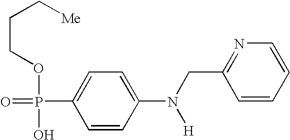 |
| A56 | 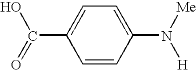 |
| A57 | 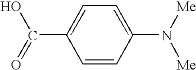 |
| A58 | 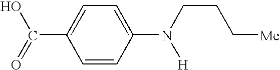 |
| A59 | 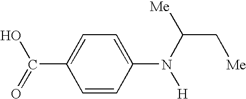 |
| A60 | 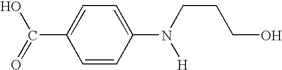 |
| A61 | 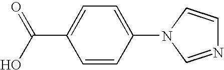 |
| A62 | 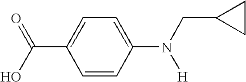 |
| A63 | 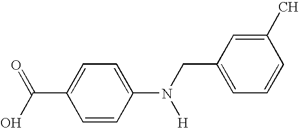 |
| A64 | 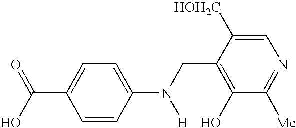 |
| A65 | 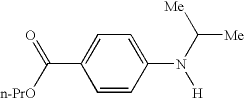 |
| A66 | 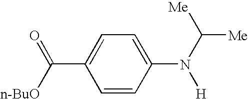 |
| A67 | 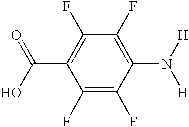 |
| A68 | 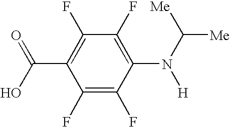 |
| A69 | 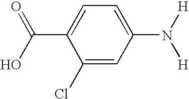 |
| A70 | 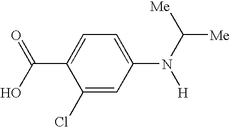 |
| A71 | 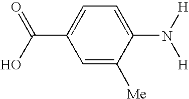 |
| A72 | 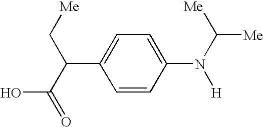 |
| A73 | 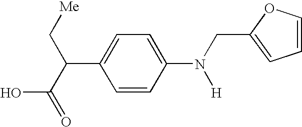 |
| A74 | 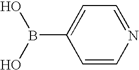 |
| A75 | 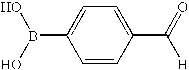 |
| A76 | 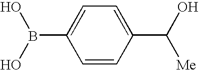 |
| A77 | 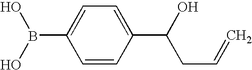 |
| A78 | 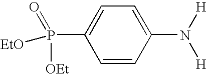 |
| A79 | 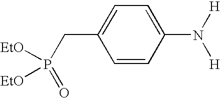 |
| A80 | 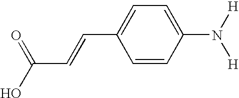 |
| A81 | 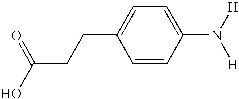 |
| A82 | 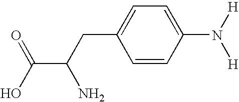 |
| A83 | 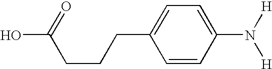 |
| A84 | 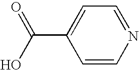 |
| A85 | 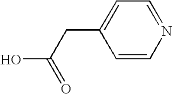 |
| A86 | 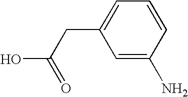 |
| A87 | 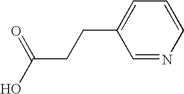 |
| A88 | 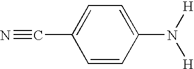 |
| A89 | 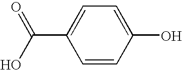 |
| A90 | 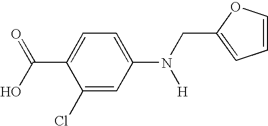 |
| A91 | 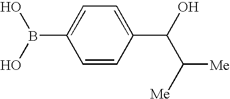 |
| A92 | 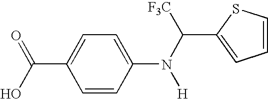 |
| A93 | 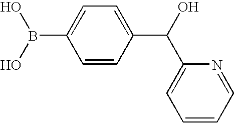 |
| A94 | 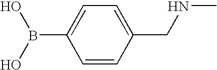 |
| B1 | 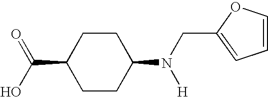 |
| B2 | 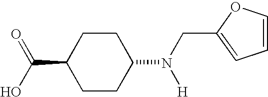 |
| B3 | 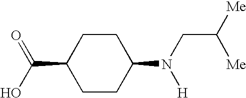 |
| B4 | 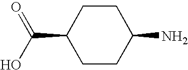 |
| B5 | 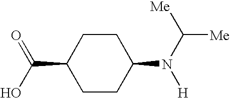 |
| B6 | 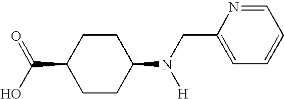 |
| B7 | 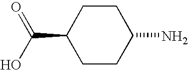 |
| B8 | 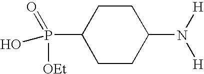 |
| C1 | 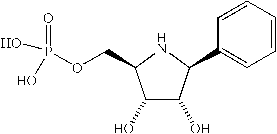 |
| C2 | 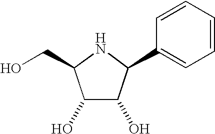 |
| C3 | 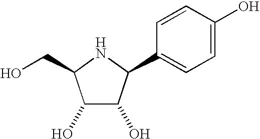 |
| C4 | 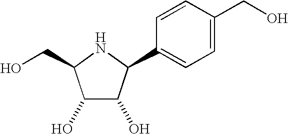 |
| D1 | 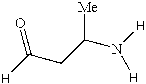 |
| D2 | 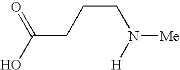 |
| D3 | 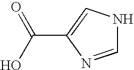 |
| D4 | 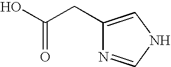 |
| D5 | 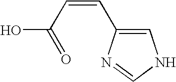 |
| D6 | 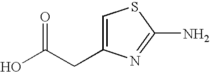 |
| D7 | 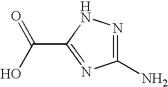 |
| E1 | 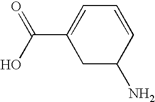 |

The compounds represented by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX and their acceptable salts, metabolites, proforms, and derivatives, may be prepared using any of the several methods known in the art for synthesis of substituted benzoic acid compounds containing analogous structures. To illustrate, however, potential synthetic approaches for preparing selected compounds delineated in Table 1 are summarized in several reaction schemes detailed in Example 1, below. Equally, if available, the compounds may be purchased from a commercial source.

The method of the present invention may be employed to inhibit methanogenesis or to inhibit the growth of methanogens in any environment that contains methanogenic archaea. Typically, however, these archaea are located in strictly anaerobic environments including the digestive tract of many animals (e.g., humans, termites and the rumen compartment of ruminant animals), landfills, stagnant ponds, anaerobic digesters and rice paddies.

In one embodiment, however, the method is utilized in ruminant animals by administering to the animal an effective rumen-modifying amount of a compound represented by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX. The method is not only advantageous in ruminants due to the presence of methanogenic archaea in the rumen compartment, but also because of the manner in which these unique animals digest and degrade the components of their feed to form molecules that can be metabolically utilized. Ruminant digestion begins when microorganisms in the rumen compartment ferment carbohydrates to produce monosaccharides and then degrade the monosaccharides to pyruvate compounds. Pyruvate is then metabolized by microbiological processes to either acetate or propionate compounds, which may be either acids or other forms of the radicals. Two acetate radicals may be combined thereafter, still in the rumen, to form butyrates.

The ruminant animal, however, can utilize butyrate, propionate, and acetate with varying degrees of efficiency. Utilization of these compounds, which are collectively known as volatile fatty acids (“VFAs”), occurs after absorption from the gut of the animal. Butyrate is utilized most efficiently, and acetate the least efficiently. The relative efficiency of use to butyrate, however, is negated by the inefficiency of its production, which must be made by the combination of two acetate radicals in the rumen.

One of the major inefficiencies in the rumen, in addition to methane production, is the synthesis of acetate. This is due to the fact that acetate is made by the degradation of a pyruvate molecule. Accordingly, each molecule of acetate that is produced is accompanied by a molecule of methane. Most of the methane produced in the rumen, as detailed above, is subsequently lost to the environment through eructation. Since butyrate is made from two molecules of acetate, each molecule of the relatively efficiently used butyrate involves the loss to the animal of two molecules of methane, with all of the associated energy.

The efficiency of carbohydrate utilization by ruminant animals, accordingly, can be markedly increased by treatments that cause the animal to produce propionate rather than acetate, while at the same time, minimizing the degree of methane production. Beneficially, when the compounds of Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX are administered in an effective rumen modifying amount, accordingly, they enhance carbohydrate utilization by increasing propionate relative to acetate and by decreasing methane production. Collectively, this increased efficiency is manifested by greater weight gains per feed intake, a reduction in energy losses by methane release, and economic advantages to the animal grower when the animal is sold for consumption.

The effective rumen-modifying amount of the compound administered to the ruminant according to the method of the current invention is preferably a quantity to achieve the desired degree of increased feed efficiency and/or inhibition of methane production. This effective amount can vary depending on many factors, such as, the size of the animal, the species of the animal, the age of the animal, the particular active compound used, the dosage form employed or the particular sensitivity of the particular animal. The optimum range of an effective amount, based on variables such as those mentioned above, can be found using conventionally known techniques, such as dose titration determinations or any other method generally known in the veterinary sciences.

An effective rumen-modifying amount of the compound is ordinarily administered substantially daily to ruminants having a developed rumen function and preferably daily during the growth and/or finishing stage of commercial meat-producing ruminants in a feed lot. Alternatively, the compound can be administered to ruminants in the pasture. “Substantially daily” administration of the compound is meant to encompass dosage schedules, such as, for example, every other day administration or administration 5 or 6 days in each 7 day period, as well as each and every day administration, all of which are within the scope of the present invention.

Preferably, as detailed above, the compound is administered to the animal by mixing it in the animal's feed as a part of any standard feed ration suitable for ruminant animals. Generally speaking, ruminant animal feed compositions are composed of various grain mixtures such as corn, oats, milo or other cereal crops along with roughage feeds such as hay, cotton seed hulls, silage or other high fiber feedstuffs commonly fed to ruminants. The percentage of each type of component (i.e. grain to roughage ratio) depends upon the dietary requirements of the particular animal. By way of example, a feed composition typically fed to feedlot cattle on an intermediate or growing diet would include:

| | Percent by Weight of |
|---|---|
| Ingredient | Total Feed Composition |
| Dehydrated Alfalfa Meal | 25.0 |
| Cottonseed Hulls | 5.0 |
| Steamrolled Corn | 60.0 |
| Soybean meal (44%) | 3.0 |
| Calcium Carbonate | 1.0 |
| Sodium Tripolyphosphate | 0.5 |
| Cane Molasses | 5.0 |
| Trace Mineral Salts | 0.5 |

The intermediate diet contains a moderate energy to roughage ratio and is fed to cattle during their growth stage. After the intermediate diet, a higher energy finishing diet is substituted until the cattle are ready for slaughter. A typical finishing diet would include:

| | Percent by Weight of |
|---|---|
| Ingredient | Total Feed Composition |
| Dehydrated Alfalfa Meal | 5.0 |
| Cottonseed Hulls | 10.0 |
| Steamrolled Corn | 74.8 |
| Soybean meal (44%) | 3.0 |
| Calcium Carbonate | 0.7 |
| Sodium Tripolyphosphate | 0.3 |
| Cane Molasses | 5.0 |
| Trace Mineral Salts | 0.5 |
| Urea | 0.7 |

Standard feed formulations are described in E. W. Crampton et al., Applied Animal Nutrition, W. H. Freeman and Company, San Francisco, Calif., 1969 and D. C. Church, Livestock Feeds and Feeding, O & B Books, Corvallis, Oreg., 1977, both of which are incorporated herein by reference.

The manner by which the compound is administered to the ruminant, however, is not a critical feature of the invention. For example, the compound may be administered to the ruminant via incorporation into tablets, drenches, boluses, or capsules, and dosed to the animals. Formulation of the compound in such dosage forms can be accomplished by means and methods well known in the veterinary pharmaceutical art.

Capsules are readily produced by filling gelatin capsules with any desired form of the compound. If desired, the compound can be diluted with an inert powdered diluent, such as a sugar, starch or purified crystalline cellulose, in order to increase its volume for convenience in filling capsules.

Tablets containing the compound utilized in this method may be made by any conventional pharmaceutical process. Manufacture of tablets is a well-known and highly-advanced art. In addition to the active ingredient, a tablet usually contains a base, a disintegrator, an absorbent, a binder, and a lubricant. Typical bases include lactose, fine icing sugar, sodium chloride, starch and mannitol. Starch is also a good disintegrator as is alginic acid. Surface active agents such as sodium lauryl sulfate, dioctyl sodium sulphosuccinate or other anionic surfactants are also sometimes used. Commonly used absorbents again include starch and lactose, while magnesium carbonate is also useful for oily substances. Frequently used binders are gelatin, gums, starch, dextrin and various cellulose derivatives. Among the commonly used lubricants are magnesium stearate, talc, paraffin wax, various metallic soaps, and polyethylene glycol.

This method can also be practiced by the administration of the compound by a time or delayed release bolus. These boluses are made in a manner similar to tablets, except that a means to delay the dissolution of the compound is provided, thereby resulting in its gradual release into the animal's system. Boluses may be made to release for lengthy periods. The slow dissolution is preferably facilitated by choosing a highly water-insoluble form of the compound. A substance such as iron filings is typically added to raise the density of the bolus and keep it static on the bottom of the rumen. Dissolution of the compound may be delayed by use of a matrix of insoluble materials in which the compound is embedded. For example, substances such as vegetable waxes, purified mineral waxes, and water insoluble polymeric materials are useful.

Drenches containing the compound may also be employed and are prepared preferably by choosing a water soluble or water dispersable form of the compound. If an insoluble form is desired, a suspension may be made. Alternatively, a drench may be formulated as a solution in a physiologically acceptable solvent such as a polyethylene glycol. Suspension of insoluble forms of the compound can be prepared in non-solvents such as vegetable oils such as peanut, corn, or sesame oil; in a glycol such as propylene glycol or a polyethylene glycol; or in water, depending on the form of the compound chosen.

Suitable physiologically acceptable adjuvants are preferably employed in order to keep the compound suspended. The adjuvants may be chosen from among the thickeners, such as carboxymethylcellulose, polyvinylpyrrolidone, gelatin, and the alginates. Many classes of surfactants also will serve to suspend the compound. For example, lecithin, alkylphenol polyethylene oxide adducts, naphthalene sulfonates, alkylbenzenesulfonates and the polyoxyethylene sorbitan esters are useful for making suspension in liquid nonsolvents.

In addition, many substances which effect the hydrophilicity, density, and surface tension of the liquid may assist in making suspensions in individual cases. For example, silicone antifoams, glycols, sorbitol, and sugars can be useful suspending agents.

Alternatively, the compound may also be administered in the drinking water of the ruminants. Incorporation into drinking water is performed by adding a water soluble or water suspendable form of compound to the water in the proper amount. Formulation of the compound for addition to drinking water follows the same principles as formulation of drenches set forth above.

The preferred method of administering the compound to the ruminant is by formulation of the compound into the ruminant's feed supply. The compound may be added to any type of feed, including but not limited to, common dry feeds, liquid feeds, and pelleted feeds.

The methods of formulating substances, such as the compound utilized in the method of the present invention, into animal feeds are well known. In a typical method, a concentrated premix containing the substance is prepared and this premix is then added to the feed formulation. Premixes may be either liquid or solid.

All of the methods of formulation, mixing, and pelleting feedstuffs which are normally used in the ruminant feed art are suitable for manufacturing feeds containing the compound employed in the method of the invention.

In addition to a compound represented by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX, the feed composition may also include any agent that beneficially impacts ruminant feed efficiency. Typically the agent selected will inhibit methanogenesis or the growth of methanogens via a mechanism other than through the inhibition of methanopterin so as to provide an enhanced treatment when administered along with a compound represented by Formulas XXXA, XXX, IA, IIA, IIIA, IVA, I, II, III, IV, V, VI, VII, VIII, IX, X, XI, XII, XIII, XIV, XV, XVI, XVII, XVIII, XIX and/or XX. By way of example, such agents include 2-bromoethanesulfonic acid (as described in Irmgard et al. (1996), Arch. Anim. Nutr. 49:363-370, which is hereby incorporated by reference in its entirety); dithiooxide and dithiooxide derivatives as described in U.S. Pat. No. 3,949,090; phthalides and phthalides derivatives as described in U.S. Pat. No. 4,333,923; anthraquinone compounds as described in U.S. Pat. No. 5,648,258; and 5-substituted tetrazoles as described in U.S. Pat. No. 4,461,772, all of which are hereby incorporated by reference in their entirety.

Moreover, it is common in the animal sciences to treat animals, including ruminants, with a variety of growth promoters, disease preventives, and disease treatments throughout their lives. Such drugs are often used in combination. The method of this invention may be practiced in combination with these other treatments.

The compound according to the method of the invention may be safely and advantageously administered to any ruminant animal including, but not limited to, cattle, sheep, deer, goats, musk, ox, buffalo, giraffe and camels. In a preferred embodiment the compound is administered to cattle or sheep.

The detailed description set-forth above is provided to aid those skilled in the art in practicing the present invention. Even so, this detailed description should not be construed to unduly limit the present invention as modifications and variation in the embodiments discussed herein can be made by those of ordinary skill in the art without departing from the spirit or scope of the present inventive discovery.

All publications, patents, patent applications and other references cited in this application are herein incorporated by reference in their entirety as if each individual publication, patent, patent application or other reference were specifically and individually indicated to be incorporated by reference.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

Abbreviations and Definitions

To facilitate understanding of the invention, a number of terms and abbreviations as used herein are defined below:

The phrase “rumen-modifying amount”, when used herein unless otherwise indicated, refers to an amount of compound, which, when administered to a ruminant, produces any one or more of the following effects: (1) an increase in the amount of propionate relative to acetate present in the rumen of the animal, (2) a decrease in the methane concentration in the rumen by inhibiting methanogenesis, (3) a decrease in methane concentration in the rumen by inhibiting the growth of methanogenic archaea, (4) an increase in the amount of acetate, and (5) an increase in the amino acid nitrogen level in the rumen. These effects, either singly or in combination, improve feed utilization efficiency and/or growth rate in ruminants.

The phrase “effective methane inhibiting amount”, when used herein unless otherwise indicated, is intended to qualify the amount of compound, which, when contacted with a methanogenic archaea medium will achieve the desired degree of methane inhibition.

The phrase “effective growth inhibiting amount”, when used herein unless otherwise indicated, is intended to qualify the amount of compound, which, when contacted with a methanogenic archaea medium will achieve the desired degree of growth inhibition.

The phrase “methanogenic archaea medium”, when used herein unless otherwise indicated, means any environment where methanogenic archaea are present.

The phrase “feed efficiency”, when used herein unless otherwise indicated, refers to the ratio of daily feed intake of the animal to the average daily gain of such animal and is generally expressed in pounds.

The “ruminant” when used herein is meant to encompass mature and immature animals with multi-compartment stomachs, including but not limited to, cattle, sheep, deer, goats, musk, ox, buffalo, giraffe and camels. For example, cattle and sheep have a stomach with four compartments comprising the rumen, reticulum, omasum and abomasum.

The term “inhibitor” when used herein specifically refers to an enzyme inhibitor unless otherwise indicated. Enzyme inhibitors are agents and/or compounds that stop, prevent, or reduce the rate of an enzymatic reaction via any mechanism including, but not limited to, competitive inhibition, noncompetitive inhibition, and uncompetitive inhibition.

The term “inhibition” when used herein in phrases such as “growth inhibition” or “inhibition of methane production” means any decrease in growth, in terms of number of archaea, or any decrease in the concentration of methane, as compared to the growth or concentration that would occur in the absence of the application of the method of the invention.

The term “methanogen” or “methanogenic archaea” are used interchangeably herein and mean any organism capable of methanogenesis. These organisms include, for example, the genera Methanococcus, Methanobacterium, Methanosarcina, Methanobrevibacter, Methanothermus, Methanothrix, Methanospirillum, Methanomicrobium, Methanococcoides, Methanogenium, Methanobacter and Methanoplanus.

The abbreviation “RFA-P” synthase stands for 4-(beta-D-ribofuranosyl)aminobenzene 5′-phosphate. RFA-P synthase is an enzyme that catalyzes the first step in methanopterin biosynthesis.

The abbreviation “H₄MPT” stands for tetrahydromethanopterin.

The abbreviation “rt” stands for room temperature

The abbreviation “PRPP” stands for phosphoribosylpyrophosphate.

The abbreviation “COMSH” stands for Coenzyme M, mercaptoethanesulfonate.

The abbreviation “HS-HTP” stands for heptanoylthreonine phosphate, also known as Coenzyme B.

The abbreviation “MFR” stands for methanofuran.

The abbreviation “VFA” stands for volatile fatty acid.

The terms “hydrocarbon” and “hydrocarbyl” as used herein describe organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, such as alkaryl, alkenaryl and alkynaryl. Unless otherwise indicated, these moieties preferably comprise 1 to 20 carbon atoms.

The “substituted hydrocarbyl” moieties described herein are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. These substituents include halogen, heterocyclo, alkoxy, alkenoxy, alkynoxy, aryloxy, hydroxy, protected hydroxy, keto, acyl, acyloxy, nitro, amino, amido, cyano, thiol, ketals, acetals, esters and ethers.

Unless otherwise indicated, the alkyl groups described herein are preferably lower alkyl containing from one to eight carbon atoms in the principal chain and up to 20 carbon atoms. They may be straight or branched chain or cyclic and include methyl, ethyl, propyl, isopropyl, butyl, hexyl and the like.

Unless otherwise indicated, the alkenyl groups described herein are preferably lower alkenyl containing from two to eight carbon atoms in the principal chain and up to 20 carbon atoms. They may be straight or branched chain or cyclic and include ethenyl, propenyl, isopropenyl, butenyl, isobutenyl, hexenyl, and the like.

Unless otherwise indicated, the alkynyl groups described herein are preferably lower alkynyl containing from two to eight carbon atoms in the principal chain and up to 20 carbon atoms. They may be straight or branched chain and include ethynyl, propynyl, butynyl, isobutynyl, hexynyl, and the like.

The terms “aryl” or “ar” as used herein alone or as part of another group denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl is the more preferred aryl.

The terms “halogen” or “halo” as used herein alone or as part of another group refer to chlorine, bromine, fluorine, and iodine.

The terms “heterocyclo” or “heterocyclic” as used herein alone or as part of another group denote optionally substituted, fully saturated or unsaturated, monocyclic or bicyclic, aromatic or nonaromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heterocyclo include heteroaromatics such as furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, ketals, acetals, esters and ethers.

The term “heteroaromatic” as used herein alone or as part of another group denote optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heteroaromatics include furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxy, protected hydroxy, acyl, acyloxy, alkoxy, alkenoxy, alkynoxy, aryloxy, halogen, amido, amino, nitro, cyano, thiol, ketals, acetals, esters and ethers.

The abbreviation “TBSCl” stands for tert-butyldimethylsilyl chloride.

The abbreviation “TFAA” stands for trifluoroacetic anhydride.

The abbreviation “TMSI” stands for trimethylsilyl iodide.

### EXAMPLES

### Example 1

Compounds described herein may be available commercially, or may be prepared according to the general synthetic procedures described below and illustrated in Schemes 1-8.

Preparation of Benzoic Acid Derivatives

The 4-(alkylamino)benzoic acid derivatives in Table 1 may be made via any of three routes. The first, shown in Scheme 1, is the direct reductive amination of an aldehyde or ketone by one of two methods: (a) treatment of the requisite aldehyde or ketone (R⁵C(O)R⁶) and commercially available benzoic acid derivatives (e.g., 4-aminobenzoic acid, 4-amino-3-hydroxybenzoic acid, 4-amino-3-methylbenzoic acid, etc.) with sodium cyanoborohydride in a mixture of ethanol and acetic acid or with hydrogen and a palladium catalyst in methanol or other suitable solvent, or (b) by treatment of the requisite aldehyde or ketone (R⁵C(O)R⁶) and commercially available 4-nitrobenzoic acid derivatives with hydrogen (1 atm balloon pressure) and a palladium catalyst (10-20% of 10% Pd/C) in methanol or other suitable solvent until TLC/NMR shows complete conversion, followed by filtration through celite, concentration, and then purification by column chromatography.

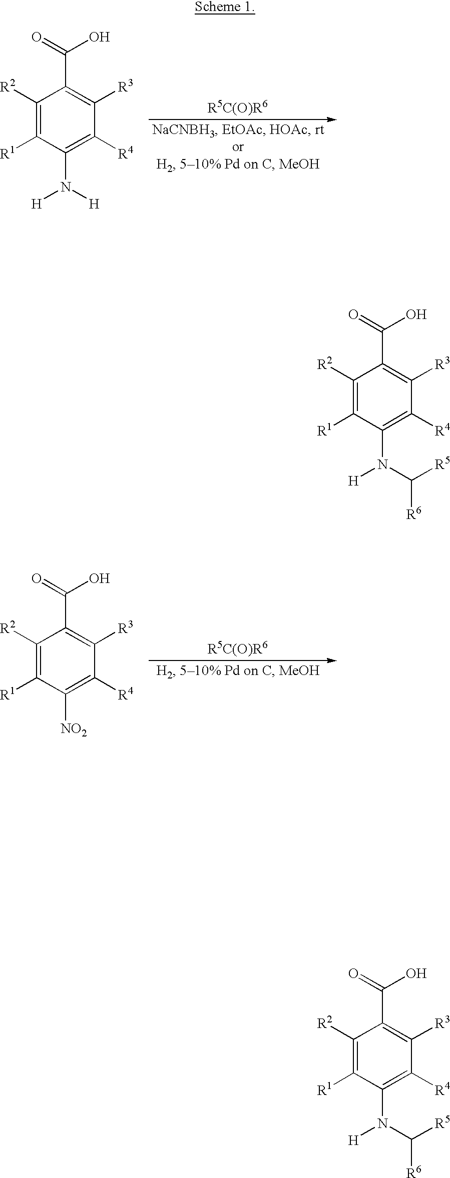

Alternatively, such derivatives can be prepared via a two-step procedure involving treatment of the requisite aldehyde or ketone (R⁵C(O)R⁶) with either a 4-nitrobenzoate under hydrogenation conditions (H₂, 5-10% Pd on C catalyst in methanol or other suitable solvent), or a 4-aminobenzoate (e.g., ethyl 4-aminobenzoate) and sodium cyanoborohydride in a mixture of ethanol and acetic acid to give the 4-(alkylamino)benzoate derivative. The ester can be hydrolyzed (aq. KOH in ethanol) to give the 4-(alkylamino)benzoic acid derivatives shown in Table 1 and related structures.

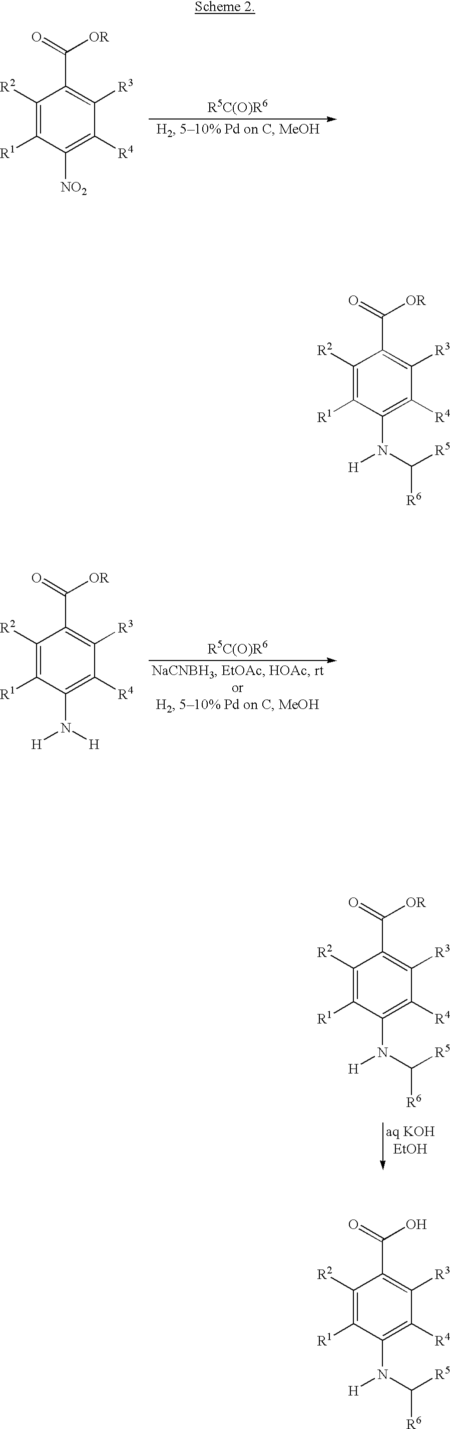

Equally, methods similar to those described in Schemes 1 and 2 may be used to prepare other N-alkyl derivative compounds shown in Table 1 and related structures from the commercially available compounds, 4-(aminomethyl)benzoic acid (Compound A7), 4-amino-3-methylbenzoic acid (Compound A37) and (4-aminophenyl)acetic acid (Compound A9) via reductive amination as illustrated in Scheme 3.

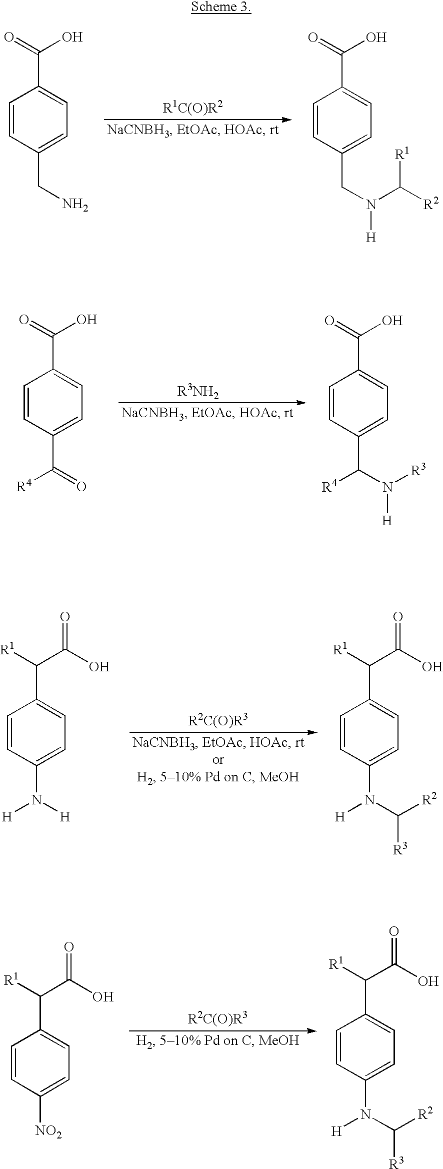

### Preparation of Phosphorus Derivatives

The phosphorus derivatives shown in Table 1 and related structures may be prepared via the sequence outlined in Scheme 4. Palladium catalyzed cross-coupling of 1-bromo-4-nitro benzene with a variety of phosphinic acids (10 mol % Pd(Ph₃P)₄, triethylamine, toluene, heat, as per Bull. Chem. Soc. Jpn., 1982, 55, 909) affords the intermediate phosphonate.

The nitro group may be converted to a monosubstituted amine via reduction-reductive amination. To a solution of the aromatic nitro compound and a suitable aldehyde or ketone (1.1-2 equivalents) in methanol (or any other solublizing solvent suitable for hydrogenation) is added 10-20 wt % of 10% Pd on C. The resulting slurry is stirred under H₂ (ca. 1 atm, balloon pressure) and the course of the reaction monitored by TLC analysis. Upon complete conversion, the reaction mixture is filtered through celite and concentrated. Chromatography on silica gives the desired compound.

Selective partial hydrolysis of the phosphonate (aq. NaOH, EtOH, as per Bartlett et al., J. Org. Chem., 1996, 55, 6268) affords the mono-acid. Hydrogenation of the nitro group (H₂ (1 atm), 10% Pd/C, EtOH) affords the desired compound or, alternatively, reduction-reductive amination via the procedure described above affords the desired substituted compounds.

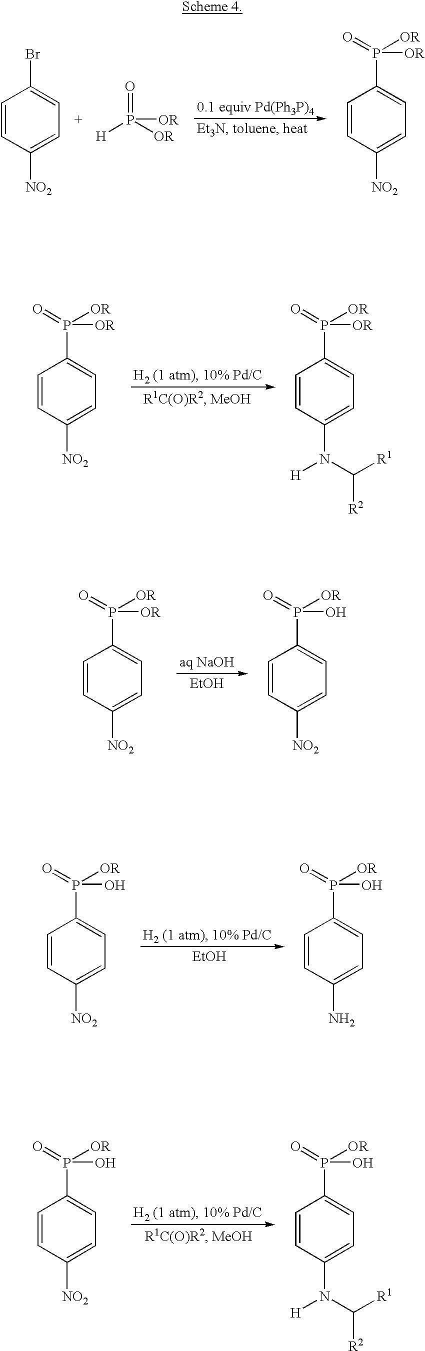

### Preparation of Boronic Acid Derivatives

The substituted aryl boronic acids are prepared as outlined in Scheme 5 using the following general procedures.

To a solution of 4-bromobenzaldehyde (1 equivalent) in dry THF (ca 0.5 M) cooled in an ice-bath is added the appropriate Grignard reagent (1.1 equivalent) dropwise, maintaining the internal temperature below 5° C. The Grignard reagents used are either commercially available, e.g., n-propylmagnesium bromide, or prepared via standard methods. The resulting mixture is stirred for 1 h with cooling, and then at room temperature for an additional 4-6 h. The reaction is slowly quenched by the addition of with 1 M aq. NH₄Cl, maintaining the internal temperature below 25° C. The resulting mixture is extracted with ether, and the ether extracts washed with brine. The organic layer is dried (anhydrous Na₂SO₄) and the solvent removed under reduced pressure to yield the corresponding phenylalkanol which is used without further purification.

The hydroxy group is protected by stirring a mixture of alcohol (1 equivalent), dihydropyran (1.5 equivalents) and pyridinium p-toluenesulfonate (“PPTS”, 0.1 equivalents) in dry methylene chloride (ca 0.1-0.5 M) at room temperature for 4 h. The resulting solution is partitioned between ether-brine and the organic layer dried and concentrated. Chromatography on silica affords the desired intermediate substituted arylbromide.

A flame-dried round-bottomed flask is charged with the substituted arylbromide compound in dry THF (0.01 to 0.5 M) under N₂ atmosphere. The resulting solution is cooled to −78° C. To this solution is added tert-butyllithium (1.7 M solution, 1.1 equivalents) dropwise. The resulting solution is stirred at −78° C. for 2 hours whereupon a solution of trimethylborate (2 equivalents) in THF (1 M) is added dropwise. The resulting solution is allowed to slowly warm to room temperature overnight. The reaction is quenched by the addition of 20% aqueous HCl and the resulting mixture concentrated to half of its original volume by rotary evaporation at 30° C. The mixture is extracted with ethyl acetate and the resulting ethyl acetate extract washed with water. The organics are dried and concentrated to afford the crude product, which is purified by chromatography on silica. As illustrated in Scheme 5, this latter metallation-borylation procedure may be adapted to prepare Compound A94 and related compounds via metallation of the 4-bromoaryl amine derivative. The latter compounds are prepared by adapting the method of Singer et al. (J. Med. Chem., 1989, 29, 40.)

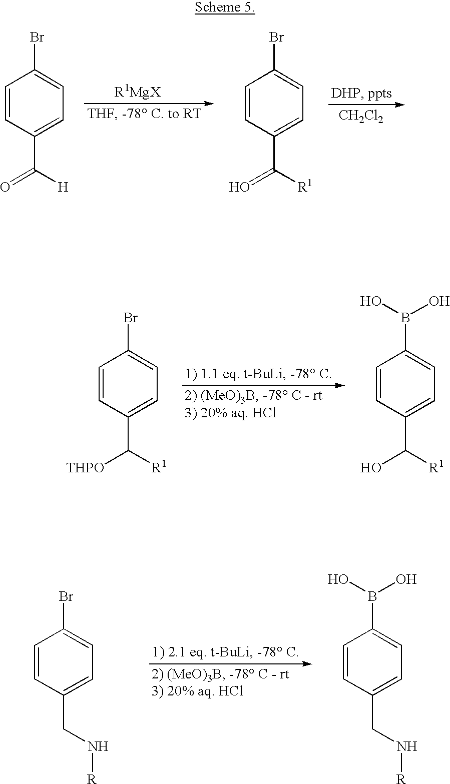

### Preparation of Sulfonic Acid Derivatives

The sulfonic acid derivatives shown in Table 1 and related compounds are either commercially available or can be prepared via a reduction-reductive amination sequence as illustrated in Scheme 6. Treatment of the 4-nitrophenyl sulfonic acid with treatment with the requisite aldehyde or ketone (R³C(O)R⁴), hydrogen and a palladium catalyst in methanol or other suitable solvent affords the desired derivatives.

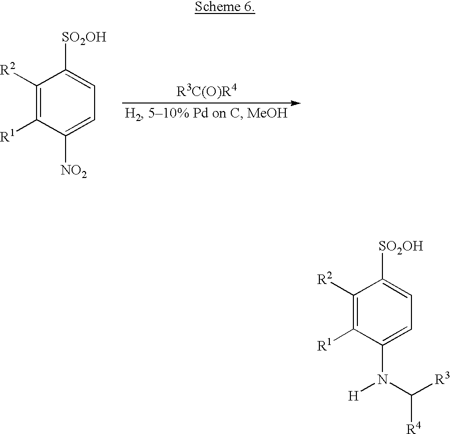

### Preparation of Cyclohexane Carboxylic Acid Derivatives

The cyclohexane carboxylic acid derivatives shown in Table 1 and related compounds can be prepared from the corresponding known cis- and trans-4-aminocyclohexane carboxylic acids. These latter compounds are prepared from ethyl 4-nitrobenzoate via hydrogenation (Pearlman, Org. Synth. Coll. Vol. V, 1973, 670) and subsequent separation of the isomers. As shown in Scheme 7, reductive amination of cis- or trans-4-aminocyclohexane carboxylic acid may be carried out by (a) treatment with the requisite aldehyde or ketone (R²C(O)R³) and sodium cyanoborohydride in a mixture of ethanol and acetic acid, or (b) treatment with the requisite aldehyde or ketone (R²C(O)R³) and hydrogen and a palladium catalyst in methanol or other suitable solvent.

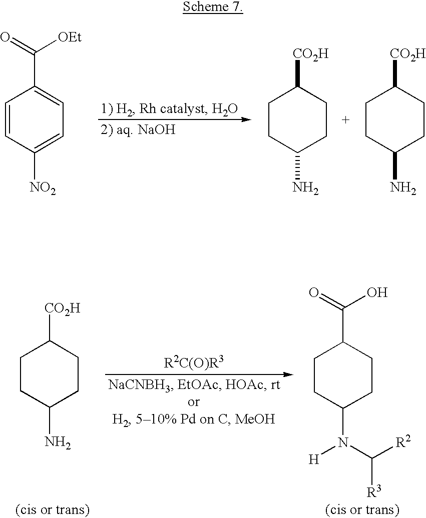

The cyclohexane phosphonic acid derivatives shown in Table 1 and related compounds can be prepared by the reduction of alkyl 4-nitrophenyl phosphonic acid via hydrogenation in the presence of a rhodium catalyst or other hydrogenation catalyst, as shown in Scheme 7A.

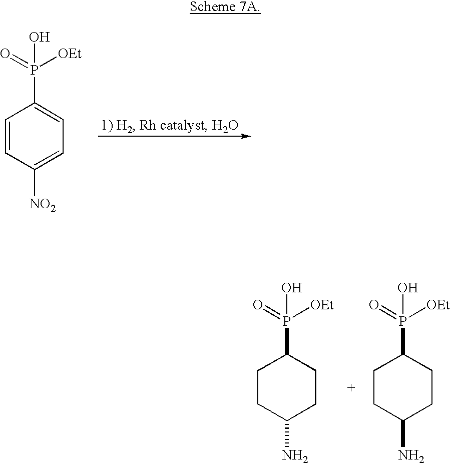

### Preparation of Azasugars and Derivatives

The aza-ribose derivatives shown in Table 1 and related compounds can be according to the multi-step sequence outlined in Scheme 8 and described below.

Ribose is converted to the silyl-protected acetonide 1 via the procedure of Kashkar et al. (Synlett. 1990, 1031.) The process for the conversion of 1 to the aza-ribose derivative 5 was adapted from the procedures of Yokoyama et al. (J. Org. Chem. 1996, 61, 6079.) Addition of an organometallic reagent (either commercially available or prepared by standard methods of metal halogen exchange) affords the diol 2. The diol 2 is oxidized by using a Swern-type oxidation to give the diketone 3. Reductive amination by treatment of 3 with ammonium formate and sodium cyanoborohydride in methanol affords the protected azo-ribose derivatives 4. Deprotection is effected by treatment of 4 with 70% aqueous trifluoroacetic acid (for example, to give compounds C1-C3 and related compounds).

Compound 4 may be converted to the desired phosphonic acid derivatives by adapting the methods of Szulc et al. (Tetrahedron Lett. 2000, 7821.) to a solution of 4 in pyridine (0.1-0.5 M) is added trimethyl phosphite (1.4 equivalents) and CBr₄ (1.25 eq.). The resulting mixture is stirred at room temperature; after complete reaction, the volatiles are removed via rotary evaporation. Purification of the residue by column chromatography gives compound 6. A solution of 6 in acetonitrile 0.1-0.5 M) is treated with trimethylsilyliodide (TMSI, 2.2 mmol). After stirring at room temperature overnight, water is added and the resulting mixture is stirred for 1 hr. The volatiles are removed via rotary evaporation, and the residue is washed several times with diethyl ether. The resulting solid is dissolved in water and filtered, and the filtrate concentrated to afford 7.

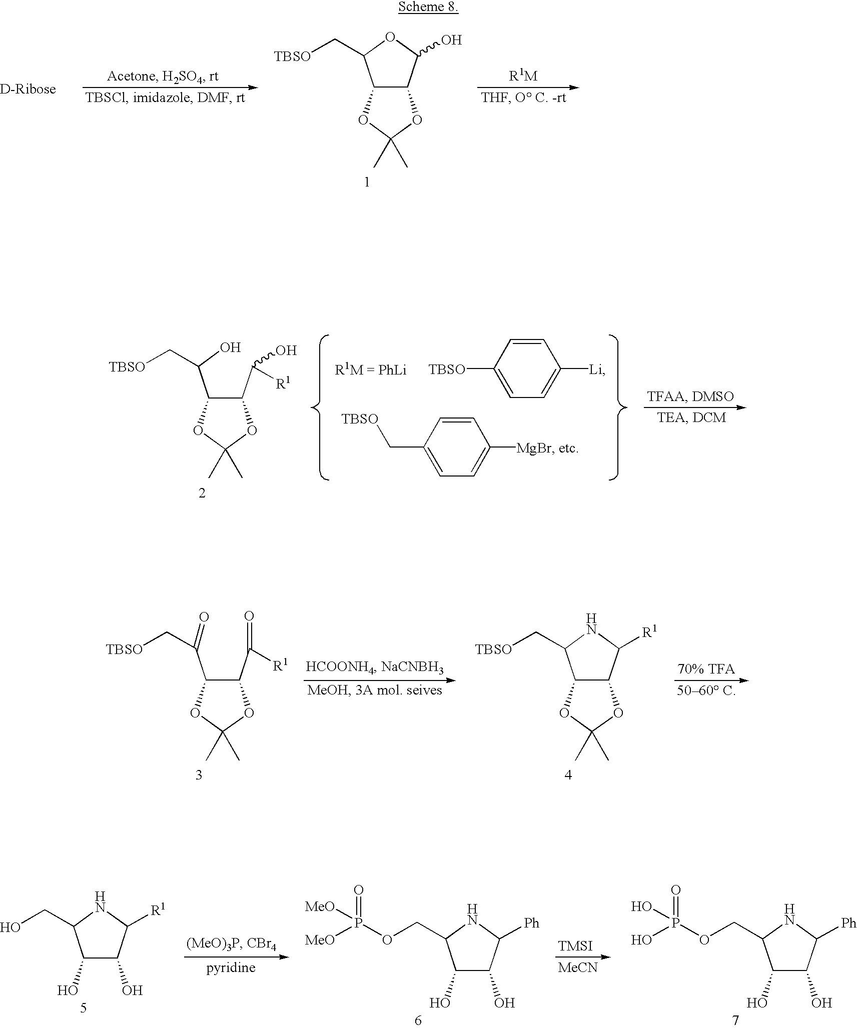

### Example 2

### Cloning and Over Expression of the RFA-P Synthase Gene

RFA-P synthase from Methanosarcina thermophila has been purified over 4000-fold to electrophoretic homogeneity. The N-terminal sequence of the purified protein was determined and genes corresponding to this sequence were found in the genomes of three thermophilic Archaea: Archaeoglobus fulgidus and M. marburgensis, and Methanococcus jannaschii. The polymerase chain reaction was used to clone the gene from A. fulgidus into the pET41a overexpression vector (Novagen, Madison, Wis.) and the gene was expressed in Escherichia coli. The enzyme was produced as a soluble protein, and active enzyme could be purified to greater than 90% purity by heating cell extracts to 80° C. The partially purified protein catalyzed the reaction of RFA-P synthase and may be used to test compounds described herein.

### Example 3

### Assay to Determine RFA-P Synthase Activity in Vitro

Generally speaking, the activity of RFA-P synthase is monitored by using p-aminobenzoate with a radioactive label in the carboxyl group that is eliminated during the reaction catalyzed by the enzyme. The reaction is quenched with perchloric or sulfuric acid, unlabeled bicarbonate is added, and the reaction is vortexed to remove the labeled CO₂ and leave the unlabeled product. Thus, product formation is measured as decrease in counts from the labeled substrate. This is a rapid assay that facilitates purification and inhibition studies. This assay is performed in the presence and absence of the inhibitors.

This method for assaying RFA-P synthase is used in two different modes. In assaying over one-hundred fractions from a chromatography column, a single time-point assay to determine which fractions have activity is performed. Quantitative assays are then performed to determine the specific activity. In this highly quantitative mode, aliquots are removed from the assay mixture at different time points to allow measurement of the decay of ¹⁴CO₂ with time. This assay is also employed in inhibition studies.

Specifically, for the results detailed below, the enzymatic assay was performed by incubating 3 mM ¹⁴C-carboxy-labeled pABA with 10 mM PRPP in 0.25 mL of 100 mM -[Tris(hydroxy-methyl)-methyl]-2-aminoethane-sulfonic acid (TES) Buffer, pH 4.8, and initiated by adding enzyme. The ¹⁴C-label is eliminated as ¹⁴CO₂ during the reaction, thus, the radioactivity decreases as the reaction proceeds. The reaction mixture was quenched with 100 μL of 1 M citric acid, pH 3.5, and the residual radioactivity was determined by liquid scintillation counting.

### Example 4

### Determination of the Effect of RFA-P Synthase Inhibitors on Methane Formation and Growth of Methanogens in Culture

Generally speaking, each compound can be evaluated to determine how effectively it inhibits RFA-P synthase in vitro by checking growth and methane production by growing methanogens. The primary test organism is H₂/CO₂-grown M. marburgensis, which is a thermophilic methanogen. Generality of the inhibitors is assessed by comparing the inhibition patterns with H₂/CO₂-grown Methanobrevibacter smithii, a mesophilic methanogen isolated originally from human feces (as detailed in Miller et al. (1982) Environ. Microbiol. 43:227-32). By measuring the inhibition patterns in these two diverse microbes, methanogenesis inhibition can be determined for each inhibitor.

Specifically, for the results detailed below, M. marburgensis (Strain OCM82) was obtained from the Oregon Collection of Methanogens and was cultured on H₂/CO₂/H₂S (80%/20%/0.1%) at 65° C. in 15 mL Hungate tubes (as described in Schonheit, et al. (1980) Archives of Microbiology 127:59-65). Growth was followed by measuring the optical density at 580 nm. Moorella thermoacetica (Strain ATCC No. 39073) was grown at 55° C. as previously described (Andreesen J. et al. (1973) J. Bacteriol. 114:743-751). Methanobrevibacter smithii (ATCC No. 35061)was grown at 37° C. in 20 mL Hungate tubes containing 5 mL of media that included 12.5 g/L each of cystein-HCL and N₂S as reducing agents and 1.1 mM vancomycin while shaking at 200 rpm as previously described (Pavlostathis et al. (1988) Appl. Environ. Microbiol. 54:2655-2659). The culture tubes were pressurized initially at 30 hour intervals with 190 kPa H₂/CO₂ (80/20), while growth was assessed by measuring the optical density at 580 nm.

### Example 5

### Determination of Effects of RFA-P Synthase Inhibitors on Ruminal Fermentation

Generally speaking, the effect of the RFA-P synthase inhibitors on acetate formation and growth of acetogenic bacteria in culture using Moorella thermoacetica can be determined. RFA-P synthase inhibitors can be screened in batch cultures inoculated with ruminal contents from steers. The primary criterion is methane production. Compounds that inhibit methanogenesis are then further evaluated. The effects of these inhibitors on production of hydrogen and volatile fatty acids (VFA) like acetate, propionate, and butyrate, and their effects on microbial population changes can be determined. Furthermore, chronic effects of inhibitors can be evaluated in a semi-continuous culture system.

The batch culture method (Goering, H. K., and Van Soest, P. J. (1970) “Forage Fiber Analyses: Apparatus, reagents, procedures, and some applications.” Agric. Handbook, ARS-USDA 379: 12-15.) includes a bicarbonate- and phosphate-based buffer with added macro and microminerals, ammonium, and trypticase to preclude a nutritional limitation to fermentation and includes titanium citrate, cysteine, or sodium sulfide as a reductant (Zehnder, A. J. B. and Wuhrmann, K. (1976) “Titanium(III) citrate as a nontoxic oxidation-reduction buffering system for the culture of obligate anaerobes.” Science 194: 1165-1166.). Cellobiose can be added because fibrolytic species are the predominant hydrogen producers and this substrate promotes significant methanogenesis because it is more defined than ground forages, and can be accurately and reproducibly added to the medium due to its high solubility. Five mL of culture is incubated in 9.4 mL glass vials that are sealed and crimped with gas-tight septa. Fresh ruminal fluid is obtained from two ruminally fistulated steers maintained on a 70% forage diet, strained through cheesecloth, and added to buffer at 20% of final volume. Initially, the 4.4-mL head space in the vial consists of CO₂ or CO₂/H₂ (80/20, v/v). Candidate inhibitors are added to triplicate cultures in logarithmically spaced concentrations between 10 mM and 1 nM. Each experiment includes cultures containing a known inhibitor of methanogenesis, 2-bromoethanesulfonate, as a positive control. After 20 or 24 hours at 37° C., the head space pressure is measured using a manometer and 500 microliter of head gas is assayed for methane and hydrogen by gas chromatography with a silica gel column using a thermal conductivity detector. Candidates that inhibit methane production are further analyzed as follows.

VFA is measured in the liquid phase of batch cultures. After centrifuging the cells, proteins are precipitated by adding 1/4 volume 20% metaphosphoric acid. VFA concentration in the supernatant is determined by gas chromatography using a Chromasorb W/AW column and a flame ionization detector. One fraction of the cell pellets is used to determine the effect of RFA-P synthase inhibitors on the proportion of methanogens in the population by microscopy. This assay takes advantage of the flavin analog factor 420, which has intense absorbance at 420 nm and yields green fluorescence (Miller, T. L. (1995) “Ecology of methane production and hydrogen sinks in the rumen,” p. 317-331, in F. Enke (ed.), Ruminant Physiology: Digestion, Metabolism, Growth and Reproduction: Proc. 8th Intl. Symp. Ruminant Physiol, Ferdinand Enke Verlag.). RNA is extracted from a second fraction of the cell pellets and ribosomal RNA probes are used to quantify the population of methanogens. (Krause, D. O., and Russell, J. B. (1996). “An rRNA approach for assessing the role of obligate amino acid fermenting bacteria in ruminant amino acid deamination,” Appl. Environ. Microbiology 62:815: 815). The concentrations and proportions of VFA provides evidence of substrate digestion, and in combination with hydrogen assay of head space, details the fate of hydrogen when methanogenesis is acutely inhibited.

Specifically, for the results detailed below, ruminal organisms were cultured in a shaking water bath at 45 rpm by a batch method as previously described (Goering et al. (1970) Agric. Handbook, ARS-USDA 379:12-15) that used a bicarbonate and phosphate-based buffer with added macro and microminerals, cellobiose (2 g/L), trypticase (2 g/L), and 12.8 mM Na₂S as a reductant. Five mL cultures were incubated in 9.4 mL glass vials that were sealed and crimped with gas-tight septa. Fresh ruminal fluid was obtained from two ruminally fistulated steers maintained on a 70% forage, 30% grain diet, strained through four layers of cheesecloth, and added to buffer at 20% of final volume. The culture vials (5.4 mL head space) were pressurized initially and after 12 hours of incubation at 37° C. to 190 kPa with H₂/CO₂ (80/20). Candidate inhibitors were added in triplicate cultures in logarithmically spaced concentrations between 10 mM and 0.01 mM. Each experiment included cultures containing a known inhibitor of methanogenesis, 2-bromoethanesulfonate, as a positive control. After 30 hours of incubation, the vials were cooled to 22° C., the head-space pressure was measured with a manometer and 500 microliters of the gas phase was assayed for methane and hydrogen by gas chromatography using a silica gel column equipped with a thermal conductivity detector.

The volatile fatty acid concentration in the liquid phase of the ruminal batch cultures was assayed after centrifuging the cells and precipitating the proteins by adding 1/4 volume of 20% metaphosphoric acid. The VFA concentration in the supernatant was determined by gas chromatography with a Chromasorb W/AW column and a flame ionization detector. The VFA concentration was also determined in parallel cultures in which ground brome hay replaced cellobiose, and headspace was pressurized with only CO₂ at inoculation of the cultures.

### Example 6

### Determination of the Toxicity of the RFA-Synthase Inhibitors

The effect of RFA-P synthase inhibitors on methanogenesis can be estimated by monitoring the concentration of methane in ruminal head space. Sheep are surgically fitted with ruminal cannulae, which have dual sampling tubes; one tube terminates in the ruminal gas dome and the other tube terminates in the digesta-filled cranial sac. Sheep are fed a grass and alfalfa hay based diet balanced to meet all nutrient requirements and intake is restricted to 90% of ad libitum consumption to ensure consistency in feed consumption between animals. The inhibitors are administered as a bolus to establish the desired concentration based on ruminal liquid volume determined within a few days before the experiment begins. Inhibitor concentration is maintained by continuous infusion using a peristaltic pump and assuming liquid turnover of 5% per hour. Samples of head gas are collected using a closed sampling method and analyzed for methane, hydrogen, and carbon dioxide by gas chromatography as described above. Liquid samples are assayed for VFA and microbial populations as described above. Samples are obtained prior to feeding; at 1, 4, and 8 hours after feeding; and 0, 1, 2, 4, 8, and 16 days after initiating inhibitor infusion. The experimental design utilizes a 4×4 Latin square; therefore, each animal is subjected to each dose of inhibitor in a separate period. Periods are separated by one week to preclude carryover effects.

### Example 7

### Results

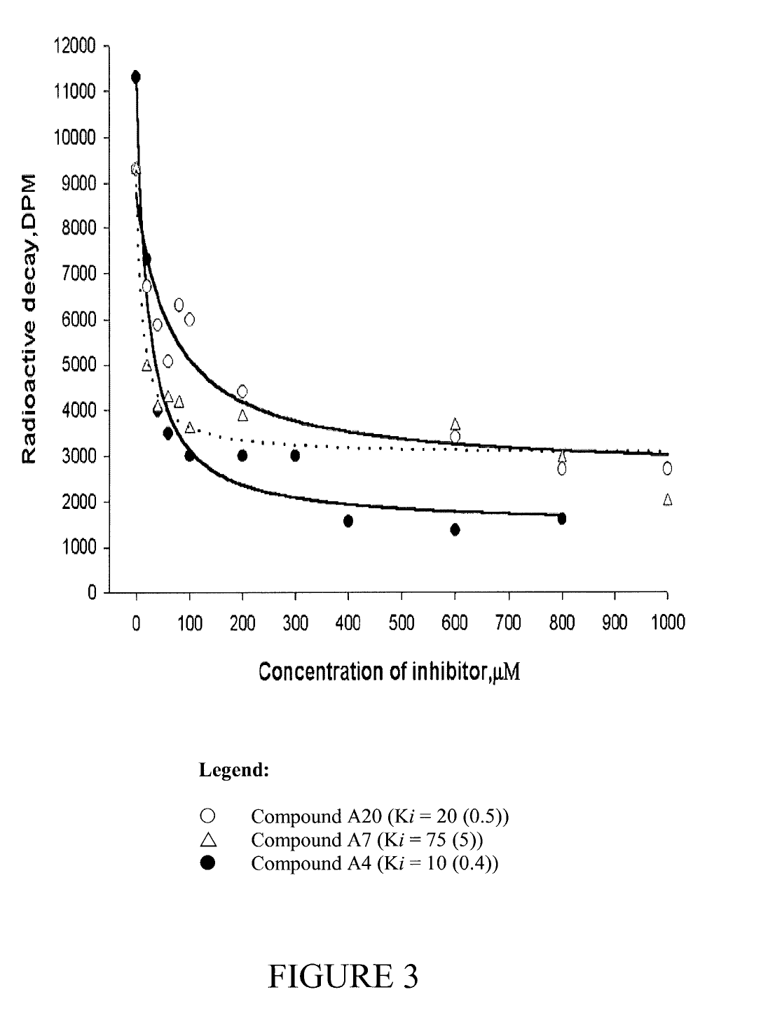

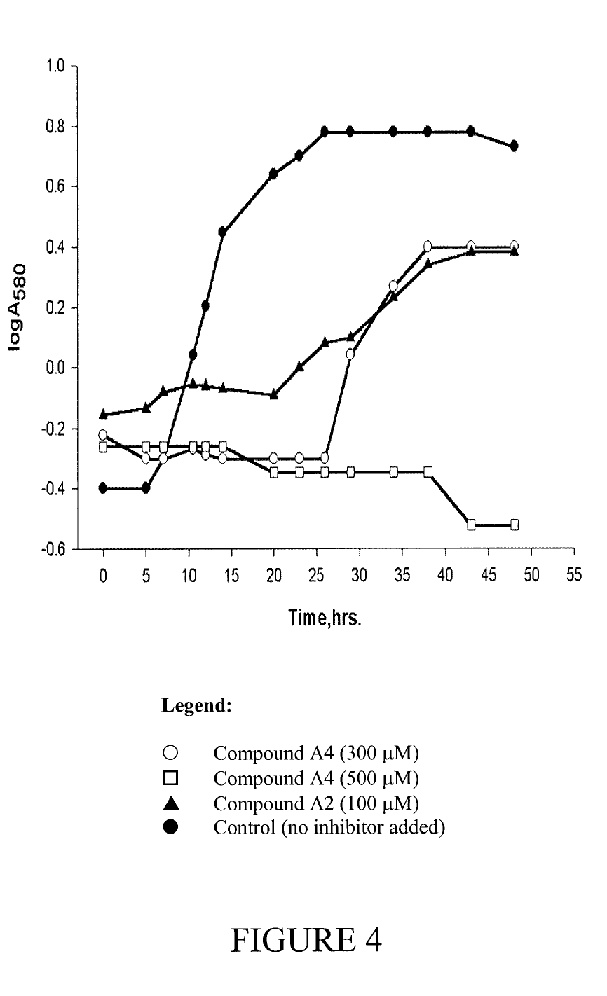

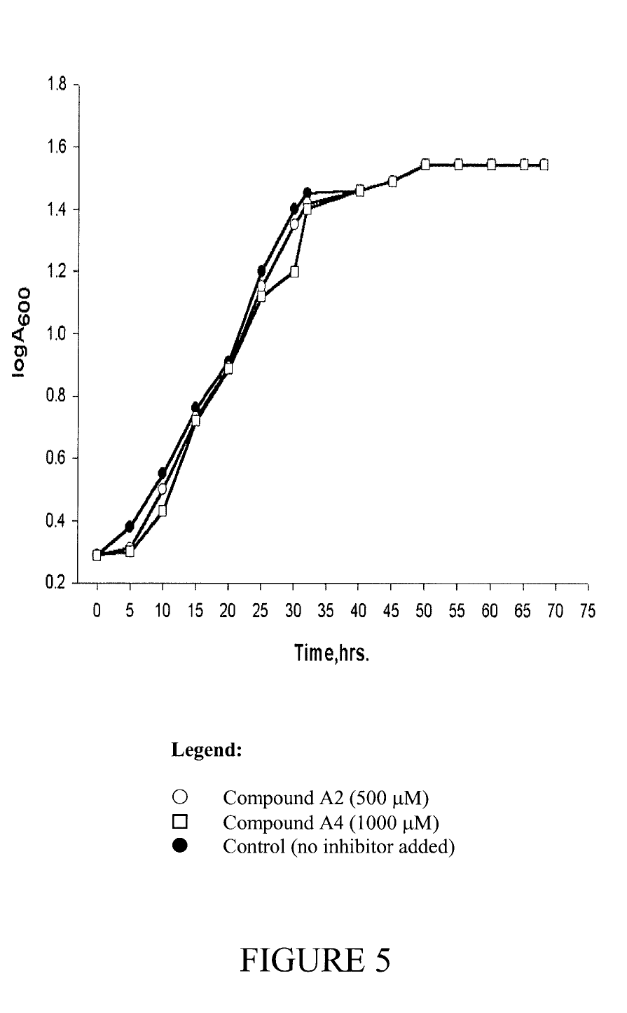

Compounds A2, A4, A7 and A20 were tested in accordance with the procedures described in Examples 1-6 above. Collectively, FIGS. 3-5 characterize the ability of each compound to inhibit RFA-P synthase, to inhibit archaeal growth, and also the compound's impact on certain VFA levels. FIG. 3 depicts inhibition of RFA-P synthase, FIG. 4 depicts the ability of the compounds to inhibit microbial growth, and FIG. 5 depicts the absence of any impact of the compounds on acetate production.

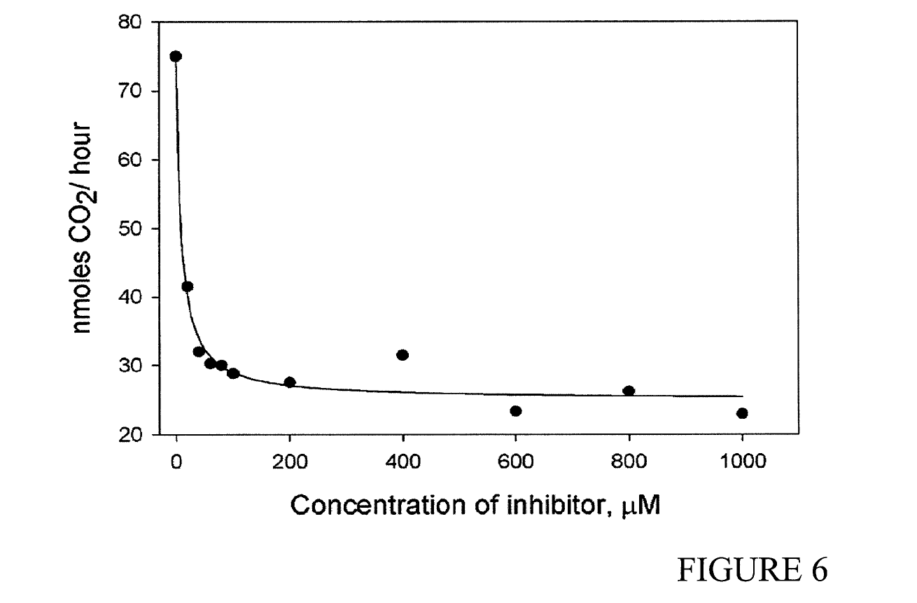

A number of compounds described herein were tested for their ability to inhibit the RFA-P synthase reaction with the substrates at saturating concentrations (results shown in Table 2 below). Briefly, first each compound was tested at 1 mM concentration and if inhibition was observed, its concentration was varied to obtain a complete inhibition curve. FIG. 6 shows representative results with 4-(isopropylamino)benzoic acid. The data for all compounds tested fit well into a competitive inhibition equation. Table 2 details the inhibition constant for each compound tested in the column labeled Ki.

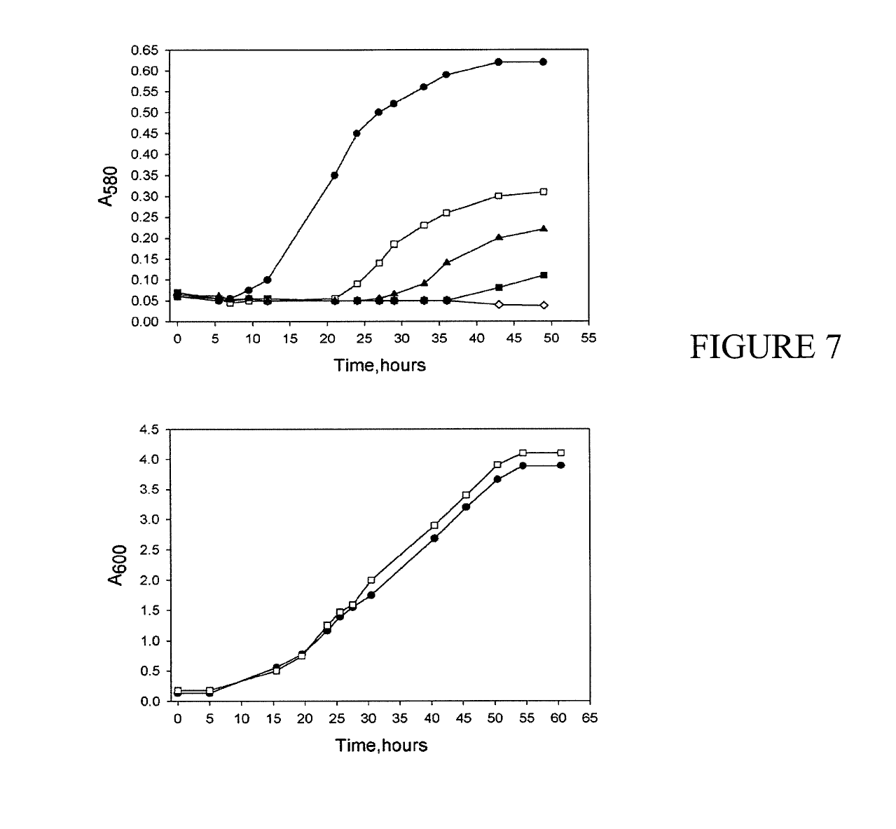

Additionally, a number of compounds were tested for their ability to inhibit methanogenesis and the growth of the methogen, M. marburgensis. As in the enzyme inhibition experiments, the cultures were first grown in the presence of 1 mM of the particular compound being tested. Those compounds that did not alter growth were not pursued and are scored as “NI,” noninhibitory in Table 2 below. Compounds that inhibited growth at 1 mM were futher studied by varying their concentration to obtain complete inhibition curves. The concentration at which growth was completely inhibited is shown in Table 2 below and representative results are depicted in FIG. 7A for isopropylaminobenzoate. These presumed active-site directed inhibitors extend the lag phase and decrease the final cell density in a dose-dependent manner. Methanogens are known to produce methane even in stationary phase; however, the compounds tested inhibit methanogenesis in parallel with cell growth as shown in Table 2. Insignificant amounts of methane were measured in the headspace of M. marburgensis cultures whose growth was completely inhibited. As detailed in Table 2, several of the best inhibitors of RFA-P synthase also are the most potent inhibitors of M. marburgensis. In fact, at 100 mM, 4-[(2-pyridylmethyl)amino]benzoic acid completely arrests the growth of and methane formation by M. marburgensis. This inhibition is fully reversed by supplementing the medium with pABA, indicating that RFA-P synthase is the cellular target. When the cells were grown in the presence of the compounds for 5 days (instead of the standard incubation of 2 days), the OD continued to decrease to zero. In addition to this inhibitory action upon M. marburgensis, several of the compounds also inhibit methanogensis and growth of Methanobrevibacter smithii, a mesophilic human intestinal methanogen. However, because methanopterin is not required for survival of bacteria, none of the compounds affect growth of M. thermoacetica at concentrations as high as 1 mM and representative results are depicted in FIG. 7B for isopropylaminobenzoate.

The effect of the compounds on methane formation and VFA production in an artificial rumen was also tested. Ruminal fluid obtained from fistulated steers was cultured in the presence of the compounds or the cultured methanogen. Ruminal fluid is a complex mixture containing more than 60 species of bacteria at a density exceeding 10¹¹ cells/g plus numerous species of archae, protozoa, and fungi. Several of the compounds tested inhibit methanogensis in the artificial rumen as shown in Table 2 below. For example, 5 mM of 4-(ethylamino)benzoate or 9 mM of 4-(2-hydroxyethylamino)benzoate inhibited methane production to 2.5% of the control level.

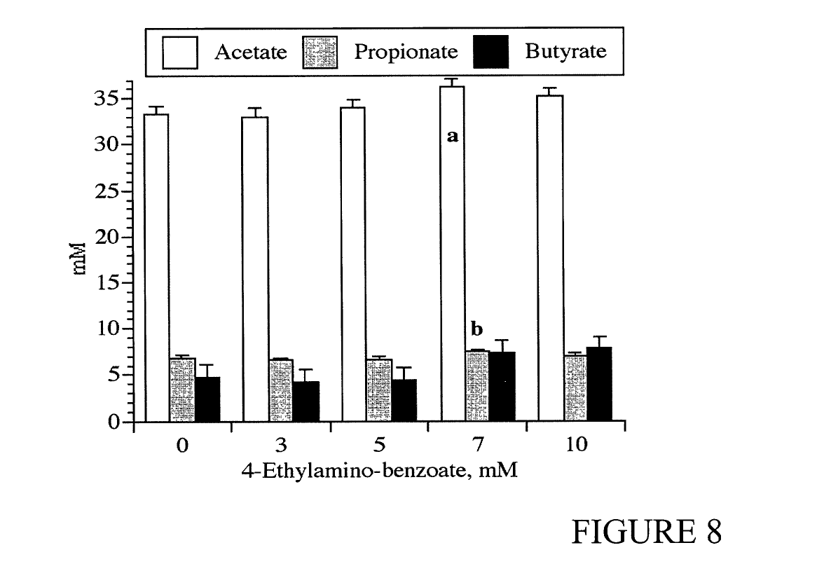

The effect of the some of the compounds on VFA production in the ruminal fluid culture is also shown in Table 2 and in FIG. 8 for the compound 4-ethylaminobenzoate. VFA production by ruminal organisms is not depressed by adding one of the compounds at concentrations that completely block methanogenesis. For example, when 7 mM of 4-ethylaminobenzoate was added to the artificial rumen system, acetate and propionate levels were elevated relative to the controls unexposed to the compounds. These results are consistent with the studies with pure cultures of acetogenic bacteria and demonstrate that the compounds do not adversely affect other ruminal bacteria or ruminal dynamics.

TABLE 2

| | | | Inhibition of Growth | | | |
|---|---|---|---|---|---|---|
| | | Methane | | | | Rumen^{d} |
| Cmpd | Ki | Produced^{a} | M. marburgensis^{b} | Acetogen^{c} | M. smithii^{c} | Culture |
| No. | (μm) | (μ moles) | (μM) | (μM) | (μM) | (mmol) |
| A1 | No | Not | Incomplete | No growth | Not | Not |
| | inhibition | Tested | growth | inhibition | Tested | Tested |
| | | | inhibition | | | |
| A2 | 140 | Not | Incomplete | No growth | Not | Not |
| | | Tested | growth | inhibition | Tested | Tested |
| | | | inhibition | | | |
| A3 | 9 | 0.01 | 100 | No growth | No growth | Growth |
| | | (100) | | inhibition | inhibition | inhibition |
| A4 | 10 | 0.02 | 500 | No growth | Not | No growth |
| | | (500) | | inhibition | Tested | inhibition |
| A5 | 17 | Not | 300 | Not | No growth | Growth |
| | | Tested | | Tested | inhibition | inhibition |
| A6 | 7.5 | Not | 300 | Not | Not | Not |
| | | Tested | | Tested | Tested | Tested |
| A7 | 75 | 0.07 | Incomplete | Not | Not | Not |
| | | (300) | growth | Tested | Tested | Tested |
| | | | inhibition | | | |
| A8 | No | Not | No growth | Not | Not | Not |
| | inhibition | Tested | inhibition | Tested | Tested | Tested |
| A9 | 60 | Not | 1000 | Not | Not | Not |
| | | Tested | | Tested | Tested | Tested |
| A10 | No | Not | No growth | Not | Not | Not |
| | inhibition | Tested | inhibition | Tested | Tested | Tested |
| A11 | 130 | Not | 1000 | Not | Not | Not |
| | | Tested | | Tested | Tested | Tested |
| A12 | 7 | Not | Incomplete | Not | Not | Not |
| | | Tested | growth | Tested | Tested | Tested |
| | | | inhibition | | | |
| A13 | 15 | Not | 1000 | Not | Not | Not |
| | | Tested | | Tested | Tested | Tested |
| A14 | 25 | Not | Incomplete | Not | Not | Not |
| | | Tested | growth | Tested | Tested | Tested |
| | | | inhibition | | | |
| A15 | 9 | Not | 100 | Not | Not | Not |
| | | Tested | | Tested | Tested | Tested |
| A16 | 23 | Not | 300 | Not | Not | No growth |
| | | Tested | | Tested | Tested | inhibition |
| A17 | No | Not | Incomplete | Not | Not | Not |
| | inhibition | Tested | growth | Tested | Tested | Tested |
| | | | inhibition | | | |
| A18 | No | Not | Incomplete | Not | Not | Not |
| | inhibition | Tested | growth | Tested | Tested | Tested |
| | | | inhibition | | | |
| A19 | 155 | Not | 300 | No growth | Growth | Growth |
| | | Tested | | inhibition | inhibition | inhibition |
| A20 | 20 | 0.05 | 600 | No growth | Not | Not |
| | | (600) | | inhibition | Tested | Tested |
| A21 | No | Not | 500 | No growth | Not | Not |
| | inhibition | Tested | | inhibition | Tested | Tested |
| A22 | 59 | Not | No growth | Not | Not | Not |
| | | Tested | inhibition | Tested | Tested | Tested |
| A23 | No | Not | Incomplete | Not | Not | Not |
| | inhibition | Tested | growth | Tested | Tested | Tested |
| | | | inhibition | | | |
| A24 | No | Not | 1000 | No growth | Not | Not |
| | inhibition | Tested | | inhibition | Tested | Tested |
| A25 | No | Not | 1000 | Not | Not | No growth |
| | inhibition | Tested | | Tested | Tested | inhibition |
| A26 | 84 | 0.06 | 100 | Not | Not | Not |
| | | (100) | | Tested | Tested | Tested |
| A27 | 72 | Not | Incomplete | Not | Not | Not |
| | | Tested | growth | Tested | Tested | Tested |
| | | | inhibition | | | |
| A28 | 55 | Not | 1000 | Not | Not | Not |
| | | Tested | | Tested | Tested | Tested |
| A29 | 51 | Not | 500 | Not | Not | Not |
| | | Tested | | Tested | Tested | Tested |
| A30 | No | Not | 500 | Not | Not | Not |
| | inhibition | Tested | | Tested | Tested | Tested |
| A31 | 705 | Not | 1000 | Not | Not | No growth |
| | | Tested | | Tested | Tested | inhibition |
| A32 | No | Not | 300 | Not | Not | Not |
| | inhibition | Tested | | Tested | Tested | Tested |
| A33 | 19 | 0.08 | 0.1 | No growth | No growth | No growth |
| | | (0.1) | | inhibition | inhibition | inhibition |
| A34 | 19 | Not | No growth | Not | Not | Not |
| | | Tested | inhibition | Tested | Tested | Tested |
| A35 | No | Not | 1000 | Not | Not | Not |
| | inhibition | Tested | | Tested | Tested | Tested |
| A36 | No | Not | 1000 | Not | Not | Not |
| | inhibition | Tested | | Tested | Tested | Tested |
| A37 | No | Not | 300 | Not | Not | Not |
| | inhibition | Tested | | Tested | Tested | Tested |
| A38 | No | Not | 500 | Not | Not | Not |
| | inhibition | Tested | | Tested | Tested | Tested |
| A39 | No | Not | 1000 | Not | Not | No growth |
| | inhibition | Tested | | Tested | Tested | inhibition |
| A40 | 270 | Not | No growth | Not | Not | Not |
| | | Tested | inhibition | Tested | Tested | Tested |
| A41 | No | Not | 500 | Not | Not | Not |
| | inhibition | Tested | | Tested | Tested | Tested |
| A42 | No | Not | 1000 | Not | Not | Not |
| | inhibition | Tested | | Tested | Tested | Tested |
| A43 | No | Not | 500 | Not | Not | Not |
| | inhibition | Tested | | Tested | Tested | Tested |
| A44 | 115 | Not | Incomplete | Not | Not | Not |
| | | Tested | growth | Tested | Tested | Tested |
| | | | inhibition | | | |
| A45 | No | Not | 500 | Not | Not | Not |
| | inhibition | Tested | | Tested | Tested | Tested |
| A46 | No | Not | Incomplete | Not | Not | Not |
| | inhibition | Tested | growth | Tested | Tested | Tested |
| | | | inhibition | | | |
| A47 | No | Not | 500 | Not | Not | Not |
| | inhibition | Tested | | Tested | Tested | Tested |
| A48 | 65 | Not | No growth | Not | Not | Not |
| | | Tested | inhibition | Tested | Tested | Tested |
| A49 | 85 | Not | No growth | Not | Not | Not |
| | | Tested | inhibition | Tested | Tested | Tested |
| A50 | Not | Not | 100 | Not | Not | Not |
| | Tested | Tested | | Tested | Tested | Tested |
| A51 | Not | Not | 100 | Not | Not | Not |
| | Tested | Tested | | Tested | Tested | Tested |
| A52 | Not | Not | 1000 | Not | Not | Not |
| | Tested | Tested | | Tested | Tested | Tested |
| A53 | 25 | Not | 300 | Not | Not | Not |
| | | Tested | | Tested | Tested | Tested |
| A54 | Not | Not | Incomplete | Not | Not | Not |
| | Tested | Tested | growth | Tested | Tested | Tested |
| | | | inhibition | | | |
| A55 | 25 | Not | 100 | Not | Not | Not |
| | | Tested | | Tested | Tested | Tested |
| A56 | 145 | Not | No growth | No growth | Not | Not |
| | | Tested | inhibition | inhibition | Tested | Tested |
| A57 | No | Not | No growth | Not | Not | Not |
| | inhibition | Tested | inhibition | Tested | Tested | Tested |
| A58 | No | Not | 1000 | Not | Not | No growth |
| | inhibition | Tested | | Tested | Tested | inhibition |
| A59 | No | Not | Incomplete | Not | Not | Not |
| | inhibition | Tested | growth | Tested | Tested | Tested |
| | | | inhibition | | | |
| A60 | No | Not | No growth | Not | Not | Not |
| | inhibition | Tested | inhibition | Tested | Tested | Tested |
| A61 | No | Not | No growth | Not | Not | Not |
| | inhibition | Tested | inhibition | Tested | Tested | Tested |
| A62 | No | Not | No growth | Not | Not | Not |
| | inhibition | Tested | inhibition | Tested | Tested | Tested |
| A63 | No | Not | No growth | Not | Not | Not |
| | inhibition | Tested | inhibition | Tested | Tested | Tested |
| A64 | No | Not | No growth | Not | Not | Not |
| | inhibition | Tested | inhibition | Tested | Tested | Tested |
| A65 | 130 | Not | Incomplete | Not | Not | Not |
| | | Tested | growth | Tested | Tested | Tested |
| | | | inhibition | | | |
| A66 | 190 | Not | 1000 | Not | Not | Not |
| | | Tested | | Tested | Tested | Tested |
| A67 | No | Not | No growth | Not | Not | Not |
| | inhibition | Tested | inhibition | Tested | Tested | Tested |
| A68 | No | Not | No growth | Not | Not | Not |
| | inhibition | Tested | inhibition | Tested | Tested | Tested |
| A69 | No | Not | No growth | Not | Not | Not |
| | inhibition | Tested | inhibition | Tested | Tested | Tested |
| A70 | No | Not | No growth | Not | Not | Not |
| | inhibition | Tested | inhibition | Tested | Tested | Tested |
| A71 | No | Not | No growth | Not | Not | Not |
| | inhibition | Tested | inhibition | Tested | Tested | Tested |
| A72 | No | Not | No growth | Not | Not | Not |
| | inhibition | Tested | inhibition | Tested | Tested | Tested |
| A73 | No | Not | No growth | Not | Not | Not |
| | inhibition | Tested | inhibition | Tested | Tested | Tested |
| A74 | 200 | Not | Incomplete | Not | Not | Not |
| | | Tested | growth | Tested | Tested | Tested |
| | | | inhibition | | | |
| A75 | No | Not | Incomplete | Not | Not | Not |
| | inhibition | Tested | growth | Tested | Tested | Tested |
| | | | inhibition | | | |
| A76 | No | Not | No growth | Not | Not | Not |
| | inhibition | Tested | inhibition | Tested | Tested | Tested |
| A77 | No | Not | No growth | Not | Not | Not |
| | inhibition | Tested | inhibition | Tested | Tested | Tested |
| A78 | No | Not | No growth | Not | Not | Not |
| | inhibition | Tested | inhibition | Tested | Tested | Tested |
| A79 | No | Not | No growth | Not | Not | Not |
| | inhibition | Tested | inhibition | Tested | Tested | Tested |
| A80 | No | Not | 500 | Not | Not | Not |
| | inhibition | Tested | | Tested | Tested | Tested |
| A81 | No | Not | No growth | Not | Not | Not |
| | inhibition | Tested | inhibition | Tested | Tested | Tested |
| A82 | No | Not | Incomplete | Not | Not | Not |
| | inhibition | Tested | growth | Tested | Tested | Tested |
| | | | inhibition | | | |
| A83 | 180 | Not | Incomplete | Not | Not | Not |
| | | Tested | growth | Tested | Tested | Tested |
| | | | inhibition | | | |
| A84 | No | Not | No growth | Not | Not | No growth |
| | inhibition | Tested | inhibition | Tested | Tested | inhibition |
| A85 | No | Not | Incomplete | Not | Not | No growth |
| | inhibition | Tested | growth | Tested | Tested | inhibition |
| | | | inhibition | | | |
| A86 | No | Not | 500 | Not | Not | Not |
| | inhibition | Tested | | Tested | Tested | Tested |
| A87 | No | Not | No growth | Not | Not | Not |
| | inhibition | Tested | inhibition | Tested | Tested | Tested |
| A88 | No | Not | No growth | Not | Not | Not |
| | inhibition | Tested | inhibition | Tested | Tested | Tested |
| A89 | No | Not | No growth | Not | Not | Not |
| | inhibition | Tested | inhibition | Tested | Tested | Tested |
| A90 | Not | Not | Not | Not | Not | Not |
| | Tested | Tested | Tested | Tested | Tested | Tested |
| A91 | No | Not | No growth | Not | Not | Not |
| | inhibition | Tested | inhibition | Tested | Tested | Tested |
| A92 | Not | Not | Not | Not | Not | Not |
| | Tested | Tested | Tested | Tested | Tested | Tested |
| A93 | No | Not | No growth | Not | Not | Not |
| | inhibition | Tested | inhibition | Tested | Tested | Tested |
| A94 | No | Not | No growth | Not | Not | Not |
| | inhibition | Tested | inhibition | Tested | Tested | Tested |
| B1 | 63 | Not | 0.1 | No growth | Not | Not |
| | | Tested | | inhibition | Tested | Tested |
| B2 | No | Not | 500 | Not | Not | Not |
| | inhibition | Tested | | Tested | Tested | Tested |
| B3 | 44 | Not | Incomplete | Not | Not | Not |
| | | Tested | growth | Tested | Tested | Tested |
| | | | inhibition | | | |
| B4 | No | Not | No growth | Not | Not | Not |
| | inhibition | Tested | inhibition | Tested | Tested | Tested |
| B5 | No | Not | No growth | Not | Not | Not |
| | inhibition | Tested | inhibition | Tested | Tested | Tested |
| B6 | No | Not | No growth | Not | Not | Not |
| | inhibition | Tested | inhibition | Tested | Tested | Tested |
| B7 | No | Not | 500 | Not | Not | Not |
| | inhibition | Tested | | Tested | Tested | Tested |
| B8 | No | Not | No growth | Not | Not | Not |
| | inhibition | Tested | inhibition | Tested | Tested | Tested |
| C1 | 30 | Not | 500 | Not | Not | Not |
| | | Tested | | Tested | Tested | Tested |
| C2 | No | Not | No growth | Not | Not | Not |
| | inhibition | Tested | inhibition | Tested | Tested | Tested |
| C3 | No | Not | No growth | Not | Not | Not |
| | inhibition | Tested | inhibition | Tested | Tested | Tested |
| C4 | No | Not | 1000 | Not | Not | Not |
| | inhibition | Tested | | Tested | Tested | Tested |
| D1 | No | Not | No growth | Not | Not | Not |
| | inhibition | Tested | inhibition | Tested | Tested | Tested |
| D2 | No | Not | No growth | Not | Not | Not |
| | inhibition | Tested | inhibition | Tested | Tested | Tested |
| D3 | No | Not | 1000 | Not | Not | Not |
| | inhibition | Tested | | Tested | Tested | Tested |
| D4 | No | Not | Incomplete | Not | Not | Not |
| | inhibition | Tested | growth | Tested | Tested | Tested |
| | | | inhibition | | | |
| D5 | No | Not | Incomplete | Not | Not | Not |
| | inhibition | Tested | growth | Tested | Tested | Tested |
| | | | inhibition | | | |
| D6 | No | Not | 500 | Not | Not | Not |
| | inhibition | Tested | | Tested | Tested | Tested |
| D7 | No | Not | 1000 | Not | Not | Not |
| | inhibition | Tested | | Tested | Tested | Tested |
| E1 | No | Not | No growth | Not | Not | Not |
| | inhibition | Tested | inhibition | Tested | Tested | Tested |

^{a}Total amount (in micromoles) of methane produced by M. marburgensis over 48 hours in the presence of the indicated compound, micromolar concentrate of the indicated compound given in parentheses (mM). 600 micromoles of methane was produced in the absence of added inhibitor.
^{b}Concentration of compound which completely inhibited growth of M. marburgensis. “No Growth Inhibition” indicates that growth was not arrested in the presence of 1 millimolar concentration of the compound indicated. “Incomplete Growth inhibition” indicates that growth was partially arrested in the presence of 1 millimolar or less concentration of the compound indicated.
^{c}“No growth Inhibition” indicates that the tested compound did not inhibit growth at a concentration of 1 millimolar and “Growth Inhibition” indicates that the tested compound inhibited growth at a concentration of 1 millimolar.
^{d}“No growth Inhibition” indicates that the tested compound did not inhibit growth at a concentration of 10 millimolar and “Growth Inhibition” indicates that the tested compound inh inhibited growth at a concentration of 10 millimolar or less.

What is claimed is:

1. A method for inhibiting methane production by methanogenic archaea, the method comprising contacting a methanogenic archaea medium with an effective methane inhibiting amount of at least one compound of Formula XXXA: 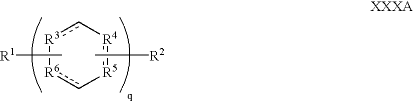
wherein the dashed lines independently indicate an optional double bond;
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
wherein q is 0 or 1;
and wherein either RI or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷ or R²⁷ and either R²⁸ or R³⁶ or R³⁷, or R²⁸ and either R³⁶ or R³⁷, or R²⁹ and R³⁷ together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

2. A method for inhibiting the growth of methanogenic archaea, the method comprising contacting a methanogenic archaea medium with an effective growth inhibiting amount of at least one compound of Formula XXXA: 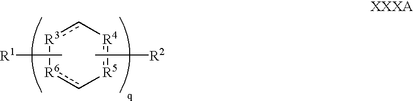
wherein the dashed lines independently indicate an optional double bond;
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrbcarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
wherein q is 0 or 1;
and wherein either R¹ or R² and either R¹ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

3. A method for increasing feed efficiency in a ruminant animal, the method comprising administering to the animal an effective rumen modifying amount of at least one compound of Formula XXXA: 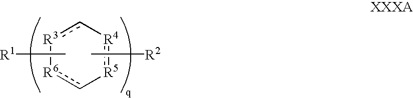
wherein the dashed lines independently indicate an optional double bond;
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷) —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
wherein q is 0 or 1;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

4. The method of any of claims 1-3, wherein the compound is a compound of Formula XXX: 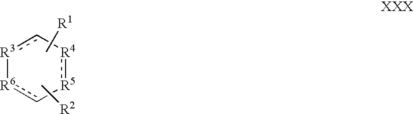
wherein the dashed lines independently indicate an optional double bond;
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

5. The method of claim 4, wherein the compound is a compound of Formula IA: 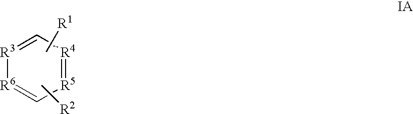
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷) —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

6. The method of claim 5, wherein the compound is a compound of Formula IIA: 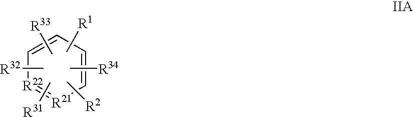
wherein R¹ is selected from the group consisting of —C≡N, —OₘBR³R⁴, —C(H)R⁵(BR³R⁴), —OₘC(O)R⁶, —(C(H)R⁵)ₚ(C(O)R⁶), —CHR⁵(NR⁸R¹²), —CR⁵═CR¹¹(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ and R¹¹are independently selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹, R¹⁰ and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸, R¹² and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²¹ and R²² are independently carbon or nitrogen;
wherein R³¹, R³², R³³ and R³⁴ are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
wherein p is an integer from 0 to 3;
and wherein R³ and R⁴, or R⁵ and either R³ or R⁴ or R⁶ or R⁷ or R⁸ or R⁹ or R¹⁰ or R¹², or R⁸ and either R⁷ or R⁹ or R¹⁰ or R¹², or R⁹ and R₁₀, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³² or R³³ or R³⁴, or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³³ or R³⁴, or R³³ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³⁴, or R³⁴ and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

7. The method of claim 6, wherein the compound is a compound of Formula IIIA: 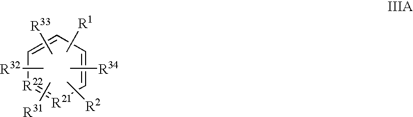
wherein R¹ is selected from the group consisting of —C≡N, —BR³R⁴, —C(H)R⁵(BR³R⁴), —CR⁵═CR¹¹(C(O)R⁶), —C(O)R⁶, —CHR⁵(NR⁸R¹²), —(C(H)R⁵)ₚ(C(O)R⁶), —SOₙR⁷, —C(H)R⁵(SOₙR⁷), —POₙR⁹R¹⁰, and —C(H)R⁵(POₙR⁹R¹⁰);
wherein R² is selected from the group consisting of hydrogen, hydroxy, —C(O)R²⁵, —C(H)R¹⁶(OH), —OₘNR¹⁹R²⁰, and —C(H)R¹⁶(N(H)R¹⁹);
wherein R³, R⁴, R⁶, R⁷ and R⁹ are independently selected from the group consisting of hydroxy and alkoxy;
wherein R⁵, R⁸, R¹¹, R¹², R¹⁶, R²⁵, R³¹, R³², R³³ and R³⁴ are independently selected from the group consisting of hydrogen, hydroxy, amino, halogen, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein R²¹ and R²² are independently carbon or nitrogen;
wherein m is 0 or 1;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁶ and either R¹⁹ or R³¹ or R³² or R³³ or R³⁴, or R¹⁹ and either R²⁰ or R³¹ or R³² or R³³ or R³⁴, or R²⁰ and either R³¹ or R³² or R³³ or R³⁴, together with the atoms to which they are independently attached, can form a substituted or unsubstituted, saturated, partially saturated or unsaturated carbocyclic or heterocyclic ring containing from 3 to 6 carbon atoms.

8. The method of claim 7, wherein the compound is a compound of Formula IVA: 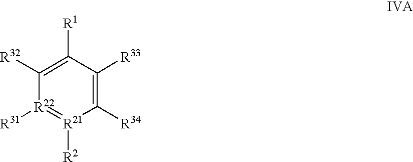
wherein R¹ is selected from the group consisting of —C≡N, —BR³R⁴, —C(O)R⁶, —CHR⁵(NR⁸R¹²), —(C(H)R⁵)ₚ(C(O)R⁶), —CR⁵═CR¹¹(C(O)R⁶), —SOₙ(OH), —POₙR⁹R¹⁰ and —C(H)R⁵(POₙR⁹R¹⁰);
wherein R² is selected from the group consisting of hydrogen, hydroxy, —C(O)R²⁵, —C(H)R¹⁶(OH), —NR¹⁹R²⁰, and —CH₂(N(H)R¹⁹);
wherein R³, R⁴, R⁶, R⁹ and R¹⁰ are independently selected from the group consisting of hydroxy and alkoxy;
wherein R⁵, R⁸, R¹¹ and R¹² are independently selected from the group consisting of hydrogen, hydrocarbyl and substituted hydrocarbyl;
wherein R¹⁶, R¹⁹, R²⁰, R²⁵, R³¹, R³², R³³ and R³⁴ are independently selected from the group consisting of hydrogen, hydroxy, amino, halogen, hydrocarbyl, and substituted hydrocarbyl;
wherein R²¹ and R²² are independently carbon or nitrogen;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁹ and either R²⁰ or R³¹, or R²⁰ and R³¹, together with the atoms to which they are independently attached, can form a substituted or unsubstituted, saturated, partially saturated or unsaturated heterocyclic ring containing from 3 to 5 carbon atoms.

9. The method of claim 4, wherein the compound is a compound of Formula I: 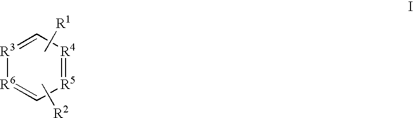
wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of —OR³⁶, —CR²⁷R²⁸(OR³⁶), —OₘNR²⁶R³⁷, —SOₙNR²⁶R³⁷—CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is from 0 to 2;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

10. The method of claim 9, wherein the compound is a compound of Formula II: 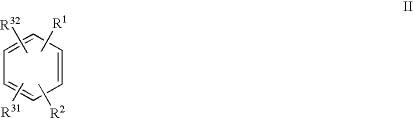
wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of —OR¹⁸, —C(H)R¹⁶(OR¹⁸), —OₙN(H)R¹⁹, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ is selected from the group consisting of hydrogen, hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, hydrocarbyloxy, substituted hydrocarbyloxy, and heterocyclooxy;
wherein m is 0 or 1;
wherein n is from 0 to 2;
and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R³², or R³² and either R³ or R⁴ or R⁵ or R⁶ or R⁷ or R⁸ or R⁹ or R¹⁰ or R¹⁶ or R¹⁷ or R¹⁸ or R¹⁹, together with the atoms to which they are independently attached, can form a substituted or unsubstituted, saturated, partially saturated or unsaturated carbocyclic or heterocyclic ring containing from 3 to 6 carbon atoms.

11. The method of claim 10, wherein the compound is a compound of Formula III: 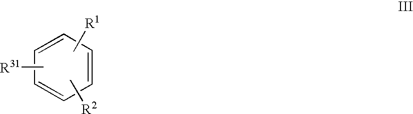
wherein R¹ is selected from the group consisting of —BR³R⁴, —C(H)R⁵(BR³R⁴), —C(O)R⁶, —C(H)R⁵(C(O)R⁶), —SOₙR⁷, —C(H)R⁵(SOₙR⁷), —POₙR⁹R¹⁰, and —C(H)R⁵(POₙR⁹R¹⁰);
wherein R² is selected from the group consisting of hydroxy, —C(H)R¹⁶(OH), —OₘN(H)R¹⁹, and —C(H)R¹⁶(N(H)R¹⁹);
wherein R³, R⁴, R⁶, R⁷ and R⁹ are independently selected from the group consisting of hydroxy and alkoxy;
wherein R⁵, R¹⁶ and R³¹ are independently selected from the group consisting of hydrogen, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ is selected from the group consisting of hydrogen, hydrocarbyl, substituted hydrocarbyl, and heterocyclo;
wherein m is 0 or 1;
wherein n is from 0 to 2;
and wherein R³ and R⁴, or R⁵ and R⁶, or R⁹ and R¹⁰, or R¹⁶ and R¹⁹, together with the atoms to which they are independently attached, can form a substituted or unsubstituted, saturated, partially saturated or unsaturated carbocyclic or heterocyclic ring containing from 3 to 6 carbon atoms.

12. The method of claim 11, wherein the compound is a compound of Formula IV: 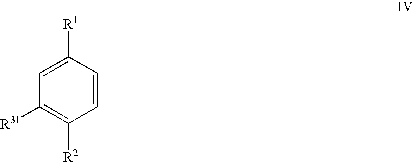
wherein R¹ is selected from the group consisting of —BR³R⁴, —C(O)R⁶, —CH₂(C(O)R⁶), —SOₙ(OH), and —POₙR⁹(OH);
wherein R² is selected from the group consisting of —CH₂OH, —N(H)R¹⁹, and —CH₂(N(H)R¹⁹);
wherein R³, R⁴, and R⁶ are independently selected from the group consisting of hydroxy and alkoxy;
wherein R⁹ is alkoxy;
wherein R¹⁹ and R³¹ are independently selected from the group consisting of hydrogen, hydrocarbyl, and substituted hydrocarbyl;
wherein n is from 0 to 2;
and wherein R³ and R⁴, or R¹⁹ and R³¹, together with the atoms to which they are independently attached, can form a substituted or unsubstituted, saturated, partially saturated or unsaturated heterocyclic ring containing from 3 to 5 carbon atoms.

13. The method of claim 4, wherein the compound is a compound of Formula V: 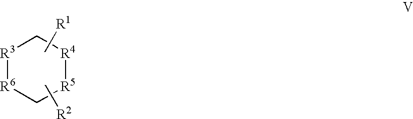
wherein R¹ is selected from the group consisting of —OₘBR⁷R⁸, —CR⁹R¹⁰(BR⁷R⁸), —OₘC(O)R⁷, —CR⁹R¹⁰(C(O)⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

14. The method of claim 13, wherein the compound is a compound of Formula VI: 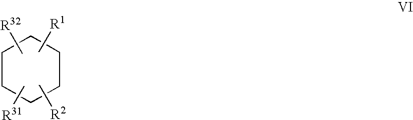
wherein R¹ is selected from the group consisting of —OₘBR³R⁴, —C(H)R⁵(BR³R⁴), —OₘC(O)R⁶, —C(H)R⁵(C(O)⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —C(H)R¹⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹ or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³², or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

15. The method of claim 14, wherein the compound is a compound of Formula VII: 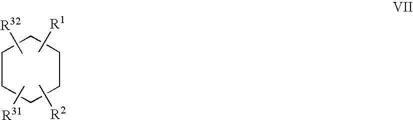
wherein R¹ is selected from the group consisting of —BR³R⁴, —C(O)R⁶, —SOₙR⁷, and —POₙR⁹R¹⁰;
wherein R² is selected from the group consisting of hydrogen, hydroxy, —C(H)R¹⁶(OH), —OₘNR¹⁹R²⁰, and —C(H)R¹⁶(N(H)R¹⁹);
wherein R³, R⁴, R⁶, R⁷ and R⁹ are independently selected from the group consisting of hydroxy, hydrocarbyl, and alkoxy;
wherein R⁵, R¹⁶, R³¹ and R³² are independently selected from the group consisting of hydrogen, hydroxy, amino, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein m is 0 or 1;
wherein n is an integer from 0 to 2;
and wherein R³ and R⁴, or R⁵ and R⁶, or R⁹ and R¹⁰, or R¹⁶ and either R¹⁹ or R³¹ or R³², or R¹⁹ and either R²⁰ or R³¹ or R³², or R²⁰ and either R³¹ or R³², together with the atoms to which they are independently attached, can form a substituted or unsubstituted, saturated, partially saturated or unsaturated carbocyclic or heterocyclic ring containing from 3 to 6 carbon atoms.

16. The method of claim 15, wherein the compound is a compound of Formula VIII: 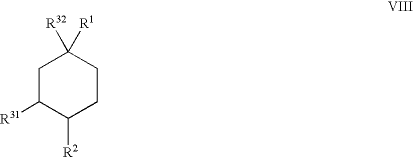
wherein R¹ is selected from the group consisting of —BR³R⁴, —C(O)R⁶, —C(H)R⁵(C(O)R⁶), —SOₙ(OH), and —POₙR⁹R¹⁰;
wherein R² is selected from the group consisting of hydrogen, hydroxy, —C(H)R¹⁶(OH), —NR¹⁹R²⁰, and —CH₂(N(H)R¹⁹);
wherein R³, R⁴, R⁶, R⁹ and R¹⁰ are independently selected from the group consisting of hydroxy and alkoxy;
wherein R⁵ is alkyl;
wherein R¹⁶, R¹⁹, R²⁰, R³¹, and R³² are independently selected from the group consisting of hydrogen, hydroxy, amino, hydrocarbyl, and substituted hydrocarbyl;
wherein n is an integer from 0 to 2;
and wherein R³ and R⁴, or R⁵ and R⁶, or R⁹ and R¹⁰, or R¹⁹ and either R²⁰ or R³¹ or R³², or R²⁰ and either R³¹ or R³², together with the atoms to which they are independently attached, can form a substituted or unsubstituted, saturated, partially saturated or unsaturated heterocyclic ring containing from 3 to 5 carbon atoms.

17. The method of claim 4, wherein the compound is a compound of Formula IX: 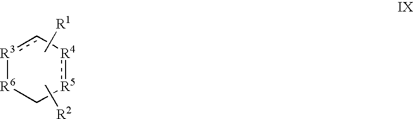
wherein the dashed lines independently indicate an optional double bond;
wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

18. The method of claim 17, wherein the compound is a compound of Formula X: 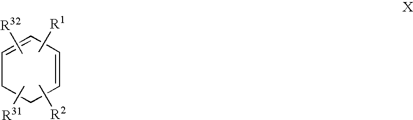
wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —C(H)R¹⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³², or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

19. The method of claim 18, wherein the compound is a compound of Formula XI: 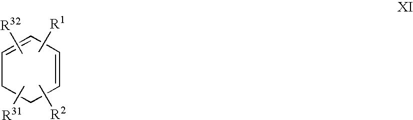
wherein R¹ is selected from the group consisting of —BR³R⁴, C(O)R⁶, —SOₙR⁷, and —POₙR⁹R¹⁰;
wherein R² is selected from the group consisting of hydrogen, hydroxy, —C(H)R¹⁶(OH), —OₘNR¹⁹R²⁰, and —C(H)R¹⁶(N(H)R¹⁹);
wherein R³, R⁴, R⁶, R⁷ and R⁹ are independently selected from the group consisting of hydroxy, hydrocarbyl, and alkoxy;
wherein R⁵, R¹⁶, R³¹ and R³² are independently selected from the group consisting of hydrogen, hydroxy, amino, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein m is 0 or 1;
wherein n is an integer from 0 to 2;
and wherein R³ and R⁴, or R⁵ and R⁶, or R⁹ and R¹⁰, or R¹⁶ and either R¹⁹ or R³¹ or R³², or R¹⁹ and either R²⁰ or R³¹ or R³², or R²⁰ and either R³¹ or R³², together with the atoms to which they are independently attached, can form a substituted or unsubstituted, saturated, partially saturated or unsaturated carbocyclic or heterocyclic ring containing from 3 to 6 carbon atoms.

20. The method of claim 19, wherein the compound is a compound of Formula XII: 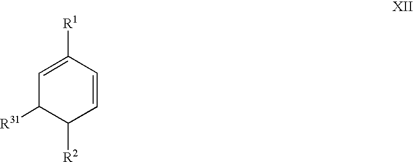
wherein R¹ is selected from the group consisting of —BR³R⁴, —C(O)R⁶, —C(H)R⁵(C(O)R⁶), —SOₙ(OH), and —POₙR⁹R¹⁰;
wherein R² is selected from the group consisting of hydrogen, hydroxy, —C(H)R¹⁶(OH), —NR¹⁹R²⁰, and —CH₂(N(H)R¹⁹);
wherein R³, R⁴, R⁶, R⁹ and R¹⁰ are independently selected from the group consisting of hydroxy and alkoxy;
wherein R⁵ is alkyl;
wherein R¹⁶, R¹⁹, R²⁰, R³¹, and R³² are independently selected from the group consisting of hydrogen, hydroxy, amino, hydrocarbyl, and substituted hydrocarbyl;
wherein n is an integer from 0 to 2;
and wherein R³ and R⁴, or R⁵ and R⁶, or R⁹ and R¹⁰, or R¹⁹ and either R²⁰ or R³¹ or R³², or R²⁰ and either R³ or R³², together with the atoms to which they are independently attached, can form a substituted or unsubstituted, saturated, partially saturated or unsaturated heterocyclic ring containing from 3 to 5 carbon atoms.

21. The method of claim 4, wherein the compound is a compound of Formula XIII: 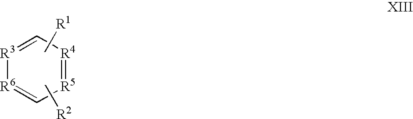
wherein R¹ is —CR⁹R¹⁰(NR¹³R¹⁴);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R²⁵ is selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
and wherein R⁹ and either R¹⁰ or R¹³ or R¹⁴, together with the atoms to which they are independently attached, form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

22. The method of claim 21, wherein the compound is a compound of Formula XIV: 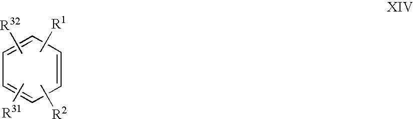
wherein R¹ is —CHR⁵(NR⁸R¹²);
wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R²⁵ is selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹² are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
and wherein R⁵ and either R⁸ or R¹², together with the atoms to which they are independently attached, form a substituted or unsubstituted, saturated, partially saturated or unsaturated carbocyclic or heterocyclic ring containing from 3 to 6 carbon atoms.

23. The method of claim 22, wherein the compound is a compound of Formula XV: 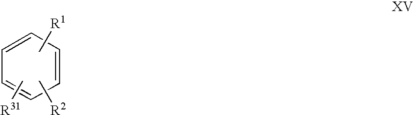
wherein R¹ is —CHR⁵(NR⁸R¹²)
wherein R² is selected from the group consisting of hydrogen, hydroxy, —C(O)R²⁵, —C(H)OR¹⁶(H), —OₘNR¹⁹R²⁰, and —C(H)R¹⁶(N(H)R¹⁹);
wherein R⁵, R⁸, R¹², R¹⁶, R²⁵ and R³¹ are independently selected from the group consisting of hydrogen, hydroxy, amino, halogen, hydrocarbyl, and substituted hydrocarbyl;
wherein R¹⁹ and R²⁰ are independently selected from the group consisting of hydrogen, hydrocarbyl, substituted hydrocarbyl, and heterocyclo;
wherein m is 0 or 1;
and wherein R⁵ and either R⁸ or R¹², together with the atoms to which they are independently attached, form a substituted or unsubstituted, saturated, partially saturated or unsaturated carbocyclic or heterocyclic ring containing from 3 to 6 carbon atoms.

24. The method of claim 23, wherein the compound is a compound of Formula XVI: 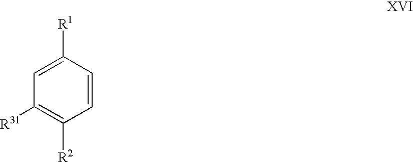
wherein R¹ is —CHR⁵(NR⁸R¹²);
wherein R² is selected from the group consisting of hydrogen, hydroxy, —C(O)R²⁵, C(H)R¹⁶(OH), —NR¹⁹R²⁰, and —CH₂(N(H)R¹⁹);
wherein R⁵, R⁸, and R¹² are independently selected from the group consisting of hydrogen, hydrocarbyl and substituted hydrocarbyl;
wherein R¹⁶, R¹⁹, R²⁰, R²⁵ and R³¹ are independently selected from the group consisting of hydrogen, hydroxy, amino, halogen, hydrocarbyl, and substituted hydrocarbyl;
and wherein R⁵ and either R⁸ or R¹², together with the atoms to which they are independently attached, form a substituted or unsubstituted, saturated, partially saturated or unsaturated heterocyclic ring containing from 3 to 5 carbon atoms.

25. The method of any of claims 1-3, wherein the compound is a compound of Formula XVII:
R¹—R² XVII
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

26. The method of claim 25, wherein the compound is a compound of Formula XVIII:
R¹—R² XVIII
wherein R¹ is selected from the group consisting of —C≡N, —OₘBR³R⁴, —C(H)R⁵(BR³R⁴), —OₘC(O)R⁶, —(C(H)R⁵)ₚ(C(O)R⁶), —CHR⁵(NR⁸R¹²), —CR⁵═CR¹¹(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ and R¹¹ are independently selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹, R¹⁰ and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸, R¹² and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein m is 0 or 1;
wherein n is an integer from 0 to 2;
wherein p is an integer from 0 to 3;
and wherein R³ and R⁴, or R⁵ and either R³ or R⁴ or R⁶ or R⁷ or R⁸ or R⁹ or R¹⁰ or R¹², or R⁸ and either R⁷ or R⁹ or R¹⁰ or R¹², or R⁹ and R¹⁰, or R¹⁶ and either R¹⁸ or R¹⁹, or R¹⁷ and R¹⁹, or R¹⁹ and R²⁰, together with the atoms to which they are independently attached, can form a substituted or unsubstituted, saturated, partially saturated or unsaturated carbocyclic or heterocyclic ring containing from 3 to 6 carbon atoms.

27. The method of claim 26, wherein the compound is a compound of Formula XIX:
R¹—R² XIX
wherein R¹ is selected from the group consisting of —C≡N, —BR³R⁴, —C(H)R⁵(BR³R⁴), —CR⁵═CR¹¹(C(O)R⁶), —C(O)R⁶, —CHR⁵(NR⁸R¹²), —(C(H)R⁵)ₚ(C(O)R⁶), —SOₙR⁷, —C(H)R⁵(SOₙR⁷), —POₙR⁹R¹⁰, and —C(H)R⁵(POₙR⁹R¹⁰);
wherein R² is selected from the group consisting of hydrogen, hydroxy, —C(O)R²⁵, —C(H)R¹⁶(OH), —OₘNR¹⁹R²⁰, and —C(H)R¹⁶(N(H)R¹⁹);
wherein R³, R⁴, R⁶, R⁷ and R⁹ are independently selected from the group consisting of hydroxy and alkoxy;
wherein Rs, R⁸, R¹¹, R¹², R¹⁶ and R²⁵ are independently selected from the group consisting of hydrogen, hydroxy, amino, halogen, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁶ and R¹⁹, or R¹⁹ and R²⁰, together with the atoms to which they are independently attached, can form a substituted or unsubstituted, saturated, partially saturated or unsaturated carbocyclic or heterocyclic ring containing from 3 to 6 carbon atoms.

28. The method of claim 27, wherein the compound is a compound of Formula XX:
R¹—R² XX
wherein R¹ is selected from the group consisting of —C≡N, —BR³R⁴, —C(O)R⁶, —CHR⁵(NR⁸R¹²), —(C(H)R⁵)ₚ(C(O)R⁶), —CR⁵═CR¹¹(C(O)R⁶), —SOₙ(OH), —POₙR⁹R¹⁰ and —C(H)R⁵(POₙR⁹R¹⁰);
wherein R² is selected from the group consisting of hydrogen, hydroxy, —C(O)R²⁵, —C(H)R¹⁶(OH), —NR¹⁹R²⁰, and —CH₂(N(H)R¹⁹);
wherein R³, R⁴, R⁶, R⁹ and R¹⁰ are independently selected from the group consisting of hydroxy and alkoxy;
wherein R⁵, R⁸, R¹¹ and R¹² are independently selected from the group consisting of hydrogen, hydrocarbyl and substituted hydrocarbyl;
wherein R¹⁶, R⁹, R²⁰ and R²⁵ are independently selected from the group consisting of hydrogen, hydroxy, amino, halogen, hydrocarbyl, and substituted hydrocarbyl;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁹ and R²⁰, together with the atoms to which they are independently attached, can form a substituted or unsubstituted, saturated, partially saturated or unsaturated heterocyclic ring containing from 3 to 5 carbon atoms.

29. The method of any of claims 1-3, wherein the compound is selected from the group of compounds consisting of:

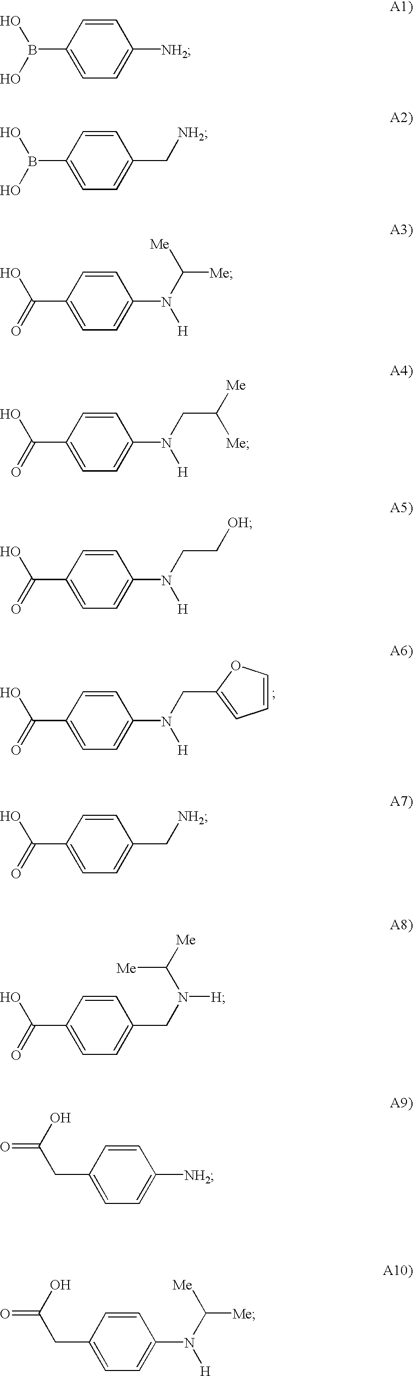

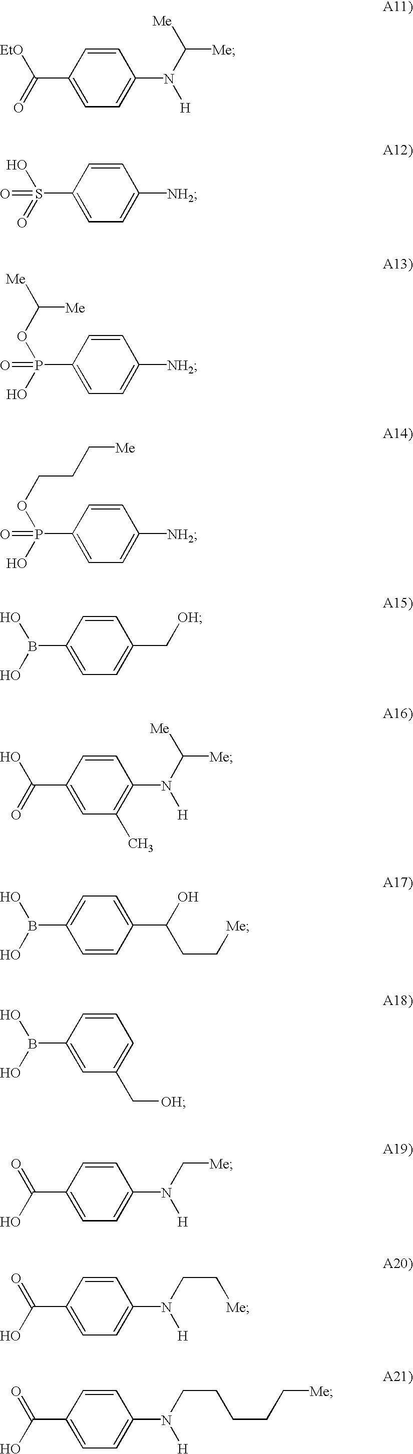

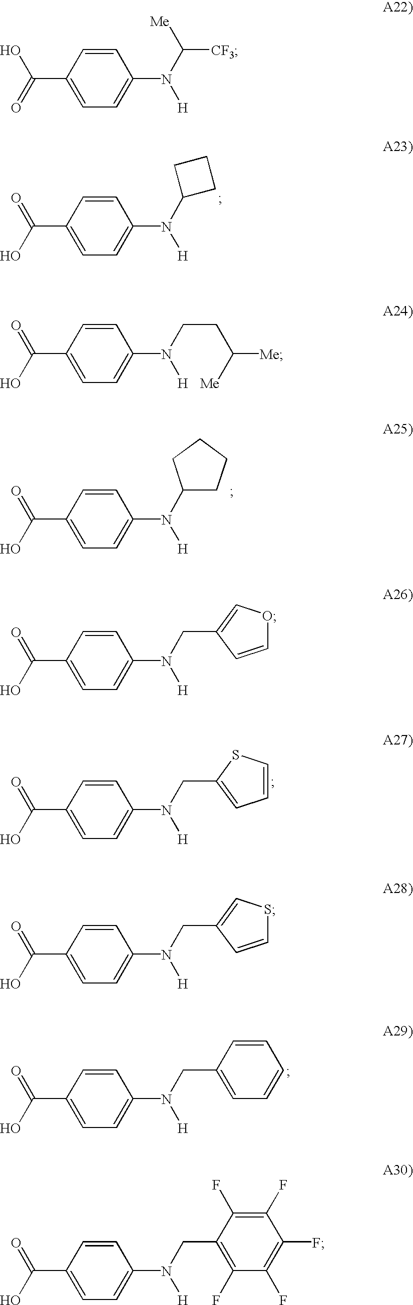

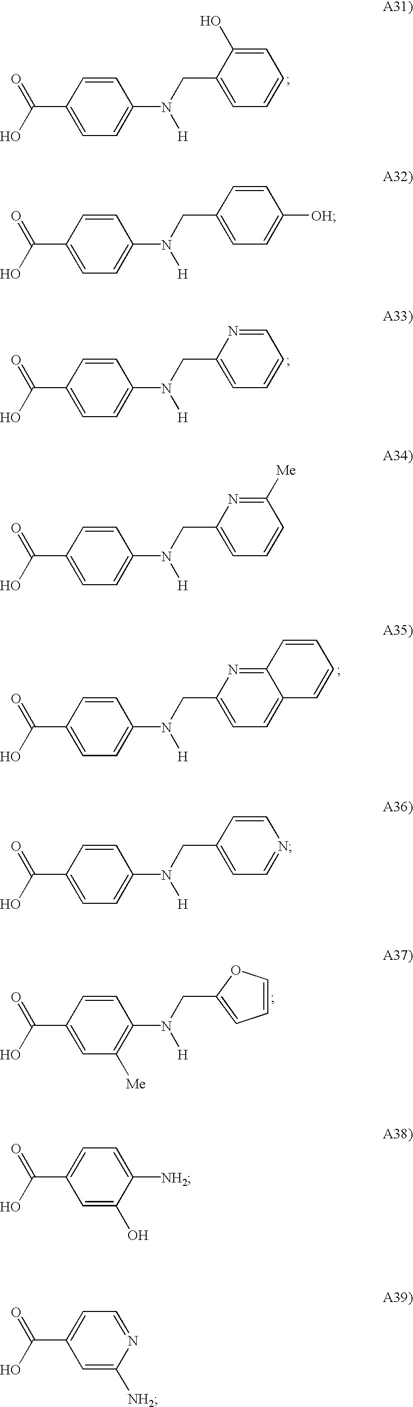

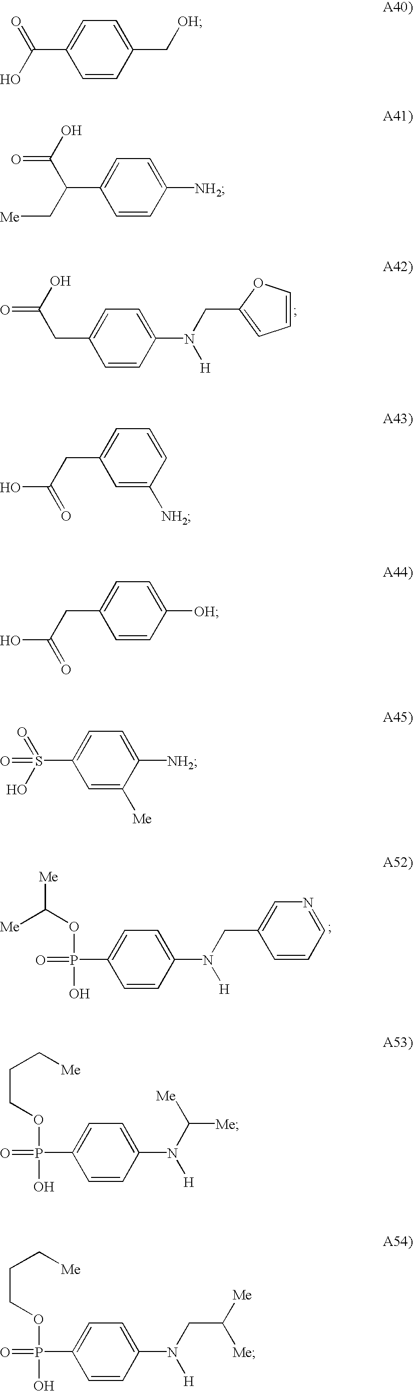

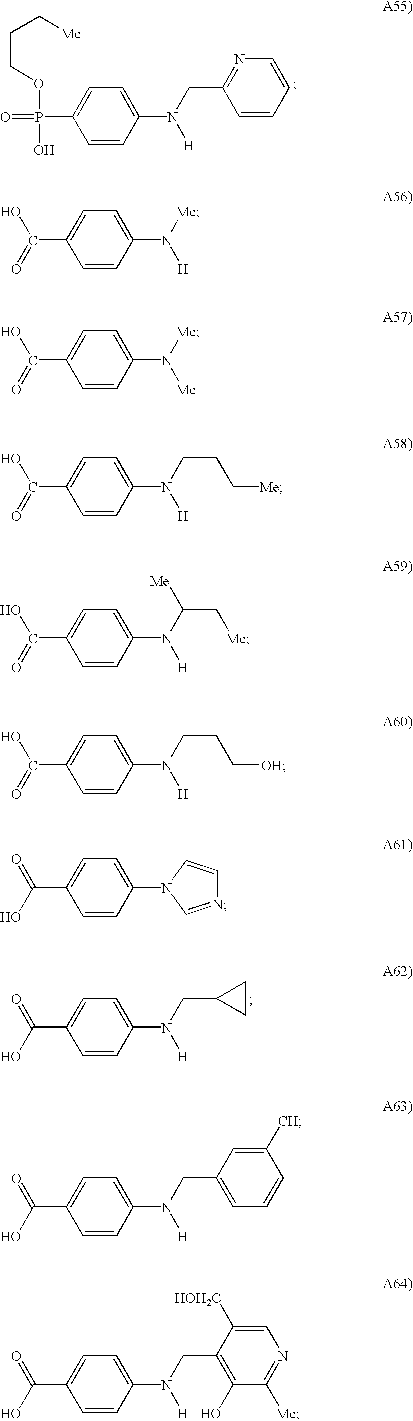

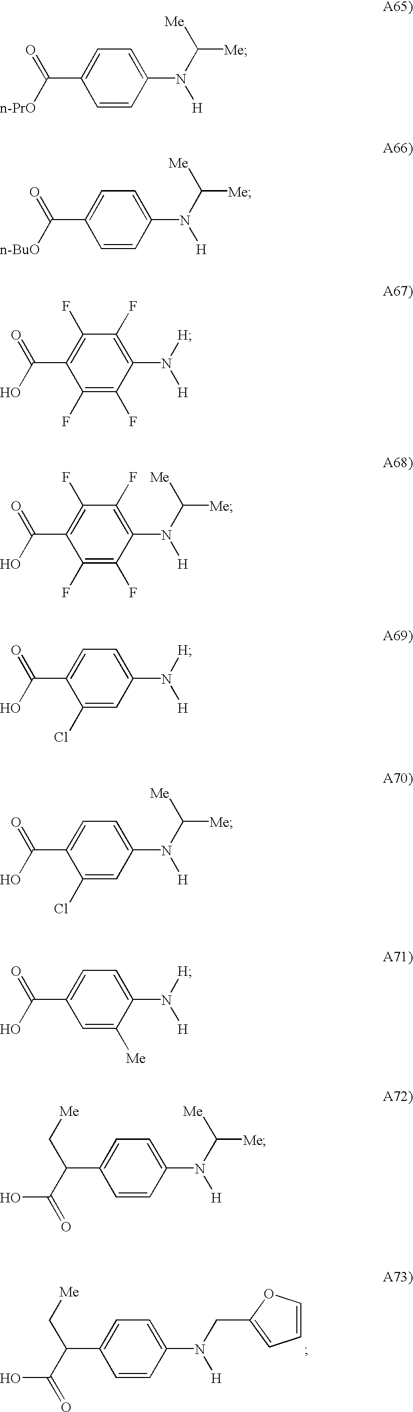

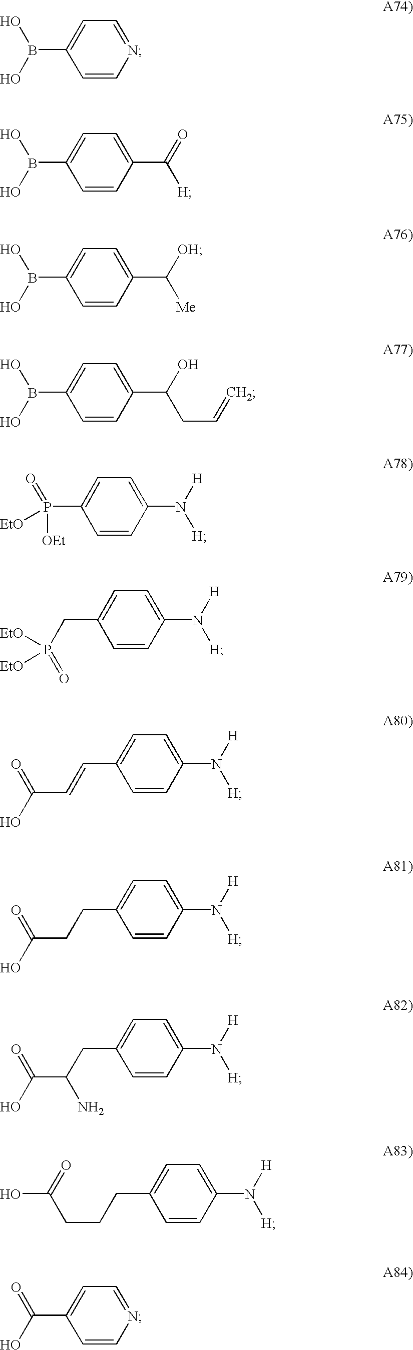

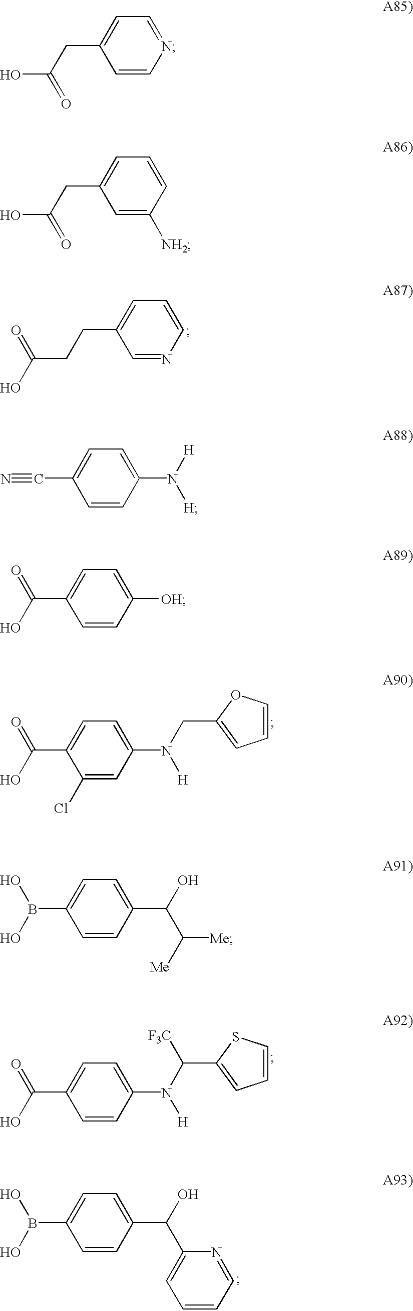

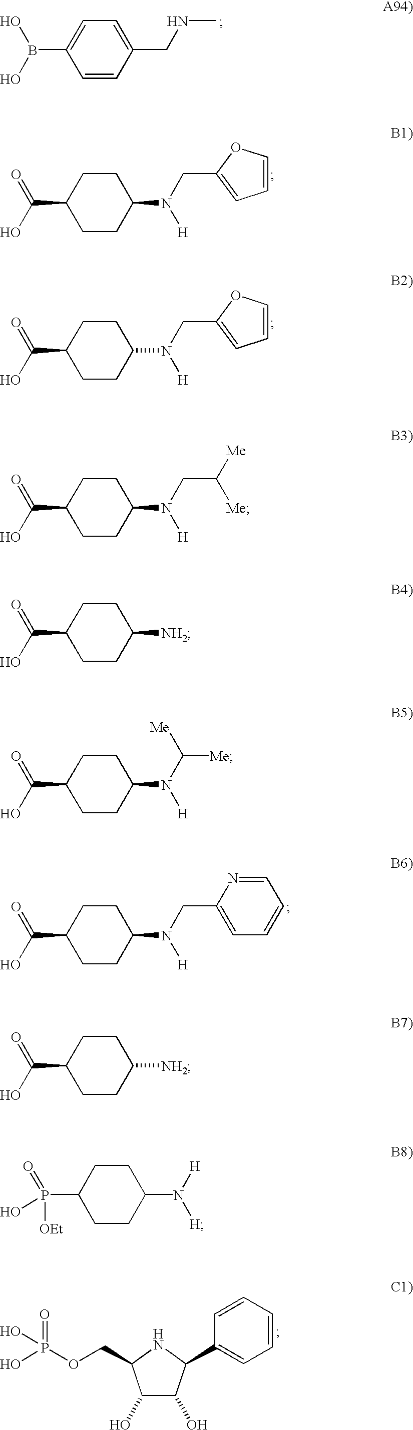

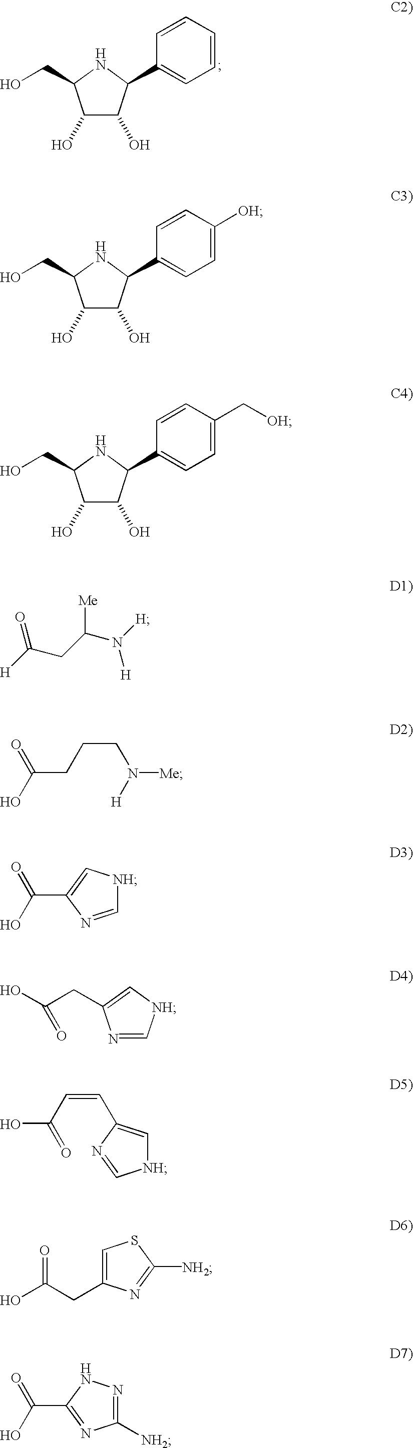

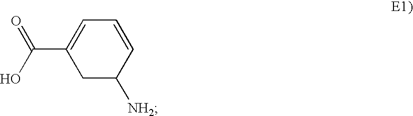

30. The method of claim 1 or 2, wherein the methanogenic archaea are selected from the group of archaea consisting of Methanococcus, Methanobacterium, Methanosarcina, Methanobrevibacter, Methanothermus, Methanothrix, Methanospirillum, Methanomicrobium, Methanococcoides, Methanogenium, Methanobacter and Methanoplanus.

31. The method of any of claims 1-3, wherein the compound inhibits the synthesis of methanopterin.

32. The method of any of claims 1-3, wherein the compound inhibits RFA-P synthase.

33. The method of claim 1 or 2, wherein the methanogenic archaea medium is selected from the group consisting of the rumen compartment of a ruminant animal, a landfill, a pond, an anaerobic digestor and a rice paddy.

34. The method of claim 33, wherein the methanogenic archaea medium is the rumen compartment of a ruminant animal.

35. The method of claim 3, wherein the ruminant animal is selected from the group of animals consisting of cattle, sheep, deer, goats, musk, ox, buffalo, giraffe and camels.

36. The method of claim 3, wherein the ruminant animal is a cow.

37. The method of claim 3, wherein the ruminant animal is a sheep.

38. The method of claim 1, wherein the method further comprises inhibiting the growth of methanogenic archaea.

39. A method for inhibiting methane production by methanogenic archaea, the method comprising contacting a methanogenic archaea medium with an effective methane inhibiting amount of a composition which interferes with methanopterin biosynthesis.

40. A method for inhibiting the growth of methanogenic archaea, the method comprising contacting a methanogenic archaea medium with an effective growth inhibiting amount of a composition which interferes with methanopterin biosynthesis.

41. A method for increasing feed efficiency in a ruminant animal, the method comprising administering to the animal an effective rumen modifying amount of a composition which interferes with methanopterin biosynthesis.

42. The method of any of claims 39-41, wherein the composition inhibits RFA-P synthase.

43. The method of claim 39, wherein the method further comprises inhibiting the growth of methanogenic archaea.

44. A ruminant feed composition comprising at least one compound of Formula XXXA: 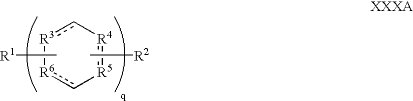
wherein the dashed lines independently indicate an optional double bond;
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
wherein q is 0 or 1;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

45. The ruminant feed composition of claim 44 wherein the compound is a compound of Formula XXX: 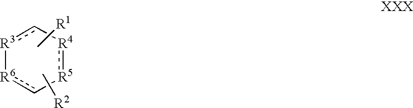
wherein the dashed lines independently indicate an optional double bond;
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen, oxygen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

46. The ruminant feed composition of claim 45 wherein the compound is a compound of Formula IA: 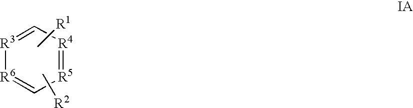
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), —NR¹³(POₙR¹¹R¹²);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or R²⁶ and either R²⁷ or R²⁸ or R²⁹ or R³⁷, or R²⁷ and either R²⁸ or R³⁶ or R³⁷, or R²⁸ , and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

47. The ruminant feed composition of claim 46 wherein the compound is a compound of Formula IIA: 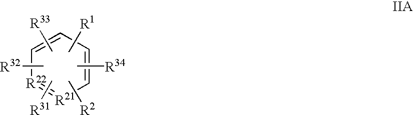
wherein R¹ is selected from the group consisting of —C≡N, —OₘBR³R⁴, —C(H)R⁵(BR³R⁴), —OₘC(O)R⁶, —(C(H)R⁵)ₚ(C(O)R⁶), —CHR⁵(NR⁸R¹²), —CR⁵═CR¹¹(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ and R¹¹ are independently selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹, R¹⁰ and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸, R¹² and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²¹ and R²² are independently carbon or nitrogen;
wherein R³¹, R³², R³³ and R³⁴ are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
wherein p is an integer from 0 to 3;
and wherein R³ and R⁴, or R⁵ and either R³ or R⁴ or R⁶ or R⁷ or R⁸ or R⁹ or R¹⁰ or R¹², or R⁸ and either R⁷ or R⁹ or R¹⁰ or R¹², or R⁹ and R₁₀, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³² or R³³ or R³⁴, or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³³ or R³⁴, or R³³ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³⁴, or R³⁴ and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

48. The ruminant feed composition of claim 47 wherein the compound is a compound of Formula IIIA: 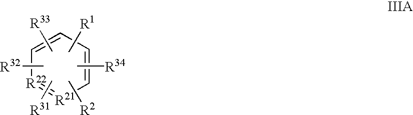
wherein R¹ is selected from the group consisting of —C≡N, —BR³R⁴, —C(H)R⁵(BR³R⁴), —CR⁵═CR¹¹(C(O)R⁶), —C(O)R⁶, —CHR⁵(NR⁸R¹²), —(C(H)R⁵)ₚ(C(O)R⁶), —SOₙR⁷, —C(H)R⁵(SOₙR⁷), —POₙR⁹R¹⁰, and —C(H)R⁵(POₙR⁹R¹⁰);
wherein R² is selected from the group consisting of hydrogen, hydroxy, —C(O)R²⁵, —C(H)R¹⁶(OH), —OₘNR¹⁹R²⁰, and —C(H)R¹⁶(N(H)R¹⁹);
wherein R³, R⁴, R⁶, R⁷ and R⁹ are independently selected from the group consisting of hydroxy and alkoxy;
wherein R⁵, R⁸, R¹¹, R¹², R¹⁶, R²⁵ R³¹, R³², R³³ and R³⁴ independently selected from the group consisting of hydrogen, hydroxy, amino, halogen, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein R²¹ and R²² are independently carbon or nitrogen;
wherein m is 0 or 1;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁶ and either R¹⁹ or R³¹ or R³² or R³³ or R³⁴, or R¹⁹ and either R²⁰ or R³¹ or R³² or R³³ or R³⁴, or R²⁰ and either R³¹ or R³² or R³³ or R³⁴, together with the atoms to which they are independently attached, can form a substituted or unsubstituted, saturated, partially saturated or unsaturated carbocyclic or heterocyclic ring containing from 3 to 6 carbon atoms.

49. The ruminant feed composition of claim 48 wherein the compound is a compound of Formula IVA: 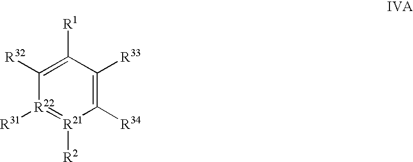
wherein R¹ is selected from the group consisting of —C≡N, —BR³R⁴, —C(O)R⁶, —CHR⁵(NR⁸R¹²), —(C(H)R⁵)ₚ(C(O)R⁶), —CR⁵═CR¹¹(C(O)⁶), —SOₙ(OH), —POₙR⁹R¹⁰ and —C(H)R⁵(POₙR⁹R¹⁰);
wherein R² is selected from the group consisting of hydrogen, hydroxy, —C(O)R²⁵₁, —C(H)R¹⁶(OH), —NR¹⁹R²⁰, and —CH₂(N(H)R¹⁹);
wherein R³, R⁴, R⁶, R⁹ and R¹⁰ are independently selected from the group consisting of hydroxy and alkoxy;
wherein R⁵, R⁸, R¹¹ and R¹² are independently selected from the group consisting of hydrogen, hydrocarbyl and substituted hydrocarbyl;
wherein R¹⁶, R¹⁹, R²⁰, R²⁵, R³¹, R³², R³³ and R³⁴ are independently selected from the group consisting of hydrogen, hydroxy, amino, halogen, hydrocarbyl, and substituted hydrocarbyl;
wherein R²¹ and R²² are independently carbon or nitrogen;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁹ and either R²⁰ or R³¹, or R²⁰ and R³¹, together with the atoms to which they are independently attached, can form a substituted or unsubstituted, saturated, partially saturated or unsaturated heterocyclic ring containing from 3 to 5 carbon atoms.

50. The ruminant feed composition of claim 45 wherein the compound is a compound of Formula I: 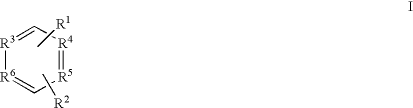
wherein R¹ is selected from the group consisting of —OₘBR⁷R⁸, —CR⁹R¹⁰(BR⁷R⁸), —OₘC(O)R⁷, —CR⁹R¹⁰(C(O)R⁷, —OₘSOₙR¹¹, —CR⁹R¹⁰(SOₙR¹¹), —NR³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is from 0 to 2;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

51. The ruminant feed composition of claim 50 wherein the compound is a compound of Formula II: 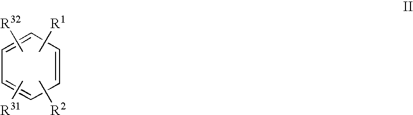
wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of —OR¹⁸, —C(H)R¹⁶(OR¹⁸), —OₘN(H)R¹⁹, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ is selected from the group consisting of hydrogen, hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, hydrocarbyloxy, substituted hydrocarbyloxy, and heterocyclooxy;
wherein m is 0 or 1;
wherein n is from 0 to 2;
and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R³², or R³² and either R³ or R or R⁵ or R⁶ or R⁷ or R⁸ or R⁹ or R¹⁰ or R¹⁶ or R¹⁷ or R¹⁸ or R¹⁹, together with the atoms to which they are independently attached, can form a substituted or unsubstituted, saturated, partially saturated or unsaturated carbocyclic or heterocyclic ring containing from 3 to 6 carbon atoms.

52. The ruminant feed composition of claim 51 wherein the compound is a compound of Formula III: 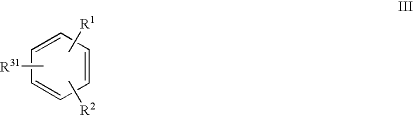
wherein R¹ is selected from the group consisting of —BR³R⁴, —C(H)R⁵(BR³R⁴), —C(O)R⁶, —C(H)R⁵(C(O)R⁶), —SOₙR⁷, —C(H)R⁵(SOₙR⁷), —POₙR⁹R¹⁰, and —C(H)R⁵(POₙR⁹R¹⁰);
wherein R² is selected from the group consisting of hydroxy, —C(H)R¹⁶(OH), —OₘN(H)R¹⁹, and —C(H)R¹⁶(N(H)R¹⁹);
wherein R³, R⁴, R⁶, R⁷ and R⁹ are independently selected from the group consisting of hydroxy and alkoxy;
wherein R⁵, R¹⁶ and R³¹ are independently selected from the group consisting of hydrogen, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ is selected from the group consisting of hydrogen, hydrocarbyl, substituted hydrocarbyl, and heterocyclo;
wherein m is 0 or 1;
wherein n is from 0 to 2;
and wherein R³ and R⁴, or R⁵ and R⁶, or R⁹ and R¹⁰, or R¹⁶ and R¹⁹, together with the atoms to which they are independently attached, can form a substituted or unsubstituted, saturated, partially saturated or unsaturated carbocyclic or heterocyclic ring containing from 3 to 6 carbon atoms.

53. The ruminant feed composition of claim 52 wherein the compound is a compound of Formula IV: 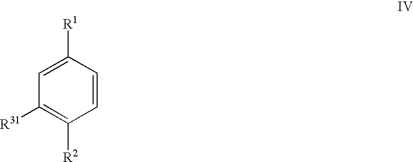
wherein R¹ is selected from the group consisting of —BR³R⁴₁, —C(O)R⁶, —CH₂(C(O)R⁶), —SOₙ(OH), and —POₙR⁹(OH);
wherein R² is selected from the group consisting of —CH₂OH, —N(H)R¹⁹, and —CH₂(N(H)R¹⁹);
wherein R³, R⁴, and R⁶ are independently selected from the group consisting of hydroxy and alkoxy;
wherein R⁹ is alkoxy;
wherein R¹⁹ and R³¹ are independently selected from the group consisting of hydrogen, hydrocarbyl, and substituted hydrocarbyl;
wherein n is from 0 to 2;
and wherein R³ and R⁴, or R¹⁹ and R³¹, together with the atoms to which they are independently attached, can form a substituted or unsubstituted, saturated, partially saturated or unsaturated heterocyclic ring containing from 3 to 5 carbon atoms.

54. The ruminant feed composition of claim 45 wherein the compound is a compound of Formula V: 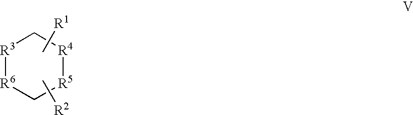
wherein R¹ is selected from the group consisting of —OₘBR⁷R⁸, —CR⁹R¹⁰(BR⁷ R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

55. The ruminant feed composition of claim 54 wherein the compound is a compound of Formula VI: 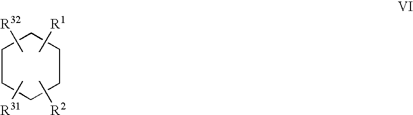
wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —C(H)R⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³², or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

56. The ruminant feed composition of claim 55 wherein the compound is a compound of Formula VII: 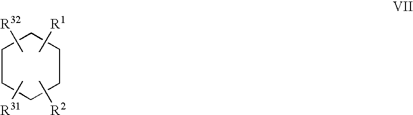
wherein R¹ is selected from the group consisting of —BR³R⁴, —C(O)R⁶, —SOₙR⁷, and —POₙR⁹R¹⁰;
wherein R² is selected from the group consisting of hydrogen, hydroxy, —C(H)R¹⁶(OH), —OₘNR¹⁹R²⁰, and —C(H)R¹⁶((H)R¹⁹);
wherein R³, R⁴, R⁶, R⁷ and R⁹ are independently selected from the group consisting of hydroxy, hydrocarbyl, and alkoxy;
wherein R⁵, R¹⁶, R³¹ and R³² are independently selected from the group consisting of hydrogen, hydroxy, amino, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein m is 0 or 1;
wherein n is an integer from 0 to 2;
and wherein R³ and R⁴, or R⁵ and R⁶, or R⁹ and R¹⁰, or R¹⁶ and either R¹⁹ or R³¹ or R³², or R¹⁹ and either R²⁰ or R³¹ or R³², or R²⁰ and either R³¹ or R³², together with the atoms to which they are independently attached, can form a substituted or unsubstituted, saturated, partially saturated or unsaturated carbocyclic or heterocyclic ring containing from 3 to 6 carbon atoms.

57. The ruminant feed composition of claim 56 wherein the compound is a compound of Formula VIII: 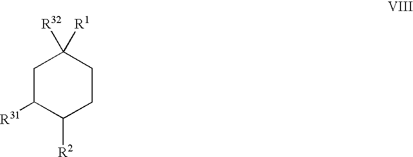
wherein R¹ is selected from the group consisting of —BR³R⁴, —C(O)R⁶, —C(H)R⁵(C(O)R⁶), —SOₙ(OH), and —POₙR⁹R¹⁰;
wherein R² is selected from the group consisting of hydrogen, hydroxy, —C(H)R¹⁶(OH), —NR¹⁹R²⁰, and —CH₂((H)R¹⁹);
wherein R³, R⁴, R⁶, R⁹ and R¹⁰ are independently selected from the group consisting of hydroxy and alkoxy;
wherein R⁵ is alkyl;
wherein R¹⁶, R¹⁹, R²⁰, R³¹, and R³² are independently selected from the group consisting of hydrogen, hydroxy, amino, hydrocarbyl, and substituted hydrocarbyl;
wherein n is an integer from 0 to 2;
and wherein R³ and R⁴, or R⁵ and R⁶, or R⁹ and R¹⁰, or R¹⁹ and either R²⁰ or R³¹ or R³², or R²⁰ and either R³¹ or R³², together with the atoms to which they are independently attached, can form a substituted or unsubstituted, saturated, partially saturated or unsaturated heterocyclic ring containing from 3 to 5 carbon atoms.

58. The ruminant feed composition of claim 45 wherein the compound is a compound of Formula IX: 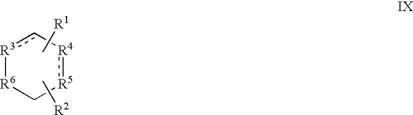
wherein the dashed lines independently indicate an optional double bond;
wherein R¹ is selected from the group consisting of —OₘBR⁷R⁸, —CR⁹R¹⁰(BR⁷R⁸), —OₘC(O)R⁷, —CR⁹R¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, —OR³⁶, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R³, R⁴, R⁵ and R⁶ are independently selected from the group consisting of nitrogen and carbon, wherein the carbon may be optionally substituted with a substituent selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁷, R⁸, R¹¹ and R¹² are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
and wherein either R¹ or R² and either R³ or R⁴ or R⁵ or R⁶, or R³ and R⁶, or R⁴ and R⁵, or R⁷ and either R⁸ or R⁹ or R¹⁰, or R⁸ and either R⁹ or R¹⁰, or R⁹ and either R¹⁰ or R¹¹ or R¹², or R¹⁰ and either R¹¹ or R¹², or R¹¹ and either R¹² or R¹³, or R¹² and R¹³, or R²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

59. The ruminant feed composition of claim 58 wherein the compound is a compound of Formula X: 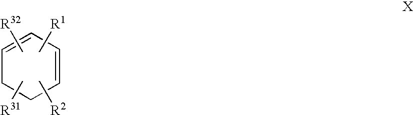
wherein R¹ is selected from the group consisting of —OₘBR³R⁴, —C(H)R⁵(BR³R⁴), —OₘC(O)R⁶, —C(H)R⁵(C(O)R⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —C(H)R¹⁶(OR¹⁸), —OₘNR¹⁹R²⁰, —C(H)R¹⁶(N(H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹ and R¹⁰ are independently selected from the group consisting of hydrocarbyl, substituted hydrocarbyl, heterocyclo, hydroxy, hydrocarbyloxy, substituted hydrocarbyloxy, heterocyclooxy, amino, -hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
and wherein R³ and R⁴, or R⁵ and either R³ or R⁴ or R⁶ or R⁷ or R⁹ or R¹⁰, or R⁸ and either R⁷ or R⁹ or R¹⁰, or R⁹ and R¹⁰, or R¹⁶ and either R¹⁸ or R¹⁹, or R¹⁷ and R¹⁹, or R¹⁹ and R²⁰, or R³¹ and either R³ or R⁴ or R⁵ or R⁶ or R⁷ or R⁸ or R⁹ or R¹⁰ or R¹⁶ or R¹⁷ or R¹⁸ or R¹⁹ or R²⁰ or R³², or R³² and either R³ or R⁴ or R⁵ or R⁶ or R⁷ or R⁸ or R⁹ or R¹⁰ or R¹⁶ or R¹⁷ or R¹⁸ or R¹⁹ or R²⁰, together with the atoms to which they are independently attached, can form a substituted or unsubstituted, saturated, partially saturated or unsaturated carbocyclic or heterocyclic ring containing from 3 to 6 carbon atoms.

60. The ruminant feed composition of claim 59 wherein the compound is a compound of Formula XI: 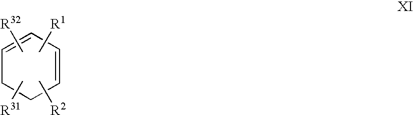
wherein R¹ is selected from the group consisting of —BR³R⁴, —C(O)R⁶, —SOₙR⁷, and —POₙR⁹R¹⁰;
wherein R² is selected from the group consisting of hydrogen, hydroxy, —C(H)R¹⁶(OH), —OₘNR¹⁹R²⁰, and —C(H)R¹⁶(N(H)R¹⁹);
wherein R³, R⁴, R⁶, R⁷ and R⁹ are independently selected from the group consisting of hydroxy, hydrocarbyl, and alkoxy;
wherein R⁵, R¹⁶, R³¹ and R³² are independently selected from the group consisting of hydrogen, hydroxy, amino, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein m is 0 or 1;
wherein n is an integer from 0 to 2;
and wherein R³ and R⁴, or R⁵ and R⁶, or R⁹ and R¹⁰, or R¹⁶ and either R¹⁹ or R³¹ or R³², or R¹⁹ and either R²⁰ or R³¹ or R³², or R²⁰ and either R³¹ or R³², together with the atoms to which they are independently attached, can form a substituted or unsubstituted, saturated, partially saturated or unsaturated carbocyclic or heterocyclic ring containing from 3 to 6 carbon atoms.

61. The ruminant feed composition of claim 60 wherein the compound is a compound of Formula XII: 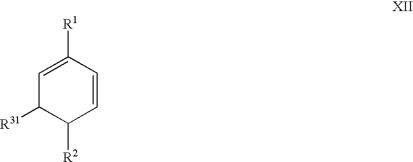
wherein R¹ is selected from the group consisting of —BR³R⁴, —C(O)R⁶, —C(H)R⁵(C(O)R⁶), —SOₙ(OH), and —POₙR⁹R¹⁰;
wherein R² is selected from the group consisting of hydrogen, hydroxy, —C(H)R¹⁶(OH), —NR¹⁹R²⁰, and —CH₂(N(H)R¹⁹);
wherein R³, R⁴, R⁶, R⁹ and R¹⁰ are independently selected from the group consisting of hydroxy and alkoxy;
wherein R⁵ is alkyl;
wherein R¹⁶, R¹⁹, R²⁰, R³¹, and R³² are independently selected from the group consisting of hydrogen, hydroxy, amino, hydrocarbyl, and substituted hydrocarbyl;
wherein n is an integer from 0 to 2;
and wherein R³ and R⁴, or R⁵ and R⁶, or R⁹ and R¹⁰, or R¹⁹ and either R²⁰ or R³¹ or R³², or R²⁰ and either R³¹ or R³², together with the atoms to which they are independently attached, can form a substituted or unsubstituted, saturated, partially saturated or unsaturated heterocyclic ring containing from 3 to 5 carbon atoms.

62. The ruminant feed composition of claim 45 wherein the compound is a compound of Formula XIII: 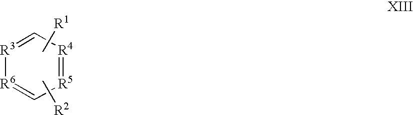
wherein R¹ is —CR⁹R¹⁰(NR¹³R¹⁴);
wherein R² is selected from the group consisting of hydrogen, —OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R²⁵ is selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
and wherein R⁹ and either R¹⁰ or R¹³ or R¹⁴, together with the atoms to which they are independently attached, form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

63. The ruminant feed composition of claim 62 wherein the compound is a compound of Formula XIV: 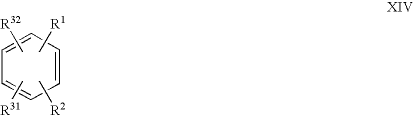
wherein R¹ is —CHR⁵(NR⁸R¹²);
wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶(N(H)R¹⁹), and —NR¹⁷(N(H)R¹⁹);
wherein R⁵ is selected from the group consisting of hydrogen, hydrocarbyl, substituted hydrocarbyl, heterocyclo, hydroxy, hydrocarbyloxy, substituted hydrocarbyloxy, and heterocyclooxy;
wherein R²⁵ is selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸ and R¹² are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R³¹ and R³² are independently selected from the group consisting of hydrogen, halogen, hydrocarbyl, substituted hydrocarbyl, heterocyclo, hydroxy, amino, hydrocarbyloxy, substituted hydrocarbyloxy, and heterocyclooxy;
wherein m is 0 or 1;
wherein n is an integer from 0 to 2;
and wherein R⁵ and either R⁸ or R¹², together with the atoms to which they are independently attached, form a substituted or unsubstituted, saturated, partially saturated or unsaturated carbocyclic or heterocyclic ring containing from 3 to 6 carbon atoms.

64. The ruminant feed composition of claim 63 wherein the compound is a compound of Formula XV: 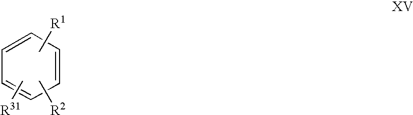
wherein R¹ is —CHR⁵(NR⁸R¹²);
wherein R² is selected from the group consisting of hydrogen, hydroxy, —C(O)R²⁵, —C(H)R¹⁶(OH), —OₘNR¹⁹R²⁰, and —C(H)R¹⁶((H)R¹⁹);
wherein R⁵, R⁸ R¹², R¹⁶ R²⁵ and R³¹ are independently selected from the group consisting of hydrogen, hydroxy, amino, halogen, hydrocarbyl, and substituted hydrocarbyl;
wherein R¹⁹ and R²⁰ are independently selected from the group consisting of hydrogen, hydrocarbyl, substituted hydrocarbyl, and heterocyclo;
wherein m is 0 or 1;
and wherein R⁵ and either R⁸ or R¹², together with the atoms to which they are independently attached, form a substituted or unsubstituted, saturated, partially saturated or unsaturated carbocyclic or heterocyclic ring containing from 3 to 6 carbon atoms.

65. The ruminant feed composition of claim 64 wherein the compound is a compound of Formula XVI: 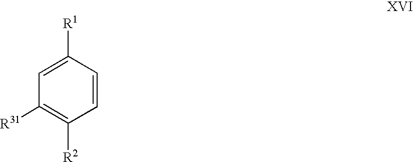
wherein R¹ is —CHR⁵(NR⁸R¹²);
wherein R² is selected from the group consisting of hydrogen, hydroxy, —C(O)R²⁵, —C(H)R¹⁶(OH), —NR¹⁹R²⁰, and —CH₂(N(H)R¹⁹);
wherein R⁵, R⁸, and R¹² are independently selected from the group consisting of hydrogen, hydrocarbyl and substituted hydrocarbyl;
wherein R¹⁶, R¹⁹, R²⁰, R²⁵ and R³¹ are independently selected from the group consisting of hydrogen, hydroxy, amino, halogen, hydrocarbyl, and substituted hydrocarbyl;
and wherein R⁵ and either R⁸ or R¹², together with the atoms to which they are independently attached, form a substituted or unsubstituted, saturated, partially saturated or unsaturated heterocyclic ring containing from 3 to 5 carbon atoms.

66. The ruminant feed composition of claim 44 wherein the compound is a compound of Formula XVII:
R¹—R² XVII
wherein R¹ is selected from the group consisting of —C≡N, —OₘBR⁷R⁸, —CR⁹R¹⁰(BR⁷R⁸), —OₘC(O)R⁷, —(CR⁹R¹⁰)ₚ(C(O)R⁷), —CR⁹R¹⁰(NR¹³R¹⁴), —CR⁹═CR¹⁰(C(O)R⁷), —OₘSOₙR¹¹, —CR⁹R¹⁰(SOₙR¹¹), —NR¹³(SOₙR¹¹), —OₘPOₙR¹¹R¹², —SPOₙR¹¹R¹², —CR⁹R¹⁰(POₙR¹¹R¹²), and —NR¹³(POₙR¹¹R¹²);
wherein R² is selected from the group consisting of hydrogen, OR³⁶, —OₘC(O)R²⁵, —CR²⁷R²⁸(OR³⁶), —OₘNR²⁶R³⁷, —SOₙNR²⁶R³⁷, —CR²⁷R²⁸(NR²⁶R³⁷), and —NR²⁹(NR²⁶R³⁷);
wherein R⁷, R⁸, R¹¹, R¹² and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, heterocyclosulfonyl, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁹ and R¹⁰ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, thio, hydrocarbylthio, substituted hydrocarbylthio, heterocyclothio, hydrocarbylsulfinyl, substituted hydrocarbylsulfinyl, heterocyclosulfinyl, hydrocarbylsulfonyl, substituted hydrocarbylsulfonyl, and heterocyclosulfonyl;
wherein R¹³, R¹⁴ and R²⁹ are independently selected from the group consisting of hydrogen, hydroxy, hydrocarbyl, substituted hydrocarbyl, and heterocyclo;
wherein R²⁶ and R³⁷ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein R²⁷, R²⁸ and R³⁶ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein R⁷ and either R⁸ or R⁹ or R¹⁰, or R⁸ and either R⁹ or R¹⁰, or R⁹ and either R¹⁰ or R¹¹ or R¹² or R¹³ or R¹⁴, or R¹⁰ and either R¹¹ or R¹² or R¹³ or R¹⁴, or R¹¹ and either R¹² or R¹³, or R¹² and R¹³, or R¹³ and R¹⁴, or ²⁶ and either R²⁷ or R²⁸ or R²⁹ or R³⁷, or R²⁷ and either R²⁸ or R³⁶ or R³⁷, or R²⁸ and either R³⁶ or R³⁷, or R²⁹ and R³⁷, together with the atoms to which they are independently attached, can form a substituted or unsubstituted, saturated, partially saturated or unsaturated heterocyclic ring containing from 2 to 20 carbon atoms, or a substituted or unsubstituted, saturated, partially saturated or unsaturated carbocyclic ring containing from 3 to 20 carbon atoms.

67. The ruminant feed composition of claim 66 wherein the compound is a compound of Formula XVIII:
R¹—R² XVII
wherein R¹ is selected from the group consisting of —C≡N, —OₘBR³R⁴, —C(H)R⁵(BR³R⁴), —OₘC(O)R⁶, —(C(H)R⁵)ₚ(C(O)R⁶), —CHR⁵(NR⁸R¹²), —CR⁵═CR¹¹(C(O)⁶), —OₘSOₙR⁷, —C(H)R⁵SOₙR⁷, —NR⁸(SOₙR⁷), —OₘPOₙR⁹R¹⁰, —SPOₙR⁹R¹⁰, —C(H)R⁵(POₙR⁹R¹⁰), and —NR⁸(POₙR⁹R¹⁰);
wherein R² is selected from the group consisting of hydrogen, —OR¹⁸, —OₘC(O)R²⁵, —C(H)R¹⁶(OR¹⁸), —OₘNR¹⁹R²⁰, —C(H)R¹⁶((H)R¹⁹), and —NR¹⁷(N(H)R¹⁹);
wherein R³ and R⁴ are independently selected from the group consisting of hydroxy, hydrocarbyl, substituted hydrocarbyl, heterocyclo, hydrocarbyloxy, substituted hydrocarbyloxy, and heterocyclooxy;
wherein R⁵ and R¹¹ are independently selected from the group consisting of hydrogen, hydrocarbyl, substituted hydrocarbyl, heterocyclo, hydroxy, hydrocarbyloxy, substituted hydrocarbyloxy, and heterocyclooxy;
wherein R⁶, R⁷, R⁹, R¹⁰ and R²⁵ are independently selected from the group consisting of hydrogen, halogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino, wherein the hydrocarbyl, substituted hydrocarbyl, and/or heterocyclo groups, together with the nitrogen to which they are independently attached, can form a heterocyclic ring containing from 2 to 20 carbon atoms;
wherein R⁸, R¹² and R¹⁷ are independently selected from the group consisting of hydrogen, hydroxy, hydrocarbyl, substituted hydrocarbyl, and heterocyclo;
wherein R¹⁶ and R¹⁸ are independently selected from the group consisting of hydrogen, hydrocarbyl, substituted hydrocarbyl, and heterocyclo;
wherein R¹⁹ and R²⁰ are independently selected from the group consisting of hydrogen, hydrocarbyl, substituted hydrocarbyl, heterocyclo, hydroxy, hydrocarbyloxy, substituted hydrocarbyloxy, heterocyclooxy, amino, N-hydrocarbyl-amino, N-substituted-hydrocarbyl-amino, N-heterocyclo-amino, N,N-dihydrocarbyl-amino, N,N-di-substituted-hydrocarbyl-amino, N,N-diheterocyclo-amino, N-hydrocarbyl-N-substituted-hydrocarbyl-amino, N-hydrocarbyl-N-heterocyclo-amino, and N-substituted-hydrocarbyl-N-heterocyclo-amino;
wherein m is 0 or 1;
wherein n is an integer from 0 to 2;
wherein p is an integer from 0 to 3;
and wherein R³ and R⁴, or R⁵ and either R³ or R⁴ or R⁶ or R⁷ or R⁸ or R⁹ or R¹⁰ or R¹², or R⁸ and either R⁷ or R⁹ or R¹⁰ or R¹², or R⁹ and R¹⁰, or R¹⁶ and either R¹⁸ or R¹⁹, or R¹⁷ and R¹⁹, or R¹⁹ and R²⁰, together with the atoms to which they are independently attached, can form a substituted or unsubstituted, saturated, partially saturated or unsaturated carbocyclic or heterocyclic ring containing from 3 to 6 carbon atoms.

68. The ruminant feed composition of claim 67 wherein the compound is a compound of Formula XIX:
R¹—R² XIX
wherein R¹ is selected from the group consisting of —C≡N, —BR³R⁴, —C(H)R⁵(BR³R⁴), —CR⁵═CR¹¹(C(O)R⁶), —C(O)R⁶, —CHR⁵(NR⁸R¹²), —(C(H)R⁵)ₚ(C(O)R⁶), —SOₙR⁷, —C(H)R⁵(SOₙR⁷), —POₙR⁹R¹⁰, and —C(H)R⁵(POₙR⁹R¹⁰);
wherein R² is selected from the group consisting of hydrogen, hydroxy, —C(O)R²⁵, —C(H)R¹⁶(OH), —OₘNR¹⁹P²⁰, and —C(H)R¹⁶(NH)R¹⁹);
wherein R³, R⁴, R⁶, R⁷ and R⁹ are independently selected from the group consisting of hydroxy and alkoxy;
wherein R⁵, R⁸, R¹¹, R¹², R¹⁶ and R²⁵ are independently selected from the group consisting of hydrogen, hydroxy, amino, halogen, hydrocarbyl, and substituted hydrocarbyl;
wherein R¹⁰ is selected from the group consisting of hydrocarbyl, substituted hydrocarbyl, heterocyclo, and alkoxy;
wherein R¹⁹ and R²⁰ are independently selected from the group consisting of hydrogen, hydrocarbyl, substituted hydrocarbyl, and heterocyclo;
wherein m is 0 or 1;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁶ and R¹⁹, or R¹⁹ and R²⁰, together with the atoms to which they are independently attached, can form a substituted or unsubstituted, saturated, partially saturated or unsaturated carbocyclic or heterocyclic ring containing from 3 to 6 carbon atoms.

69. The ruminant feed composition of claim 68 wherein the compound is a compound of Formula XX:
R¹—R² XX
wherein R¹ is selected from the group consisting of —C≡N, —BR³R⁴, —C(O)R⁶, —CHR⁵(NR⁸R¹²), —(C(H)R⁵)ₚ(C(O)R⁶), —CR⁵═CR¹¹(C(O)R⁶), —SOₙ(OH), —POₙR⁹R¹⁰ and —C(H)R⁵(POₙR⁹R¹⁰);
wherein R² is selected from the group consisting of hydrogen, hydroxy, —C(O)R²⁵₁, —C(H)R¹⁶(OH), —NR¹⁹R²⁰, and —CH₂((H)R¹⁹);
wherein R³, R⁴, R⁶, R⁹ and R¹⁰ are independently selected from the group consisting of hydroxy and alkoxy;
wherein R⁵, R⁸, R¹¹ and R¹² are independently selected from the group consisting of hydrogen, hydrocarbyl and substituted hydrocarbyl;
wherein R¹⁶, R¹⁹, R²⁰ and R²⁵ are independently selected from the group consisting of hydrogen, hydroxy, amino, halogen, hydrocarbyl, and substituted hydrocarbyl;
wherein n is an integer from 0 to 2;
wherein p is an integer from 0 to 3;
and wherein R³ and R⁴, or R⁵ and either R⁶ or R⁸ or R¹², or R⁸ and R¹², or R⁹ and R¹⁰, or R¹⁹ and R²⁰, together with the atoms to which they are independently attached, can form a substituted or unsubstituted, saturated, partially saturated or unsaturated heterocyclic ring containing from 3 to 5 carbon atoms.

70. The ruminant feed composition of claim 44 wherein the compound is a compound selected from the group consisting of: 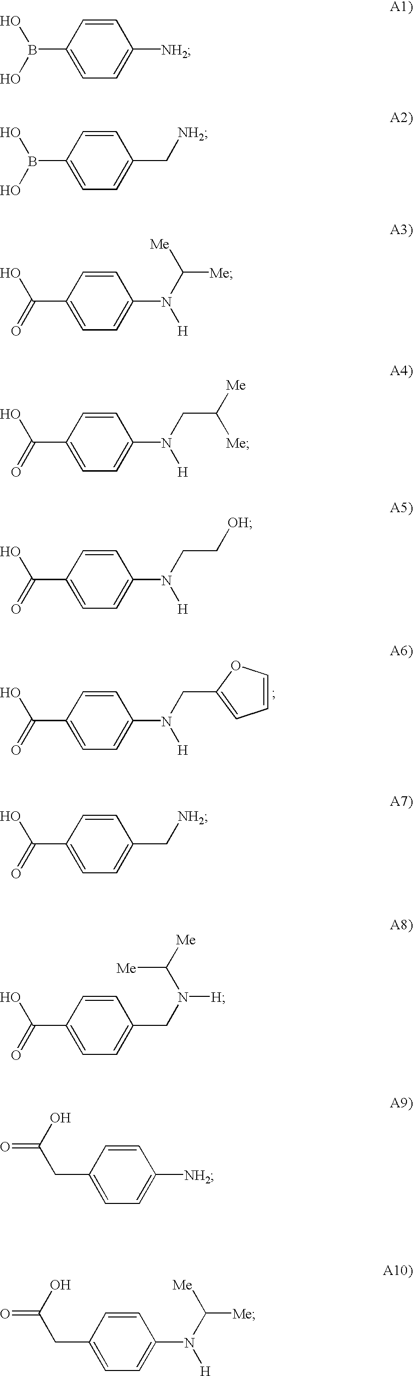 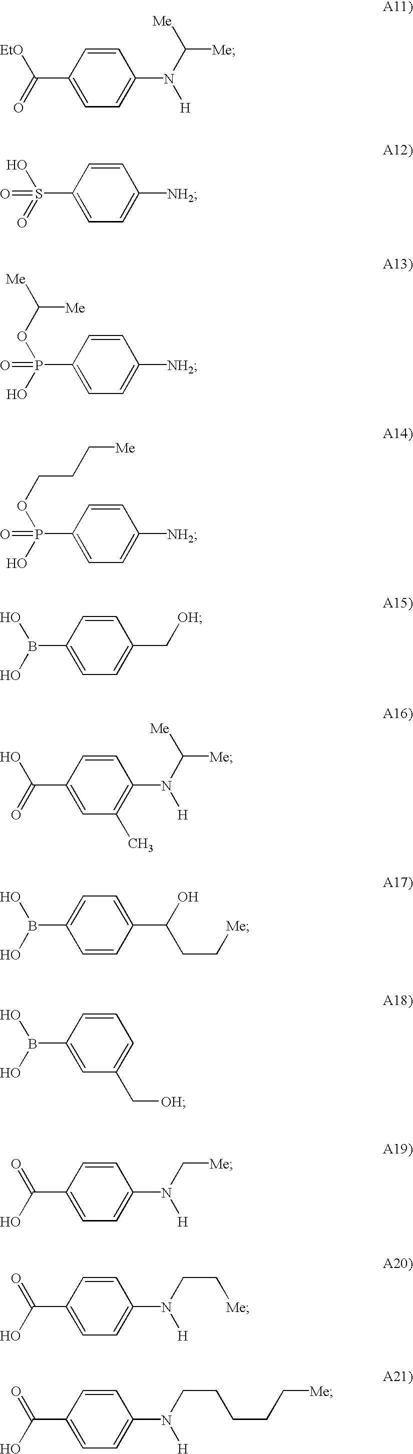 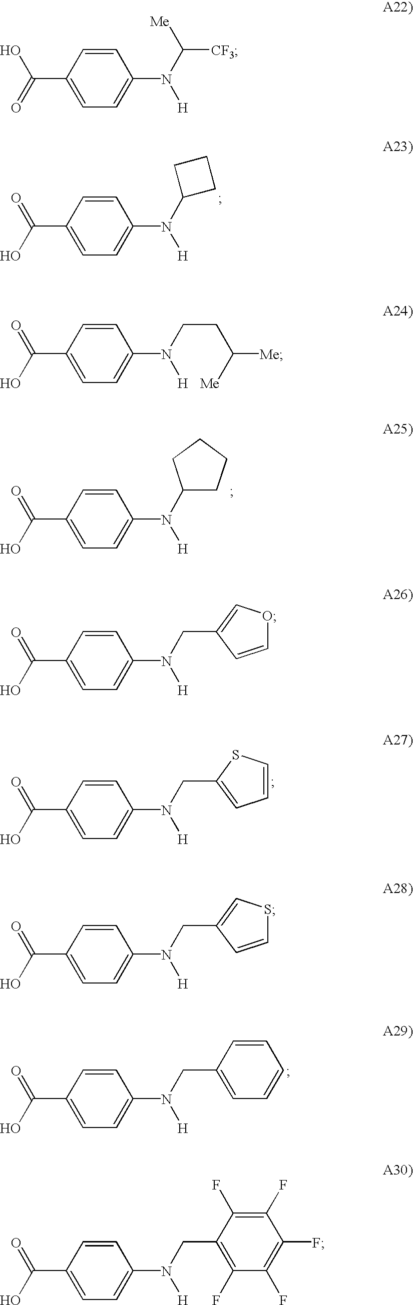 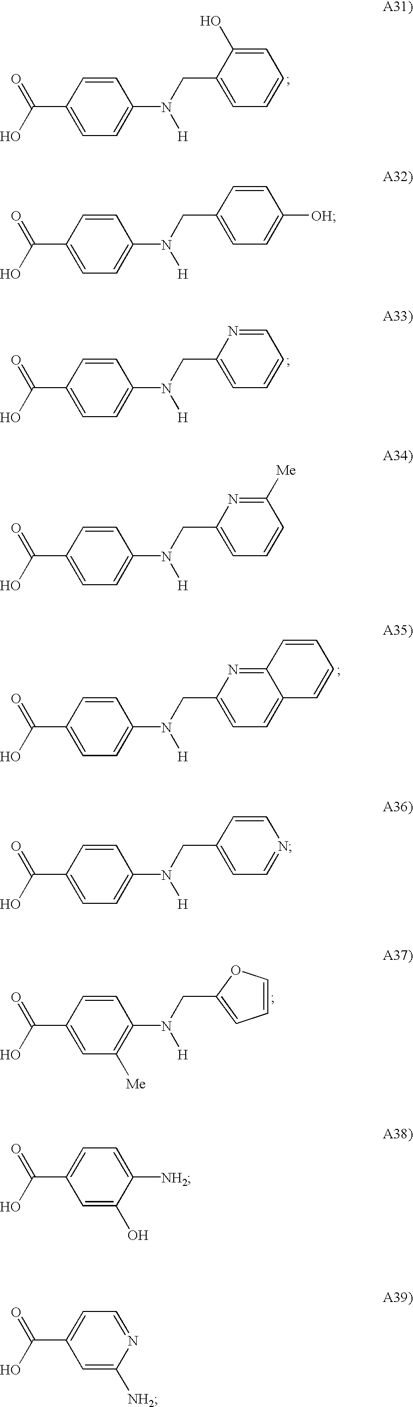 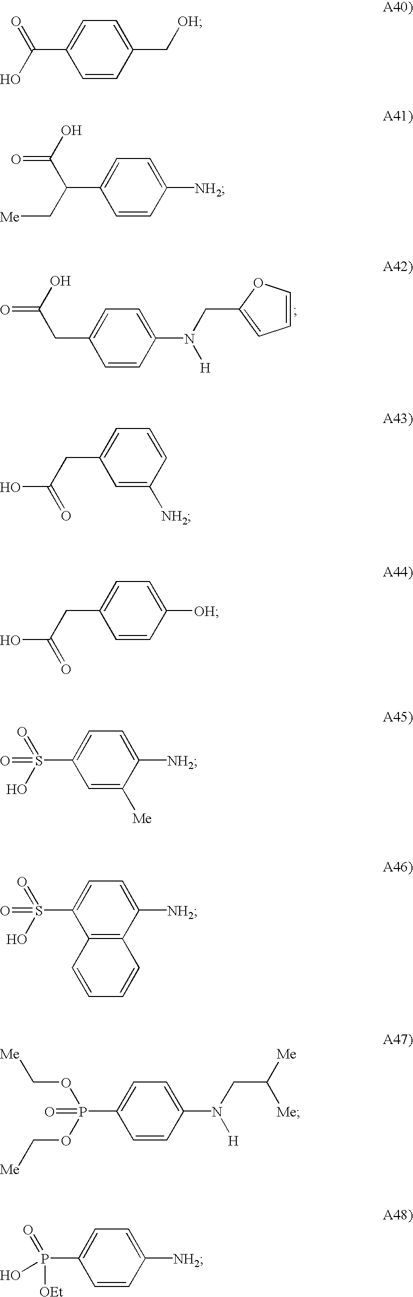 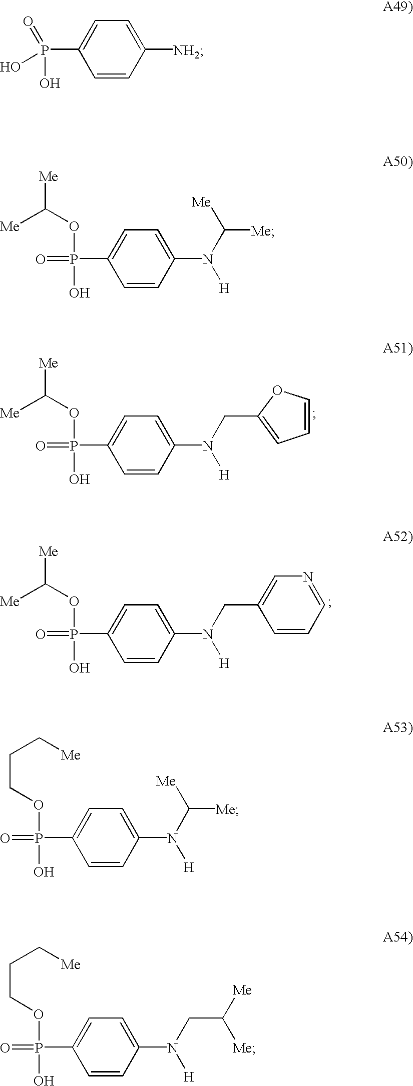 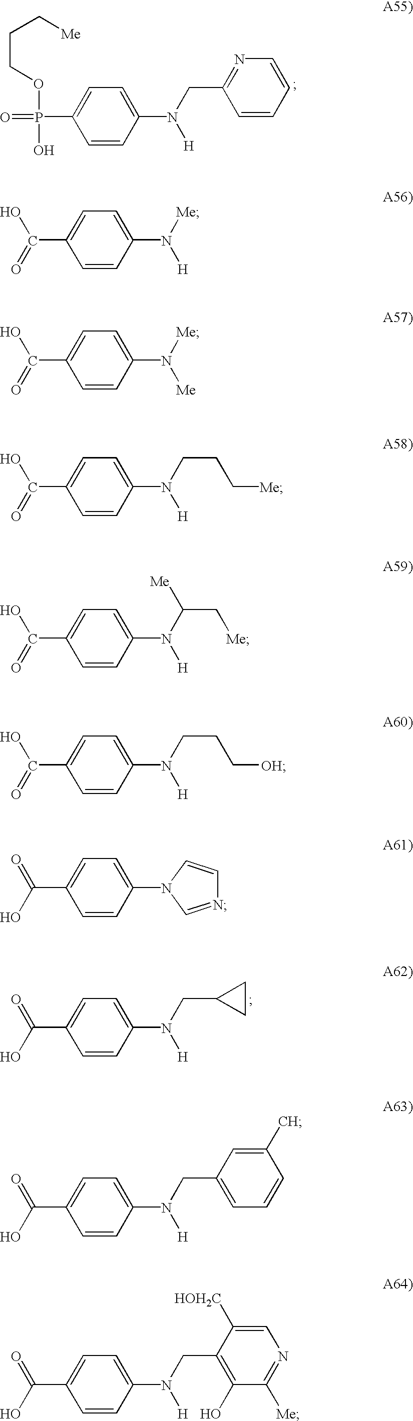 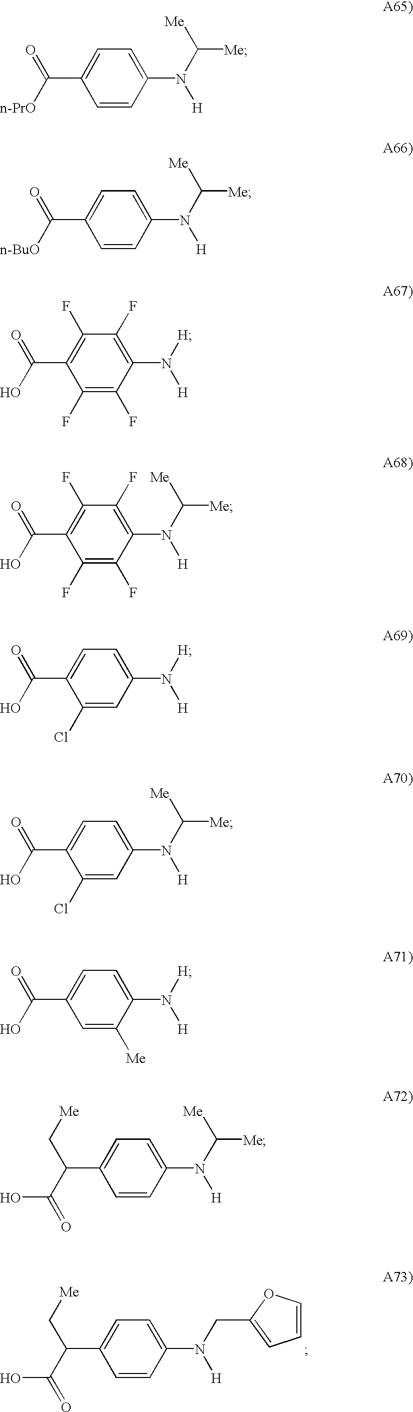 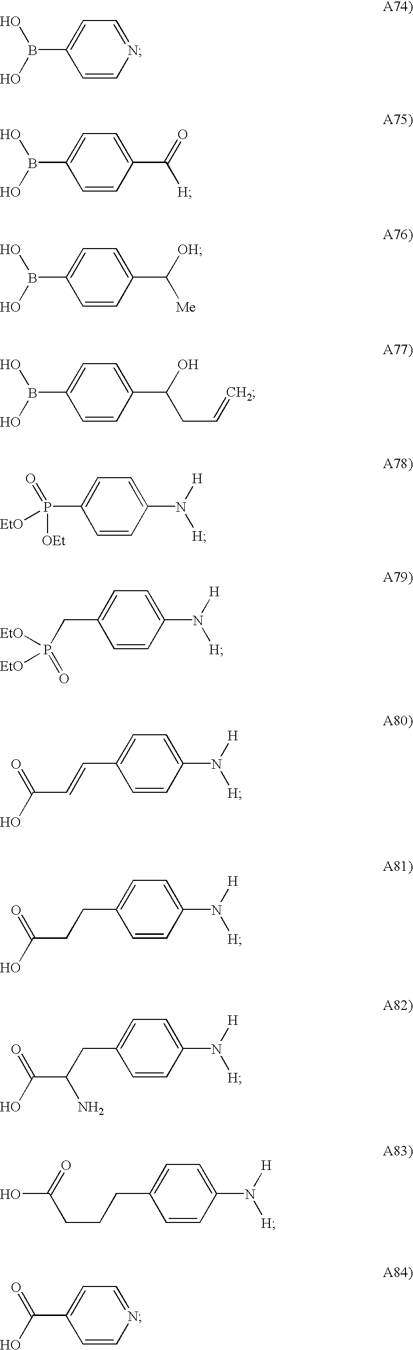 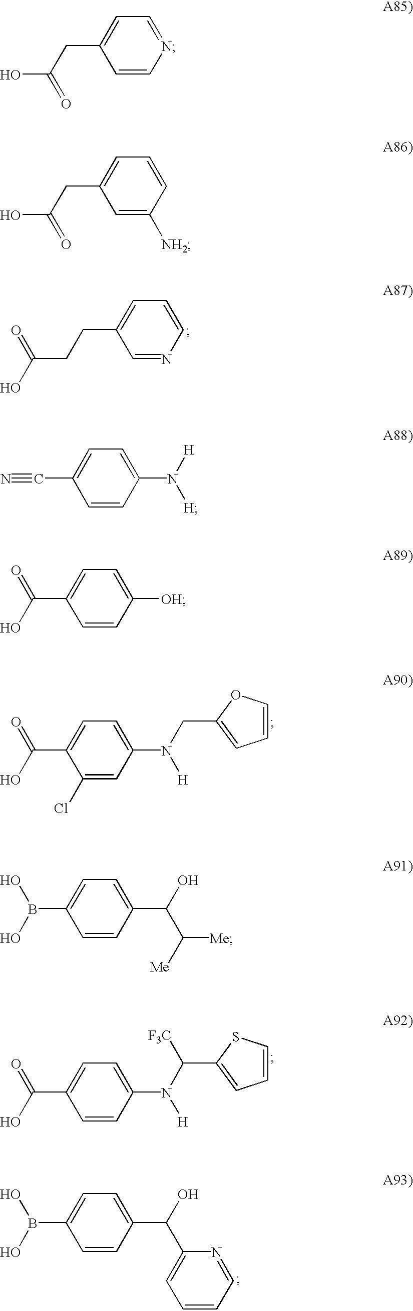 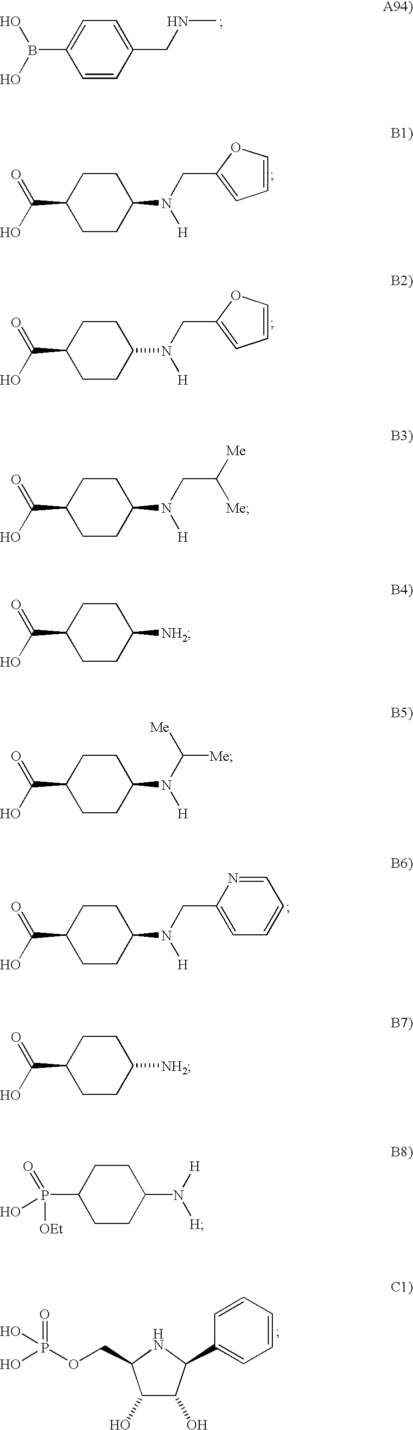 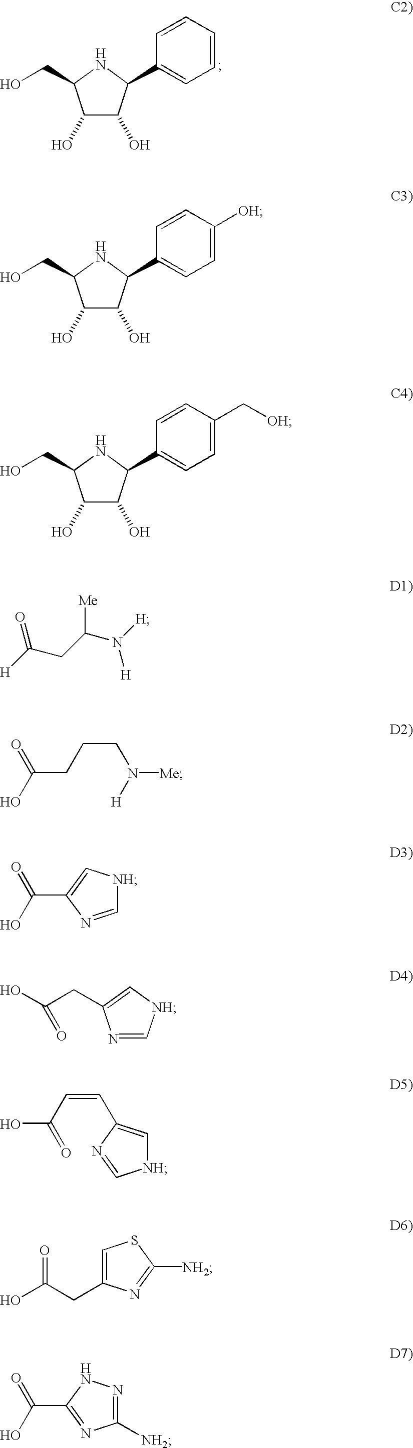 [chemical structure]
